(19) United States
(12) Patent Application Publication
(10) Pub. No.: US 2009/0174531 A1
(43) Pub. Date: Jul. 9, 2009

(54) Apparatus for communicating with RFID tag, processing device for communication with RFID tag, RFID tag, and RFID tag communication system

(75) Inventors: Tsuyoshi Ohashi, Hashima-shi (JP); Hirokazu Sato, Nagoya-shi (JP); Kunihiro Yasui, Nagoya-shi (JP); Atsushi Matsubara, Nagoya-shi (JP); Yasuhisa Ichikawa, Nagoya-shi (JP); Yasuhiro Kudo, Ichinomiya-shi (JP); Shiro Yamada, Kasugai-shi (JP)

Correspondence Address: DAY PITNEY LLP, 7 TIMES SQUARE, NEW YORK, NY, 10036-7311, US

(73) Assignee: Brother Kyogyo Kabushiki Kaisha

(21) Appl. No.: 12/380,559

(22) Filed: Feb. 27, 2009

Related U.S. Application Data
(63) Continuation-in-part of application No. PCT/JP2007/066668, filed on Aug. 28, 2007.

(30) Foreign Application Priority Data
Aug. 28, 2006 (JP) 2006-231241
Sep. 4, 2006 (JP) 2006-239443
Sep. 5, 2006 (JP) 2006-240264

(51) Int. Cl. H04Q 5/22

(52) U.S. Cl. 340/10.52; 340/10.1

(57) ABSTRACT

There are provided an antenna of an apparatus for producing RFID label configured to transmit/receive information via radio communication with a RFID circuit element provided with an IC circuit part storing information, a control circuit of the apparatus for producing RFID label configured to create file additional information relating to an electronic file to be processed and to create tag access information to the IC circuit part, and a radio frequency circuit configured to transmit at least the file additional information and the tag access information to the RFID circuit element via the antenna and to write the information in the IC circuit part.

### CROSS-REFERENCE TO RELATED APPLICATION

This is a CIP application PCT/JP2007/66668, filed Aug. 28, 2007, which was not published under PCT article 21(2) in English.

### BACKGROUND OF THE INVENTION

1. Field of the Invention

The present invention relates to an apparatus for communicating with RFID tag and a processing device for communication with a RFID tag configured to carry out information communication with a RFID tag that can read/write information contactlessly, a RFID tag, and a RFID tag communication system.

2. Description of the Related Art

A RFID (Radio Frequency Identification) system configured to carry out reading/writing of information contactlessly between a small-sized RFID tag and a reader (reading device)/writer (writing device) has been known. A RFID circuit element provided at a RFID tag includes an IC circuit part storing predetermined RFID tag information and an antenna connected to the IC circuit part for information transmission/reception so that an access to the RFID tag information in the IC circuit part (information reading/writing) can be made from the side of the reader/writer, even if the RFID tag is stained or arranged in a hidden position, and is being put into practice in various fields such as merchandize control, inspection process and the like.

A prior art using a portable information terminal as a reader, for example, is described in JP,Z, 3085050. In this prior art, RFID tag information stored in a RFID tag attached to an advertisement medium includes URL information of a web site of the advertisement, and by reading the RFID tag information by the RFID circuit element at the portable information terminal as a radio communication device, the portable information terminal automatically accesses the URL and displays contents of the web site.

Also, a prior art that applies the RFID system to a printed matter, for example, is described in JP,A, 2001-307042. In this prior art, URL information of a web site relating to the printed matter is stored in a RFID tag attached to the printed matter (a page of a publication and the like), and by reading RFID tag information out of the RFID circuit element by a reader, the URL information can be gotten. As a result, the URL information of the web site relating to contents of the printed matter can be gotten accurately and easily.

Also, a prior art using the RFID for reproducing a personal work environment, for example, is described in JP,A, 2004-206698. In this prior art, work environment information including a seat height, inclination information of a seat back, setting information of illumination and air conditioner, description contents of a document medium (or display contents of a display medium) and the like is stored in the RFID tag provided at a card owned by an operator (user), and by reading the RFID tag information out of the RFID tag by a RFID tag information reading device (card reader), equipment is automatically controlled so that the work environment of the operator can be reproduced.

As mentioned above, data transmission/reception via radio communication using a RFID tag has been known and is being put into practice in a variety of fields. Here, after predetermined data to be processed is obtained by accessing the RFID tag, there might be some needs for each operator (user) in connection with processing of the data to be processed such that a file attribute such as read only is to be given to the data (so-called electronic files and the like), a part of the data should not be displayed, the data is to be displayed in a specific font or language and the like, for example. In this case, it is usually necessary that, after installing the electronic file from the RFID tag on a radio communication device side, the installed electronic file should be specified each time at the radio communication device for making corresponding setting (setting of the file attribute, setting of display/non-display, setting of font or language and the like). Thus, a labor of cumbersome operations can not be avoided for the operators, which gives a demerit in convenience.

In the prior art described in Japanese Utility Model Registration No. 3085050, after the predetermined data is obtained by accessing the URL relating to the attached matter (advertisement) of the RFID tag, only a simple function such as an image display function or voice generating function originally provided on the portable terminal side is used for providing predetermined display, music tunes and the like, and a fine setting function corresponding to the users' needs such as setting of the file attribute, display/non-display setting, font setting and the like of the data to be processed is not provided.

In the prior art described in JP,A, 2001-307042, the URL information of the web site relating to the printed matter is stored in the RFID tag. Thus, if a printed matter on which a new procedure format is described is to be circulated in a company, for example, a case where the data itself of the printed matter is to be obtained as the data to be processed can not be addressed. Thus, it is necessary to scan the printed matter itself to make it data, which is a huge labor.

In the prior art described in JP,A, 2004-206698, it is possible to reproduce the description contents of the data to be processed (electronic page) in the document medium, but the description contents of the electronic page generally refers to document information which has been created and edited by an operator and stored in a storage device such as a hard disk. Therefore, if the work environment is closed due to use of another user's terminal and the like in a state where the created/edited contents are not stored such as a case where the operator interrupts the work in the middle of the operation of creation, editing and the like of the document due to some reasons and wants to resume the operation later at different time from the work status at time of the interruption, for example, the work environment intended by the user can not be reproduced. Therefore, the operator has to construct the work environment again from the beginning, which is a huge labor.

Moreover, if the operator is to carry out the work using a PC terminal, for example, it is important to recover the operation work setting (such as a short cut) created by the user on the desktop when the work environment for the data to be processed is to be reproduced. However, since only the display contents of the display medium (data specifying characters, figures and tables, images and the like to be displayed on the display medium) can be reproduced by the above prior art, only the image information on the desk top is reproduced (that is, only the image information of the short cut is reproduced but its path information is not reproduced and the information does not function as a short cut), and the operation work setting can not be reproduced.

As mentioned above, any of the above prior arts does not sufficiently respond to the various needs of the operator for the data to be processed, and the labor of the operator can not be reduced, which is inconvenient.

### SUMMARY OF THE INVENTION

A first object of the present invention is to provide an apparatus for communicating with RFID tag, a processing device for communication with a RFID tag, a RFID tag, and a RFID tag communication system that can respond to various needs of an operator for data to be processed, reduce labor of an operator and improve convenience.

A second object of the present invention is to provide an apparatus for communicating with RFID tag and a RFID tag that can reduce the labor of the operator by enabling fine setting in response to the various needs of the operator for the data to be processed.

A third object of the present invention is to provide a processing device for communication with a RFID tag and a RFID tag that can reduce the labor of the operator by enabling easy reproduction of a work environment of the data to be processed at interruption.

A fourth object of the present invention is to provide an apparatus for communicating with RFID tag, a processing device for communication with a RFID tag, and a RFID tag communication system that can reduce the labor of the operator by enabling easy obtainment of data itself of a printed matter from the printed matter.

### BRIEF DESCRIPTION OF THE DRAWING

FIG. 1 is a system configuration diagram illustrating an entire RFID tag manufacturing system including an apparatus for producing RFID label of a first embodiment of the present invention.

FIG. 2 is a functional block diagram illustrating detailed functions of a PC and the apparatus for producing RFID label constituting the RFID tag manufacturing system.

FIG. 3 is a flowchart illustrating a control procedure executed by a control circuit of the apparatus for producing RFID label when file additional information and print information and the like are set and input.

FIG. 4 is a diagram illustrating an example of an additional information setting screen displayed on a display portion of the PC at Step S10.

FIG. 5 is a diagram illustrating an example of a file storage destination setting screen displayed on a display portion of the PC at Step S30.

FIG. 6 is a diagram illustrating an example of a print information setting screen displayed on a display portion of the PC at Step S50.

FIG. 7 is a diagram illustrating an example of a confirmation screen of tag production displayed on a display portion of the PC at Step S70.

FIG. 8 is a flowchart illustrating a detailed procedure of Step S100.

FIG. 9 is a top view illustrating an example of an entire schematic structure of a tag card produced by the apparatus for producing RFID label.

FIG. 10 is a block diagram illustrating an example of functional configuration of a RFID circuit element provided at the tag card.

FIG. 11 is a diagram illustrating an example of data structure of a memory part of an IC circuit part in the RFID circuit element provided at the tag card produced by the apparatus for producing RFID label.

FIG. 12 is a system configuration diagram illustrating an entire RFID tag reading system including a reader of the first embodiment of the present invention.

FIG. 13 is a functional block diagram illustrating detailed functions of the PC and the reader constituting the RFID tag reading system.

FIG. 14 is a flowchart illustrating a control procedure executed by a control circuit of the reader when the RFID tag information of the tag card is read out.

FIG. 15 is a system configuration diagram illustrating the entire RFID tag manufacturing system including the apparatus for producing RFID label of a second embodiment of the present invention.

FIG. 16 is a diagram illustrating an example of the file storage destination setting screen displayed on the display portion of the PC when the file access information is set and input at production of the tag card by the apparatus for producing RFID label.

FIG. 17 is a system configuration diagram illustrating the entire RFID tag reading system including a reader of the second embodiment of the present invention.

FIG. 18 is a system configuration diagram illustrating the entire RFID tag manufacturing system including an apparatus for producing RFID label of a third embodiment of the present invention.

FIG. 19 is a diagram illustrating an example of the file storage destination setting screen displayed on the display portion of the PC when the file access information is set and input at production of the tag card by the apparatus for producing RFID label.

FIG. 20 is a flowchart illustrating a control procedure executed by the control circuit of the apparatus for producing RFID label when the file additional information and the print information and the like are set and input.

FIG. 21 is a diagram illustrating an example of data structure of the memory part of the IC circuit part in the RFID circuit element provided at the tag card produced by the apparatus for producing RFID label.

FIG. 22 is a system configuration diagram illustrating the entire RFID tag reading system including a reader of the third embodiment of this invention.

FIG. 23 is a system configuration diagram illustrating the entire RFID tag manufacturing system including an apparatus for producing RFID label in a variation when an electronic file is created using a scanner.

FIG. 24 is a functional block diagram illustrating detailed functions of the PC and the apparatus for producing RFID label constituting the RFID tag manufacturing system in the variation when the electronic file is created using the scanner.

FIG. 25 is a flowchart illustrating a control procedure executed by the control circuit of the apparatus for producing RFID label when the file additional information and the print information and the like are set and input in the variation in which the electronic file is created using the scanner.

FIG. 26 is a system configuration diagram illustrating the entire RFID tag system including a PC of a fourth embodiment of the present invention.

FIG. 27 is a flowchart illustrating a control procedure executed by the control circuit of the PC at the production of the tag card.

FIG. 28 is a diagram illustrating an example of a display screen on the display portion of the PC when an operator interrupts a work in the middle.

FIG. 29 is a flowchart illustrating a control procedure executed by the control circuit of the apparatus for producing RFID label at the production of the tag card.

FIG. 30 is a top view illustrating an example of the entire schematic configuration of the tag card produced by the apparatus for producing RFID label.

FIG. 31 is a diagram illustrating an example of the data structure of the memory part of the IC circuit part in the RFID circuit element provided at the tag card produced by the apparatus for producing RFID label.

FIG. 32 is a flowchart illustrating a control procedure executed by the control circuit of the PC when the RFID tag information of the tag card is read out.

FIG. 33 is a flowchart illustrating a control procedure executed by the control circuit of the reader when the RFID tag information of the tag card is read out.

FIG. 34 is a diagram illustrating an example of the data structure of the memory part of the IC circuit part in the RFID circuit element in a variation when a plurality of works is carried out using a plurality of applications.

FIG. 35 is a system configuration diagram illustrating entire configuration of a network system including the RFID tag system having a PC, which is an information terminal, of a fifth embodiment of the present invention.

FIG. 36 is a functional block diagram obtained by extracting the PC of the RFID tag system and the apparatus for producing RFID label among the plurality of RFID tag systems in the network system and illustrating their detailed functions.

FIG. 37 is a flowchart illustrating a control procedure executed by the control circuit of the PC at the production of the tag card.

FIG. 38 is a diagram illustrating an example of the display screen on the display portion of the PC when the operator interrupts the work in the middle.

FIG. 39 is a diagram illustrating an example of the data structure of the memory part of the IC circuit part in the RFID circuit element provided at the tag card.

FIG. 40 is a functional block diagram obtained by extracting the PC of the RFID tag system and the reader among the plurality of RFID tag systems in the network system and illustrating their detailed functions.

FIG. 41 is a flowchart illustrating a control procedure executed by the control circuit of the PC when the RFID tag information of the tag card is read out.

FIG. 42 is a flowchart illustrating a control procedure executed by the control circuit of the PC at the production of the tag card in a variation in which a part of short cuts selected from among the short cuts on a desk top are stored.

FIG. 43 is a diagram illustrating an example of the display screen on the display portion of the PC when the operator interrupts the work in the middle in a variation in which a holder on the desk top is stored.

FIG. 44 is a diagram illustrating an example of the data structure of the memory part of the IC circuit part in the RFID circuit element in a variation in which the operator manually inputs a tag production instruction.

FIGS. 45A and 45B are diagrams illustrating an example of the data structure of the memory part of the IC circuit part in the RFID circuit element in a variation in which identification information of personal work information is written in a tag.

FIG. 46 is a flowchart illustrating a control procedure executed by the control circuit at the production of the tag card in a variation in which those to be written in the tag and those not are discriminated among the personal information.

FIG. 47 is a system configuration diagram illustrating entire configuration of a manufacturing system for printed matter with tag including a printing management system having a printing device according to a sixth embodiment of the present invention.

FIG. 48 is a functional block diagram illustrating detailed functions of the PC, the printer, and the apparatus for producing RFID label constituting the manufacturing system for printed matter with tag.

FIG. 49 is a flowchart illustrating a control procedure executed by the control circuit of the PC at the production of a printed matter with tag.

FIG. 50 is a flowchart illustrating a detailed procedure of Step S3100.

FIG. 51 is a flowchart illustrating a control procedure executed by the control circuit of the printer at the production of the printed matter with tag.

FIG. 52 is a flowchart illustrating a control procedure executed by the control circuit of the apparatus for producing RFID label at the production of the printed matter with tag.

FIG. 53 is a flowchart illustrating a detailed procedure of Step S3400.

FIG. 54 is a diagram illustrating signal transmission/reception among the PC, the printer, and the apparatus for producing RFID label in a time sequence in control executed at the production of the printed matter with tag.

FIGS. 55A to 55C are a top view illustrating an example of an entire schematic configuration of a printed matter produced by the printer and the RFID label produced by the apparatus for producing RFID label, a top view illustrating an example of an entire schematic configuration of the printed matter with tag produced by attaching the RFID label on the printed matter, a top view of the RFID label when a user selects another format, and a top view of the printed matter with tag.

FIG. 56 is a diagram illustrating an example of the data structure of the memory part of the IC circuit part in the RFID circuit element provided at the RFID label produced by the apparatus for producing RFID label.

FIG. 57 is a system configuration diagram illustrating entire configuration of the printing management system at the reading of the printed matter with tag.

FIG. 58 is a functional block diagram illustrating detailed functions of the PC and the reader constituting the printing management system.

FIG. 59 is a flowchart illustrating a control procedure executed by the control circuit of the reader when the RFID tag information of the RFID label is read out.

FIG. 60 is a system configuration diagram illustrating entire configuration of the manufacturing system for printed matter with tag in a variation in which file data is stored in a server connected to the network.

FIG. 61 is a functional block diagram illustrating the detailed functions of the PC, the printer, the apparatus for producing RFID label, and an information server constituting the manufacturing system for printed matter with tag.

FIGS. 62A and 62B are top views illustrating an example of an entire schematic configuration of the printed matter with tag produced by attaching the RFID label produced by the apparatus for producing RFID label on the printed matter produced in the variation in which there is a plurality of printed matters.

FIGS. 63A to 63C are diagrams illustrating an example of the data structure of the memory part of the IC circuit part in the RFID circuit element when the identification information of the file data to be printed is written, when the file additional information corresponding to the file data to be printed is written, and when authority information relating to an access to the file data or various processing after the access is written, respectively.

FIG. 64 is a top view illustrating an example of the printed matter with tag when a thumb-nail image of a top page on the printed matter is printed.

FIG. 65 is a top view illustrating an example of the printed matter with tag when the file access information is printed.

FIG. 66 is a flowchart illustrating a control procedure executed by the control circuit of the reader in a variation having a function to check if the printed matter is the latest or not.

FIG. 67 is a flowchart illustrating a control procedure executed by the control circuit in a variation in which the file data itself is written if there is an extra storage capacity in the RFID circuit element.

FIG. 68 is a flowchart illustrating a control procedure executed by the control circuit of the reader when the RFID tag information of the RFID label is read out in the variation in which the file data itself is written if there is an extra storage capacity in the RFID circuit element.

### DETAILED DESCRIPTION OF THE PREFERRED EMBODIMENTS

Embodiments of the present invention will be described below referring to the attached drawings.

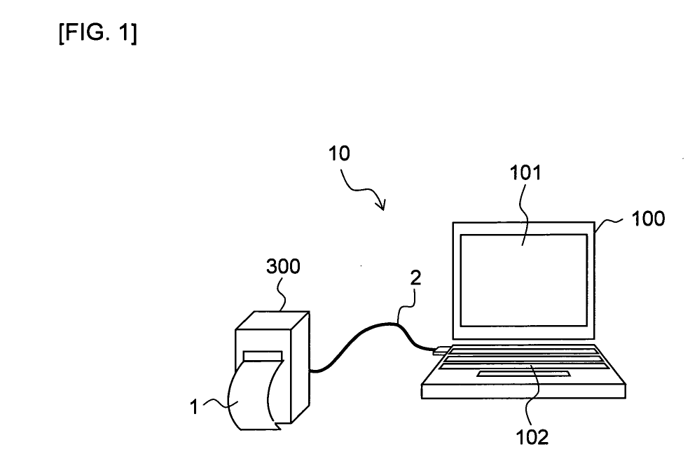

A first embodiment of the present invention will be described referring to FIGS. 1 to 14.

FIG. 1 is a system configuration diagram illustrating an entire RFID tag manufacturing system including an apparatus 300 for producing RFID label of this embodiment (tag card manufacturing device, an apparatus for communicating with RFID tag).

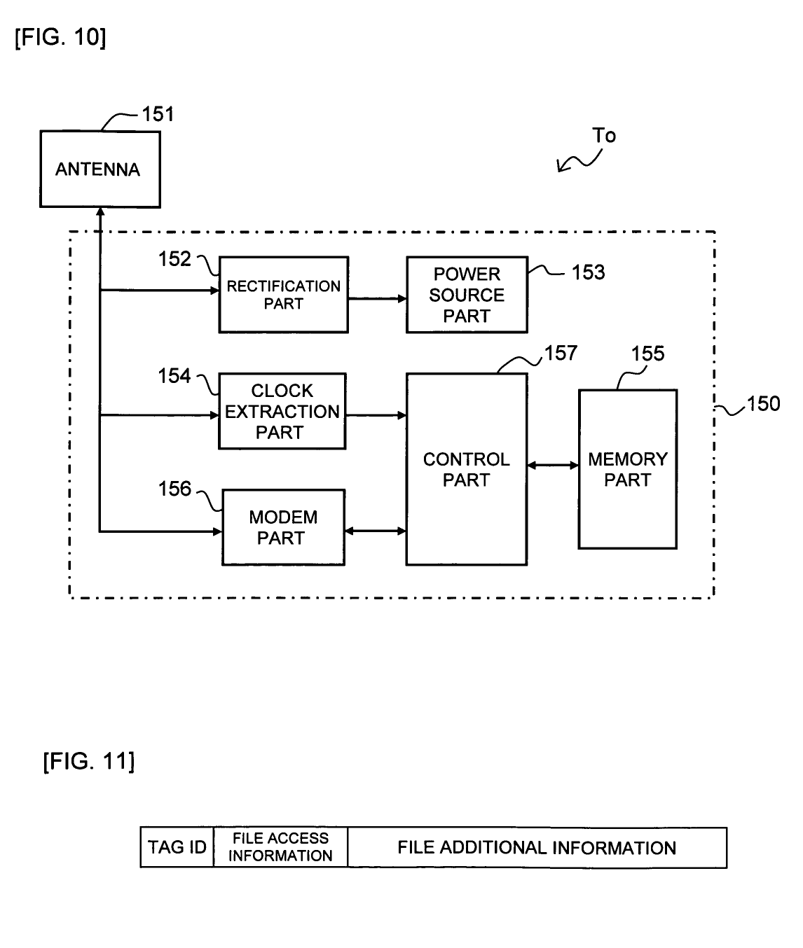

A RFID tag manufacturing system 10 shown in FIG. 1 comprises an apparatus 300 for producing RFID label configured to produce a tag card 1 (RFID label, RFID tag) having a RFID circuit element To (See FIG. 10, which will be described later) provided with an IC circuit part 150 storing information and an antenna 151 (tag antenna) connected to the IC circuit part 150 and a PC terminal (or general-purpose computer. Hereinafter described as “PC”) 100 connected to the apparatus 300 for producing RFID label via a connecting member 2 such as a USB cable, for example, and having a display portion 101, an operation portion 102 and the like.

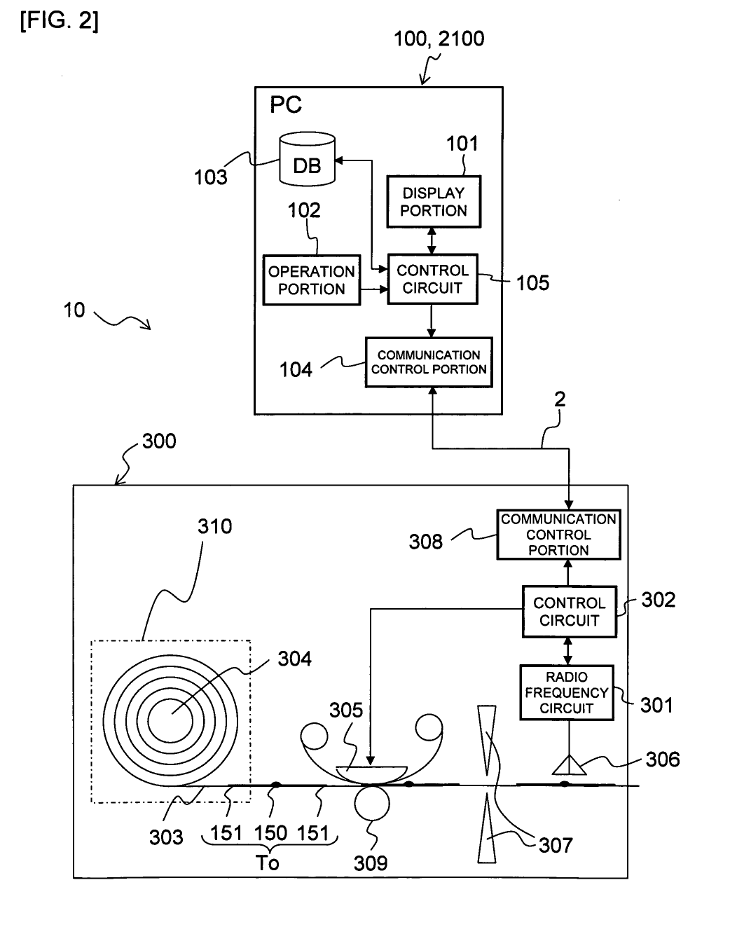

FIG. 2 is a functional block diagram illustrating detailed functions of the PC 100 (operation terminal) and the apparatus 300 for producing RFID label constituting the RFID tag manufacturing system 10.

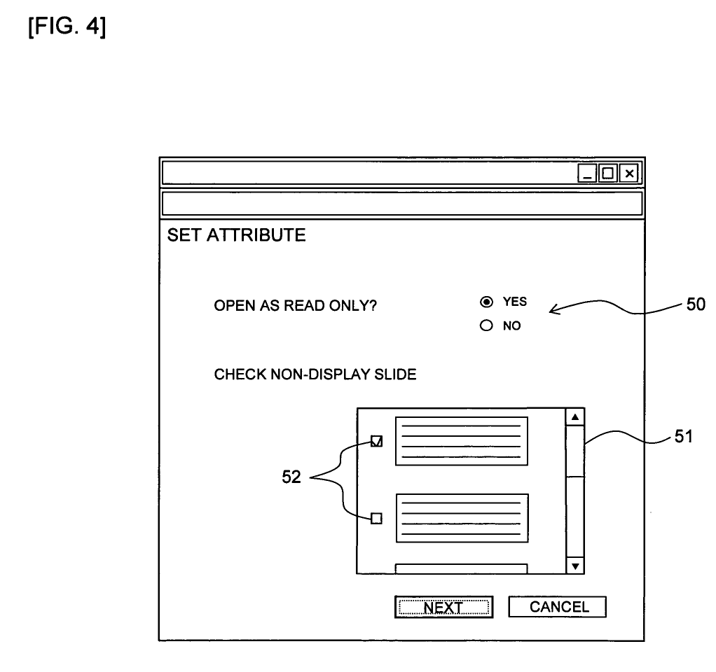

In FIG. 2, the PC 100 has the display portion 101 configured to make predetermined display such as various input screens (see FIGS. 4 to 7 and the like, which will be described later), the operation portion 102 provided with an appropriate button, key, mouse and the like for an operator to make an operation input, a database 103 in which an electronic file and the like capable of performing predetermined processing by the tag card 1 (the details will be described later) are stored and functioning as a storage means (memory portion), a communication control portion 104 that controls communication made with the apparatus 300 for producing RFID label via the connecting member 2, and a control circuit 105 configured to control an entire operation of the PC 100 including the display portion 101, the operation portion 102, the database 103, and the communication control portion 104.

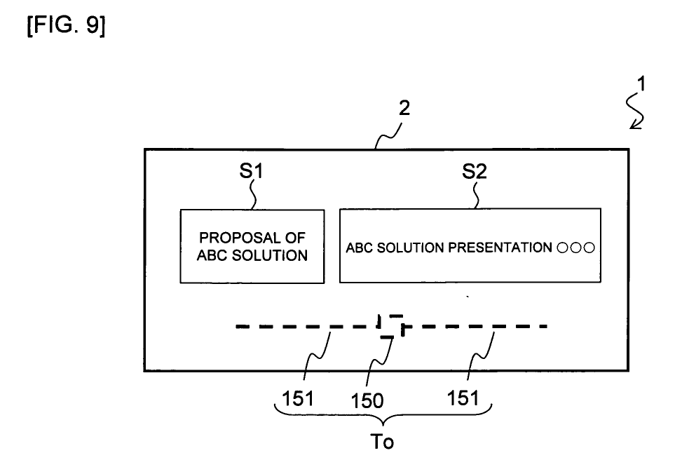

On the other hand, the apparatus 300 for producing RFID label has a holder portion 310a of roll of a tape with RFID tags that can detachably attach a roll 304 of a tape with RFID tags around which a tag tape 303 (tag medium) provided with RFID circuit elements To with a predetermined interval (or detachably attach a cartridge provided with the roll 304 of a tape with RFID tags) is wound, a print head 305 (first printing device) configured to apply a desired print on regions S1, S2 (See FIG. 9, which will be described later) corresponding to the RFID circuit element To in the tag tape 303 fed out of the roll 304 of a tape with RFID tags, an antenna 306 (antenna for production) configured to transmit/receive information with the RFID circuit element To via radio communication, a radio frequency circuit 301 and a control circuit 302, a communication control portion 308 configured to control communication made with the PC 100 via the connecting member 2, a cutter 307 configured to cut the tag tape 303 with which the print on the tag tape 303 and the information writing into the RFID circuit element To have been finished to a predetermined length so as to produce the tag card 1, and a feeding device 309 provided oppositely to the print head 305 and configured to feed the roll 304 of a tape with RFID tags under control by the control circuit 302.

The radio frequency circuit 301 and the control circuit 302 create access information to the IC circuit part 150 of the RFID circuit element To, transmits it to the RFID circuit element To via the antenna 306, and writes the information in the IC circuit part 150 of the RFID circuit element To. The control circuit 302 is connected to the PC 100 via the connecting member 2 so that information can be transmitted/received with the PC 100.

In such a configuration, if the tag card 1 is to be produced by the apparatus 300 for producing RFID label, the operator uses the operation portion 102 of the PC 100 so as to set and input file additional information (in this example, file attribute information and the like. The details will be described later) as processing assisting information for operator relating to the electronic file (data to be processed), print information and the like and inputs a production instruction of the tag card. When the production instruction signal is transmitted to the apparatus 300 for producing RFID label via the connecting member 2, by control of the control circuit 302 of the apparatus 300 for producing RFID label, print is applied by the print head 305 on the basis of the setting input information, and the access information is created by the radio frequency circuit 301 and transmitted to the RFID circuit element To via the apparatus antenna 306. As a result, the file additional information and the like are written in the IC circuit part 150 of the RFID circuit element To, and the tag card 1 is produced.

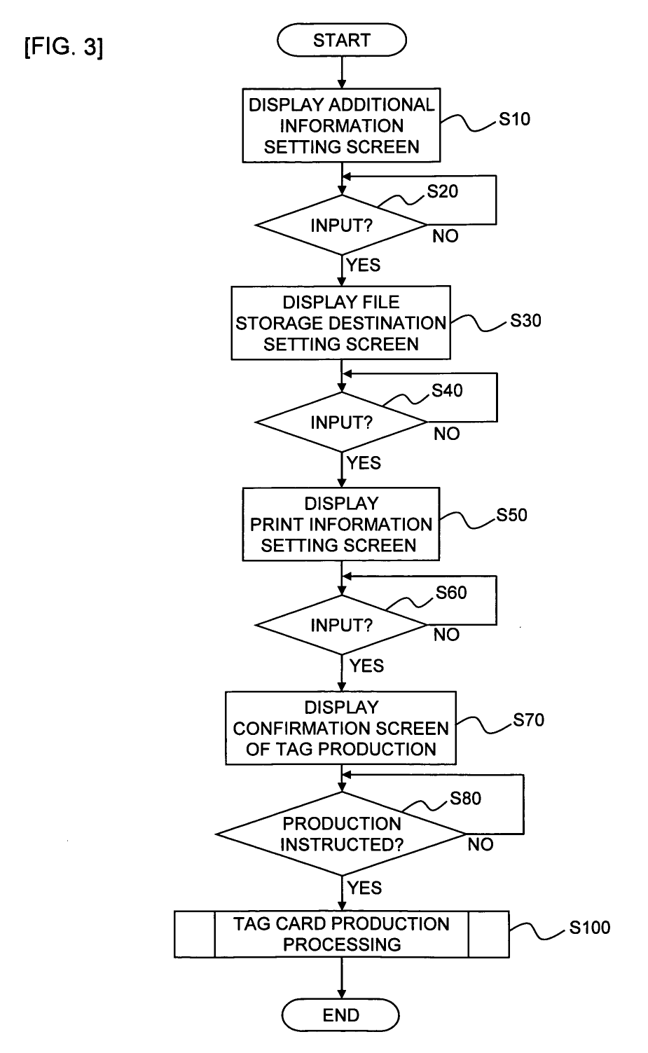

FIG. 3 is a flowchart illustrating a control procedure executed by the control circuit 302 of the apparatus 300 for producing RFID label when settings of the file additional information, print information and the like are input.

In FIG. 3, first at Step S10, a control signal is output to the control circuit 105 of the PC 100 via the communication control portion 308 and the connecting member 2, and a display signal is output to the display portion 101 from the control circuit 105 (setting display signal output device) so that the setting screen of the additional information relating to the electronic file to be processed is displayed on the display portion 101, and an operator is prompted to input the file additional information (See FIG. 4, which will be described later). Here, the electronic file is a presentation file made of a plurality of slides, and whether the entire file should be read-only or not (file attribute information) and whether display is made for each slide or not (processing mode information) can be set.

At the subsequent Step S20, according to the additional information setting screen, it is determined if the operator has input the additional information relating to the electronic file using the operation portion 102 or not. If the file additional information has been input, and the information has been received via the communication control portion 104 and the connecting member 2, the determination is satisfied, and the routine goes to the subsequent Step S30.

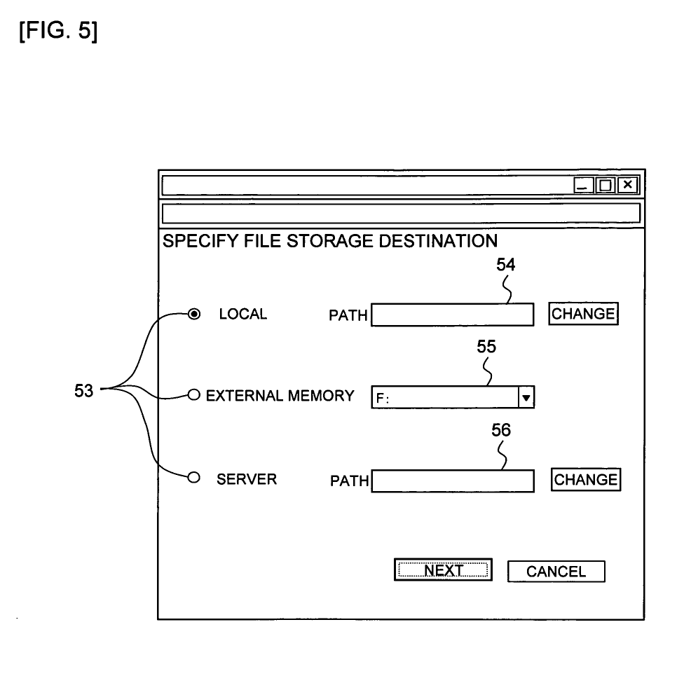

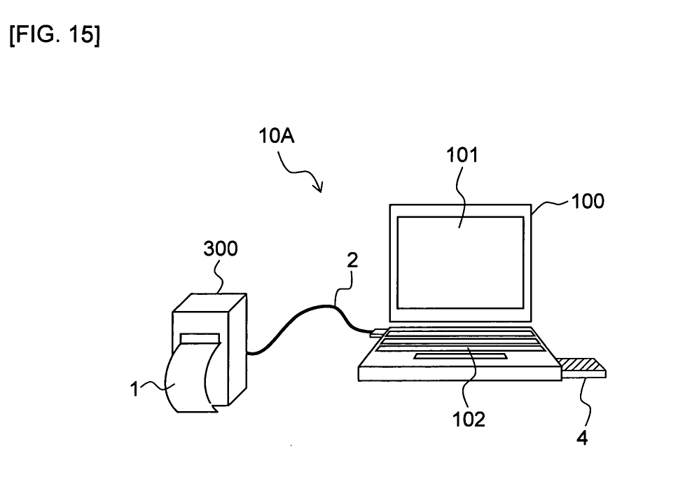

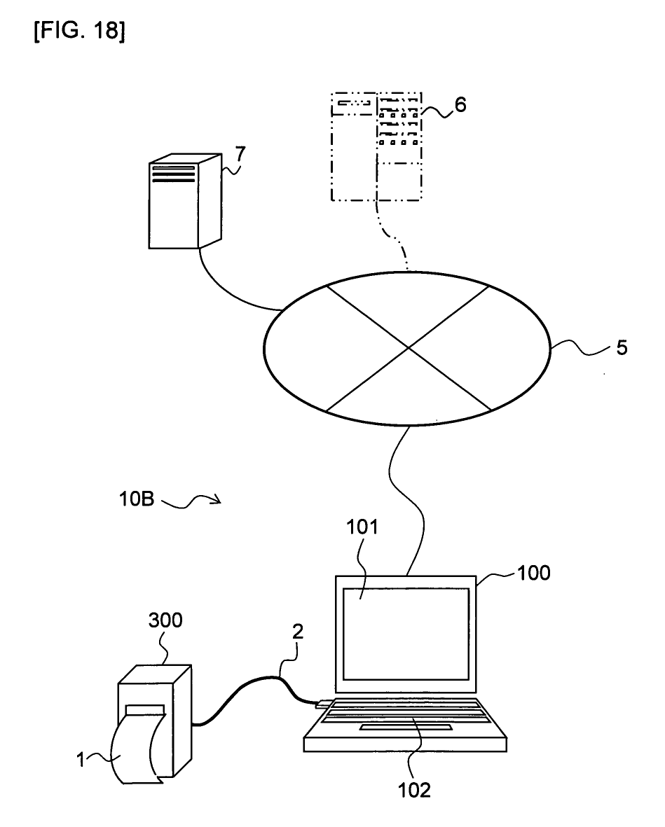

At Step S30, a control signal is output to the control circuit 105 of the PC 100 via the communication control portion 308 and the connecting member 2, a setting screen of a destination to store the electronic file to be processed is displayed on the display portion 101, and an operator is prompted to input the file access information, which is the information on the destination to store the file (See FIG. 5, which will be described later). Here, any one of the database 103 provided at the PC 100 (shown as “local” in FIG. 5), an external memory such as a USB memory (See FIG. 15, which will be described later), and an external server connected via a communication line and the like (See FIG. 18, which will be described later) can be selected and specified as the destination to store.

At the subsequent Step S40, according to the file storage destination setting screen, it is determined if the operator has input the destination to store the electronic file using the operation portion 102 or not. If the file access information has been input and the information has been input via the communication control portion 104 and the connecting member 2, the determination is satisfied and the routine goes to the subsequent Step S50.

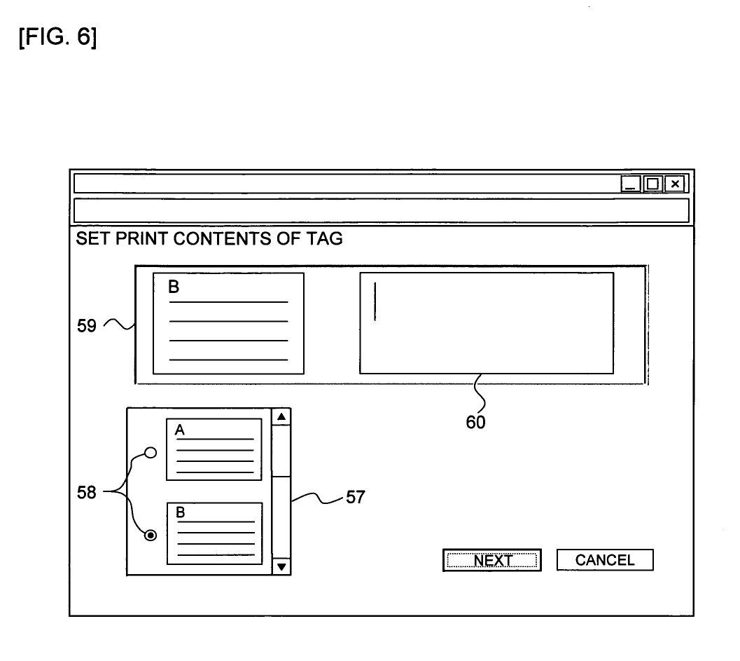

At Step S50, a control signal is output to the control circuit 105 of the PC 100 via the communication control portion 308 and the connecting member 2, a setting screen of the print information to be printed on a print region of the tag card 1 is displayed on the display portion 101, and an operator is promoted to input the print information (See FIG. 6, which will be described later). Here, a slide for printing a thumb-nail image (size-reduced image of a slide) can be selected and arbitrary text information can be input. In this setting screen, if the slide to have the thumb-nail image printed is not selected, a thumb-nail image of a slide of a top page (or it may be an abstract page and the like), which is an initial setting, is printed. Also, if the text is not input, identification information of the electronic file (a file name, for example), which is an initial setting, is printed.

At the subsequent Step S60, according to the setting screen of the print information, it is determined if the operator has input the print information using the operation portion 102 or not. If the print information has been input, and the information has been input via the communication control portion 104 and the connecting member 2, the determination is satisfied and the routine goes to the subsequent Step S70.

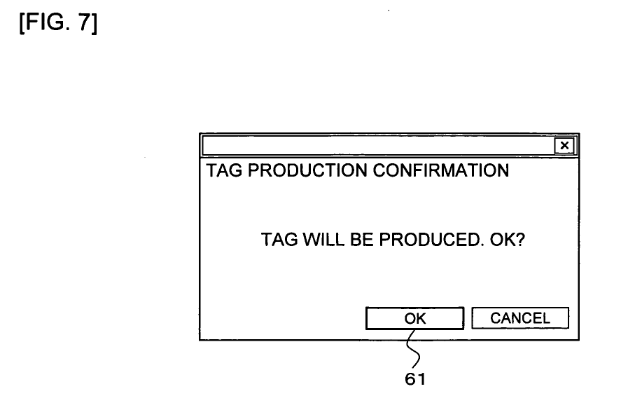

At Step S70, a control signal is output to the control circuit 105 of the PC 100 via the communication control portion 308 and the connecting member 2, a final confirmation screen on whether the tag card 1 is to be produced or not is displayed on the display portion 101, and an operator is prompted to input a tag card production instruction (See FIG. 7, which will be described later)

At the subsequent Step S80, according to the confirmation screen, it is determined if the operator has input the production instruction of the tag card using the operation portion 102 or not. If the production instruction has been input and a production instruction signal has been input via the communication control portion 104 and the connecting member 2, the determination is satisfied and the routine goes to the subsequent Step S100.

At Step S100, the print is applied by the print head 305 on the basis of the print information set and input at Step S50, the file additional information set at Step S10, the file access information set at Step S30, and writing information (tag ID) are written in the IC circuit part 150 of the RFID circuit element To and the tag card production processing that produces the tag card 1 is executed. Then, this flow is finished.

Though not particularly described in the above flow, a tag ID, which is identification information of the RFID circuit element To, is automatically allocated as writing information so that the tag ID and the various setting information (file additional information, file access information and print information) are associated with each other and stored in the database 103 of the PC 100. Also, though not particularly shown in the above flow, if a cancellation button (See FIGS. 4 to 7, which will be described later) is operated in each input screen, the flow is terminated.

FIG. 4 is a diagram illustrating an example of the additional information setting screen displayed on the display portion 101 of the PC 100 at Step S10. In FIG. 4, the electronic file is a presentation file made of a plurality of slides as mentioned above, whether the entire file is to be read only or not can be set by a radio button 50 in the screen, and whether display is made for each slide or not can be set by each check box 52 in a window 51 on the screen.

FIG. 5 is a diagram illustrating an example of the file storage destination setting screen displayed on the display portion 101 of the PC 100 at Step S30. In FIG. 5, if the electronic file is to be stored in the data base 103 provided at the PC 100, “local” is selected by a radio button 53 and a path of the storage destination is input in an input window 54. This “local” is selected when the electronic file is presented and the like by carrying the PC 100 to an outside location, for example. On the other hand, if the electronic file is to be stored in an external memory such as a USB memory (See FIG. 15, which will be described later), “external memory” is selected by the radio button 53 and a path of the storage destination is input in an input window 55. Alternatively, if the electronic file is to be stored in an external server (See FIG. 18, which will be described later) connected via a communication line and the like, “server” is selected by the radio button 53 and a path of the storage destination is input in an input window 56.

FIG. 6 is a diagram illustrating an example of the print information setting screen displayed on the display portion 101 of the PC 100 at Step S50. In FIG. 6, the electronic file is a presentation file made of a plurality of slides, and a thumb-nail image of which slide is to be printed is selected by the radio button 58 as an input portion in a window 57 (the slide B is selected in the figure). Also, the operator can input arbitrary text information in a text input area 60 in a window 59. As mentioned above, if the slide was not selected in the window 57, a slide of a top page (or may be an abstract page and the like), which is an initial setting, is selected. If text was not input in the text input area 60, the identification information of the electronic file (file name, for example), which is an initial setting, is printed (See FIG. 9, which will be described later).

FIG. 7 is a diagram illustrating an example of the confirmation screen of tag production displayed on the display portion 101 of the PC 100 at Step S70. In FIG. 7, if the operator operates an OK button 61, the determination at Step S80 is satisfied, the routine goes to Step S90, the production instruction signal of the tag card is transmitted to the control circuit 302 of the apparatus 300 for producing RFID label via the connecting member 2 from the PC 100.

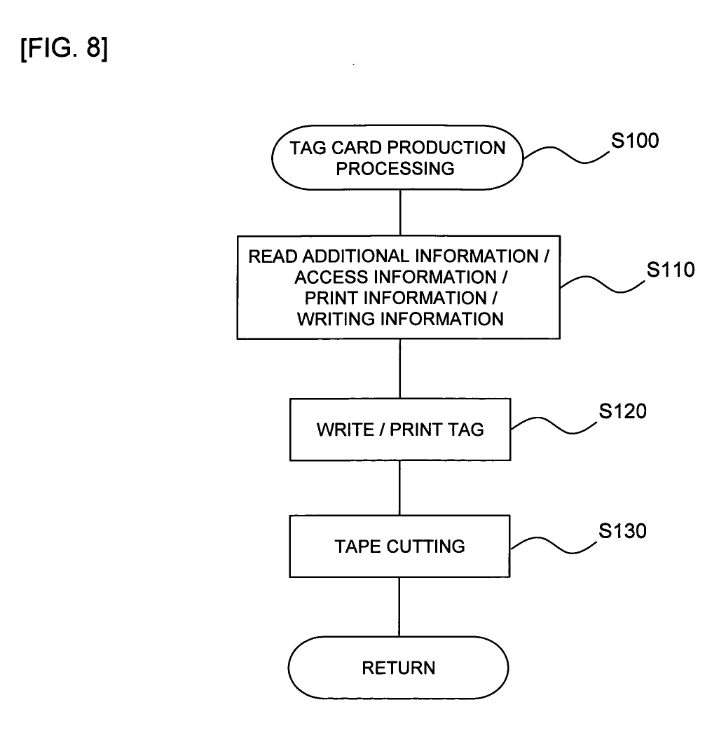

FIG. 8 is a flowchart illustrating a detailed procedure of Step S100.

In FIG. 8, first, at Step S110, a control signal is output to the control circuit 105 of the PC 100 via the communication control portion 308 and the connecting member 2, an access is made to the database 103, and the various setting information, that is, file additional information, file access information, print information to be printed on the print region of the tag card 1 by the print head 305, and the writing information to the RFID circuit element To (tag access information including at least a tag ID) are gotten. Then, an information signal corresponding to the file additional information and the file access information is created by the radio frequency circuit 301 (file additional information creating portion, file access information creating portion), and a signal corresponding to the writing information is created (tag access information creating portion).

After that, the routine goes to Step S120, where each information signal created at Step S110 is transmitted to the RFID circuit element To via the apparatus antenna 306 and written in the IC circuit part 150 (production-side access portion, transmission/reception control portion). Also, the print is applied by the print head 305 on the basis of the print information gotten at Step S110.

At the subsequent Step S130, tape cutting is carried out so as to produce the tag card 1 provided with one RFID circuit element To, and this routine is finished.

FIG. 9 is a top view illustrating an example of an entire schematic configuration of the tag card 1 produced by the apparatus 300 for producing RFID label by the above control.

In FIG. 9, the tag card 1 is formed in a card shape and is constituted by a substantially square thin plate-shaped base 2 and the RFID circuit element To positioned on the base 2 and provided with the IC circuit part 150 storing information and the antenna 151 connected to the IC circuit part 150.

On the front side (upper face) of the base 2, a region S1 on which a representative portion of the contents in the electronic file to be applied with predetermined processing by the tag card 1 (in this example, a thumb-nail image of a slide of a top page in which “Proposal of ABC Solution” is described. It may be a figure or sentence including the thumb-nail image) is printed and a region S2 on which the identification information of the electronic file (in this example, a file name of “ABC solution presentation”) is printed are provided. It is not necessarily required to print both of the regions S1, S2 but only either one of them may be printed. It does not have to be characters but may be a figure, symbol or simply color painted, pattern and the like as long as the electronic file contents can be recognized/identified in some form. The size of the tag card 1 can be constituted as various sizes such as a name card, for example. The RFID circuit element To may be attached (a label-like one is affixed, for example) on paper of usual A4-size, B-5 size and the like (does not have to be printed).

The RFID circuit element To is positioned in a biased manner to one side (in this example, lower side in FIG. 1) from the center part in the plane direction of the base 2 (in this example, center part in the vertical direction in FIG. 1) in this example. In other words, the region S and the RFID circuit element To are arranged so that they are not overlapped with each other as much as possible on plan view.

FIG. 10 is a block diagram illustrating an example of functional configuration of the RFID circuit element To provided at the tag card 1.

In FIG. 10, the RFID circuit element To has an antenna 151 (tag antenna) that carries out signal transmission/reception contactlessly using a radio frequency such as a short-wave band (13.56 MHz, for example), UHF band or microwave band with the antenna 306 of the apparatus 300 for producing RFID label and an antenna 210 of a reader 200 provided with a function to read out the RFID circuit element To, which will be described later, and the IC circuit part 150 connected to the antenna 151.

The IC circuit part 150 includes a rectification part 152 that rectifies an interrogation wave received by the antenna 151, a power source part 153 that accumulates energy of the interrogation wave rectified by the rectification part 152 so as to make it a driving power supply, a clock extraction part 154 that extracts a clock signal from the interrogation wave received by the antenna 151 so as to supply it to a control part 157 (which will be described later), a memory part 155 which can store a predetermined information signal, a modem part 156 connected to the antenna 151, and the control part 157 that controls operation of the RFID circuit element To through the memory part 155, the clock extraction part 154, the modem part 156 and the like.

The modem part 156 demodulates a communication signal from the antenna 306 of the apparatus 300 for producing RFID label and the antenna 210 of the reader 200 received by the antenna 151 and modulates a reply signal from the control part 157 and transmits it as a response wave from the antenna 151.

The control part 157 executes basic control such as interpretation of a received signal demodulated by the modem part 156, generation of a reply signal on the basis of the information signal stored in the memory part 155, and return of reply by the modem part 156 from the antenna 151.

FIG. 11 is a diagram illustrating an example of data structure of the memory part 155 of the IC circuit part 150 in the RFID circuit element To provided at the tag card 1 produced by the apparatus 300 for producing RFID label as above.

In the example shown in FIG. 11, the data stored in the memory part 155 of the IC circuit part 150 in the RFID circuit element To is constituted by the tag ID as the above-mentioned writing information, the file access information, which is information of the destination to store the electronic file to be processed, the file attribute information on whether or not the entire electronic file is to be read-only, and the file additional information made of processing mode information on whether or not display is made for each slide.

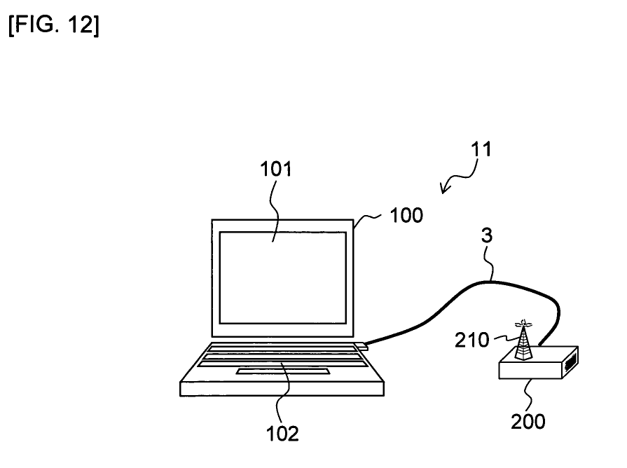

FIG. 12 is a system configuration diagram illustrating an entire RFID tag reading system including the reader 200 (apparatus for communicating with RFID tag) of this embodiment.

The RFID tag reading system 11 shown in FIG. 12 is provided with the reader 200 having the antenna 210 (antenna for reading) configured to read out information from the tag card 1 produced by the apparatus 300 for producing RFID label via radio communication and the PC 100 connected to the reader 200 via a connecting member 3 such as a USB cable, for example, and having the display portion 101, the operation portion 102 and the like. The RFID tag reading system 11 is used when an electronic file is to be presented by carrying the PC 100 and the reader 200 to an outside location (as for the reader, it does not have to be carried but a general-purpose reader may be borrowed for a while at an outside location, for example), for example. In this case, when the tag card 1 is to be produced, at the above-mentioned Step S30, the “local” is selected by the radio button 53 and set so that the electronic file for presentation is stored in the database 103 of the PC 100.

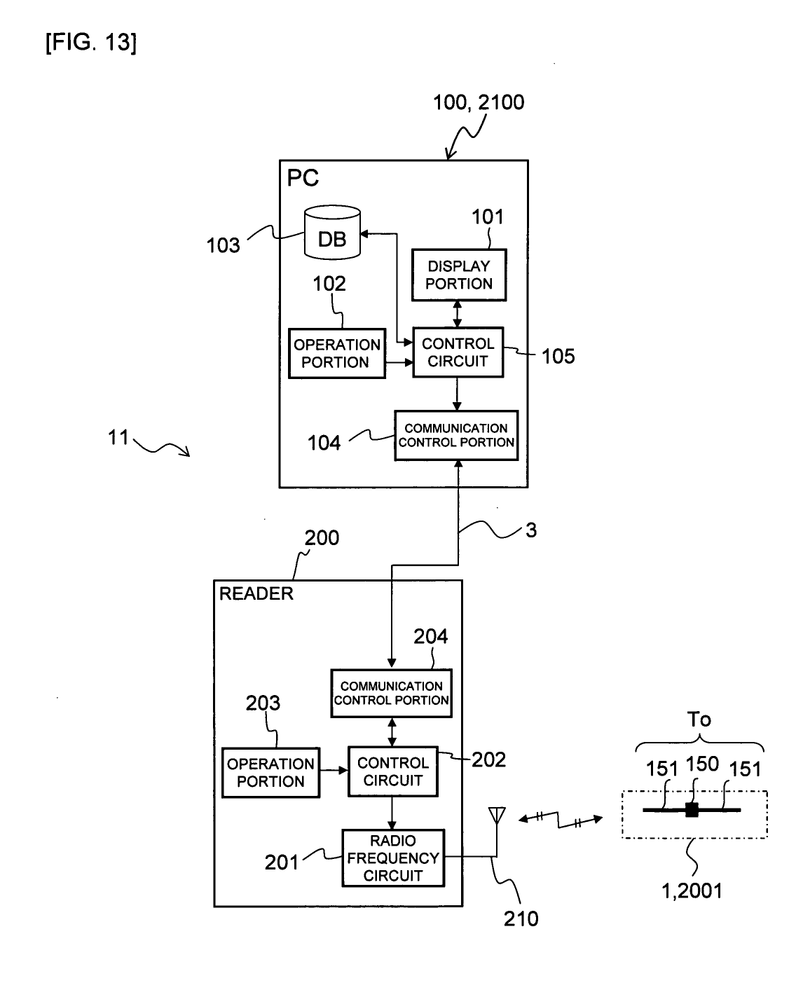

FIG. 13 is a functional block diagram illustrating detailed functions of the PC 100 and the reader 200 constituting the RFID tag reading system 11. In FIG. 13, the reader 200 has the antenna 210 that transmits/receives a signal with the antenna 151 of the RFID circuit element To provided at the tag card 1 via radio communication, the radio frequency circuit 201 that accesses (for reading in this example) the IC circuit part 150 of the RFID circuit element To via the antenna 210 and processes the signal read out of the RFID circuit element To, a control circuit 202 that includes a function to process the signal read out of the IC circuit part 150 of the RFID circuit element To via the radio frequency circuit 201 so as to read out the information and to create the access information to access the IC circuit part 150 of the RFID circuit element To and controls an entire operation of the reader 200, an operation portion 203 provided with an appropriate button, key and the like that can be operated by an operator, and a communication control portion 204 that controls communication with the PC 100 via the connecting member 3.

In such a configuration, in order to read out the RFID tag information of the tag card 1 by the reader 200, the tag card 1 is brought close to the side of the reader 200 (to have it present in a communicable range). At this time, as mentioned above, the IC circuit part 150 of the RFID circuit element To in the tag card 1 stores and holds the file access information and file additional information relating to the electronic file to be processed, and when the information is gotten by the side of the reader 200, the electronic file is read in from the database 103 of the PC 100 on the basis of the file access information, and the electronic file is opened on the basis of the above-gotten file additional information and displayed on the display portion 101.

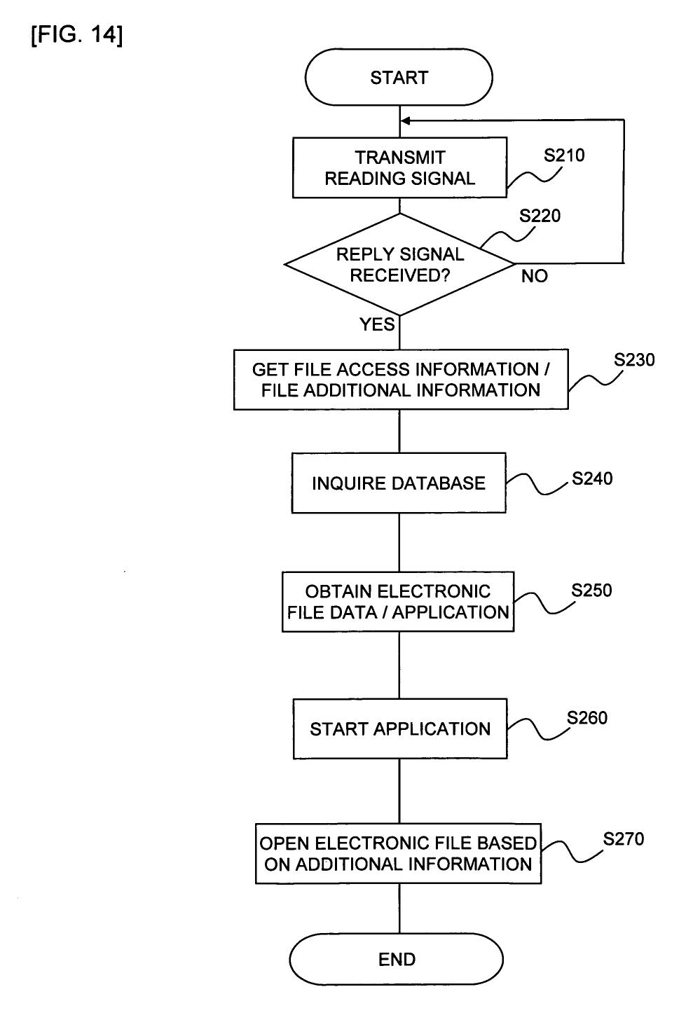

FIG. 14 is a flowchart illustrating a control procedure executed by the control circuit 202 of the reader 200, when the RFID tag information of the tag card 1 is read out.

In FIG. 14, first, at Step S210, via the radio frequency circuit 201 and the antenna 210, a signal to read out the information stored in the IC circuit part 150 of the RFID circuit element To in the tag card 1 is transmitted. In detail, a “Scroll ALL ID” signal (or a “Ping” signal) to read out the information stored in the RFID circuit element To is created and transmitted to the RFID circuit element To present in the communication range via the radio frequency circuit 201, for example, and a reply is prompted.

After that, the routine goes to Step S220, where it is determined if the reply signal transmitted (returned) from the RFID circuit element To in response to the “Scroll ALL ID” signal has been received via the antenna 210 and taken into the control circuit 202 via the radio frequency circuit 201. These Step S210 and Step S220 constitute an information access portion for reading and also constitute a transmission/reception control portion.

If the reply signal has not been received, the determination is not satisfied, the routine returns to Step S210 and the similar procedure is repeated. If the reply signal has been received, the determination at Step S220 is satisfied, and the routine goes to Step S230.

At Step S230, from the reply signal received from the RFID circuit element To, the file access information and the file additional information (in this example, the file attribute information on whether or not the entire file is to be read-only and the processing mode information on whether or not display is made for each slide), which is information of the storage destination of the electronic file, are read out and gotten (additional information acquisition portion). The read-out information is temporarily stored in an appropriate storage device (such as a memory provided at the control circuit 202, for example).

Subsequently, at Step S240, a control signal is output to the control circuit 105 of the PC 100 as processing equipment via the communication control portion 204 and the connecting member 3, and an inquiry on the electronic file data is made to the database 103 on the basis of the file access information gotten at Step S230.

At the subsequent Step S250, data of the electronic file corresponding to the inquiry at Step S240 is read out of the database 103, and a predetermined application (Japanese language software, drawing software and the like, for example) corresponding to the electronic file is obtained. The read-out electronic file data and application data are temporarily stored in an appropriate storage device (such as a RAM provided at the control circuit 105, for example). With regard to the application, an appropriate application is selected according to the type of the electronic file.

Then, at Step S260, a control signal is output to the control circuit 105 of the PC 100 via the communication control portion 204 and the connecting member 3 so as to start the application obtained at Step S250.

After that, at Step S270, a control signal is output to the control circuit 105 of the PC 100 via the communication control portion 204 and the connecting member 3 (processing signal output portion), and while file processing is carried out on the basis of the file additional information gotten at Step S230, the electronic file is opened on the started application. That is, in this example, on the basis of the setting shown in the above-mentioned FIG. 4, the electronic file is opened as read only and only the slide other than the slides for which the non-display setting was made is displayed on the display portion 101. Then, this flow is finished.

In the above, Step S40 executed by the control circuit 302 constitutes a storage operation signal input portion that inputs a storage operation signal for operating and specifying a storage destination of the electronic file described in each claim, Step S60 constitutes a print operation signal input portion that inputs a print operation signal, and Step S80 constitutes an instruction signal input portion that inputs a start instruction signal for instructing start of production of the RFID tag.

In the apparatus 300 for producing RFID label of this embodiment constituted as above, the radio communication information to the tag card 1 is produced by the control circuit 302, the file additional information relating to the electronic file is created as well, at least the radio communication information and the file additional information are written in the IC circuit part 150 of the RFID circuit element To via the antenna 306 at the radio frequency circuit 301, and the tag card 1 is produced. Then, when information is read out of the IC circuit part 150 of the RFID circuit element To in thus produced tag card 1 by the reader 200, the file is opened by the control circuit 302 according to a reading result thereof and displayed on the display portion 101 of the PC 100.

At this time, in this embodiment, since the file additional information is written in the IC circuit part 150 of the RFID circuit element To, when the file display operation is carried out on the display portion 101 of the PC 100 on the basis of the reading by the reader 200, processing corresponding to the file additional information can be carried out. That is, in this embodiment, the electronic file can be opened as a read-only file according to its attribute information and in the electronic file made of a plurality of slides, only the slide other than the slides for which non-display setting is made can be displayed according to the processing mode information.

As a result, if a presentation is to be made for customers A, B, for example, if the tag card 1 in which the slide display setting for each customer is stored as the file additional information, has been produced, respectively, only by storing a single electronic file for presentation in the database 103 in the PC 100, the electronic file for presentation can be displayed on the display portion 101 of the PC 100 with the display setting corresponding to each customer by reading the corresponding tag card 1 by the reader 200 at presentation for the customer. As mentioned above, fine settings and the like corresponding to the needs of the user in the processing of electronic files can be automatically executed without requiring a special operation. As a result, a labor of the operator can be reduced and convenience can be greatly improved.

Also, particularly in this embodiment, the attribute information on whether or not the electronic file is set to be read-only is included in the file additional information. As a result, when the reading processing of the electronic file from the database 103 of the PC 100 is carried out, the electronic file corresponding to the file attribute information can be opened as read-only. As a result, writing, modification, overwrite saving and the like of the electronic file can be prevented.

Also, particularly in this embodiment, display/non-display setting information of each slide in the electronic file made of a plurality of slides is included in the file additional information. As a result, when the electronic file is displayed on the display portion 101 of the PC 100, the display can be made in the display mode according to the setting. As a result, as mentioned above, if a presentation is to be made for the customers A, B, for example, the slide display according to each customer can be easily made using a single electronic file for presentation.

Also, particularly in this embodiment, the file access information to access the storage destination of the electronic file is written in the IC circuit part 150 of the RFID circuit element To. As a result, at reading by the reader 200, the file access information is gotten from the IC circuit part 150 of the RFID circuit element To, and by accessing the database 103 as the storage destination of the electronic file on the basis of the information, the electronic file to be processed can be surely obtained.

Also, particularly in this embodiment, by the file access information setting procedure executed by the control circuit 302 of the apparatus 300 for producing RFID label (Step S30 and Step S40), the operator can operate and specify the storage destination of the electronic file using the operation portion 102 of the PC 100. As a result, the electronic file can be stored in a desired destination by the user's operation and the information corresponding to the storage destination can be written in the RFID circuit element To.

Also, particularly in this embodiment, the storage destination of the electronic file is the database 103 provided at the PC 100 connected to the apparatus 300 for producing RFID label. As a result, by carrying the PC 100, for example, and by connecting it to the reader 200 at an outside location so as to execute reading from the RFID circuit element To of the tag card 1, the electronic file can be taken out of the database 103 of the PC 100 without connecting the PC 100 to a network and the like.

Also, particularly in this embodiment, the predetermined print information corresponding to the contents of the electronic file is printed by the print head 305 on the tag tape 303 provided with the RFID circuit element To so as to produce the tag card 1. In this way, by applying the print corresponding to the contents of the electronic file on the tag card 1, which electronic file corresponds to the tag card 1 can be visually made clear to the user.

Also, particularly in this embodiment, the thumb-nail image of the selected slide (if not selected, a slide of a top page) among a plurality of slides constituting the electronic file and the text input information (if not input, a file name) that can identify the electronic file are printed by the print head 305 as the predetermined print information on the print regions S1, S2, respectively. As a result, what the electronic file is can be further visually made clear to the user.

Also, particularly in this embodiment, by the print information setting procedure executed by the control circuit 302 of the apparatus 300 for producing RFID label (Step S50 and Step S60), the operator can operate and specify contents of the print information to be printed on the tag card 1 using the operation portion 102 of the PC 100. As a result, according to preference or use mode of the user, what kind of contents is to be printed on the tag card 1 can be operated and input or selected, and convenience can be further improved.

Also, particularly in this embodiment, using the display portion 101 of the PC 100, a setting screen on which various settings are made relating to the file attribute information as the file additional information, processing mode information, file access information relating to the destination to store the electronic file, print information and the like is displayed. As a result, the user can make various settings on the setting screen easily and efficiently relating to the various types of information.

Also, particularly in this embodiment, by the tag card production instruction input procedure executed by the control circuit 302 of the apparatus 300 for producing RFID label (Step S80), when the operator instructs start of the production of the tag card 1, the production processing of the tag card 1 is started. As a result, the production of the tag card can be started after the user's final intension of tag production is confirmed.

Subsequently, a second embodiment of the present invention will be described referring to FIGS. 15 to 17. The first embodiment stores an electronic file to be processed in the database 103 of the PC 100 and reads out the electronic file from the database 103 by carrying the PC 100, while this embodiment stores the electronic file in an external memory that can be detachably attached to the PC 100, and reads out the electronic file from an external memory by carrying the memory.

FIG. 15 is a system configuration diagram illustrating an entire RFID tag manufacturing system 10A including an apparatus 300 for producing RFID label of this embodiment and corresponds to the above-mentioned FIG. 1. The same portions as those in FIG. 1 are given the same reference numerals and the description will be omitted.

As shown in FIG. 15, in this embodiment, an external memory 4 (external recording medium) such as a USB memory that can be detachably attached to an external slot, not shown, of the PC 100 is equipped.

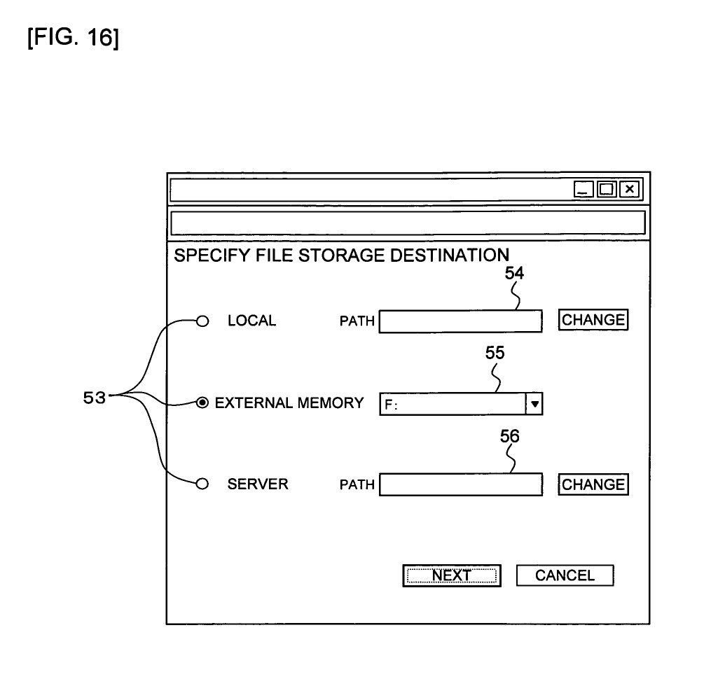

FIG. 16 is a diagram illustrating an example of a file storage destination setting screen displayed on the display portion 101 of the PC 100 when the file access information is set and input at production of the tag card 1 by the apparatus 300 for producing RFID label. As shown in FIG. 16, in this embodiment, the “external memory” is selected by the radio button 53, and a path of the storage destination corresponding to the external memory 4 is input in the input window 55. As a result, the electronic file to be processed is stored in the external memory 4 instead of the database 103 of a PC 100.

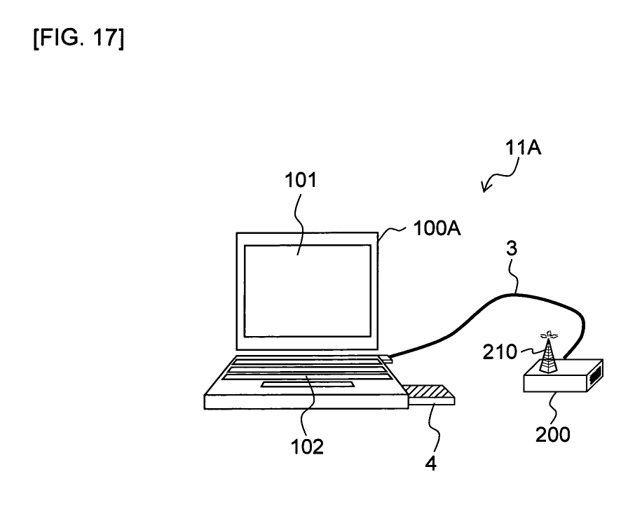

FIG. 17 is a system configuration diagram illustrating an entire RFID tag reading system 11A including a reader 200 of this embodiment and corresponds to the above-mentioned FIG. 12. The same portions as those in FIG. 12 are given the same reference numerals and the description will be omitted.

In this embodiment, the user carries the tag card 1 produced by the apparatus 300 for producing RFID label, the external memory 4, and the reader 200 to an outside location (as for the reader, it does not have to be carried but a general-purpose reader may be borrowed at an outside location) Then, at the outside location (at a client company in which a presentation is to be made, for example), a PC 100A (processing device) having an external slot is borrowed, the external memory 4 having been carried is attached to the PC 100A, and the reader 200 is connected using the connecting member 3. As a result, the RFID tag reading system 11A shown in FIG. 17 is constituted.

The subsequent operation is the same as that in the above-mentioned first embodiment, and by bringing the tag card 1 having been carried close to the side of the reader 200 (to have it present in the communicable range), the file access information and the file additional information relating to the electronic file to be processed which is stored and held in the IC circuit part 150 of the RFID circuit element To in the tag card 1 are gotten by the side of the reader 200, the electronic file is read out of the external memory 4 attached to the PC 100A based on the file access information, and the electronic file is opened on the basis of the file additional information thus gotten and displayed on the display portion 101.

In this embodiment with the above configuration, the electronic file is stored in the external memory 4 to be externally attached to the PC 100, and the information corresponding thereto is written in the RFID circuit element To. As a result, by carrying the external memory 4, for example, attaching the external memory 4 to the appropriate PC 100A at an outside location and executing reading from the RFID circuit element To using the reader 200 as mentioned above, the electronic file can be taken out of the external memory 4. In this case, as compared with the case as the above-mentioned first embodiment in which the electronic file is stored in the PC, the user does not have to carry the operation terminal, and convenience can be further improved.

Subsequently, a third embodiment of the present invention will be described referring to FIGS. 18 to 22. The second embodiment stores an electronic file in an external memory detachably attached to the PC 100, carries the external memory and reads out the electronic file from the memory, while this embodiment stores the electronic file in a server connected to the PC 100 via a communication line such as the Internet, for example.

FIG. 18 is a system configuration diagram illustrating an entire RFID tag manufacturing system 10B including an apparatus 300 for producing RFID label of this embodiment and corresponds to the above-mentioned FIG. 1 and the like. The same portions as those in FIG. 1 and the like are given the same reference numerals and the description will be omitted.

As shown in FIG. 18, in this embodiment, the PC 100 is connected to an information server (contents server) 7 that stores and holds a plurality of various electronic files capable of being read out via a wired or radio communication line 5 such as the Internet, for example. Also, the PC 100 is connected to the apparatus 300 for producing RFID label that produces the tag card 1 via the connecting member 2 similarly to the above first embodiment and second embodiment. A route server (address server) 6 may be provided. Though the PC 100 and the apparatus 300 for producing RFID label are connected by the connecting member 2 in this example, they may be connected via the communication line 5.

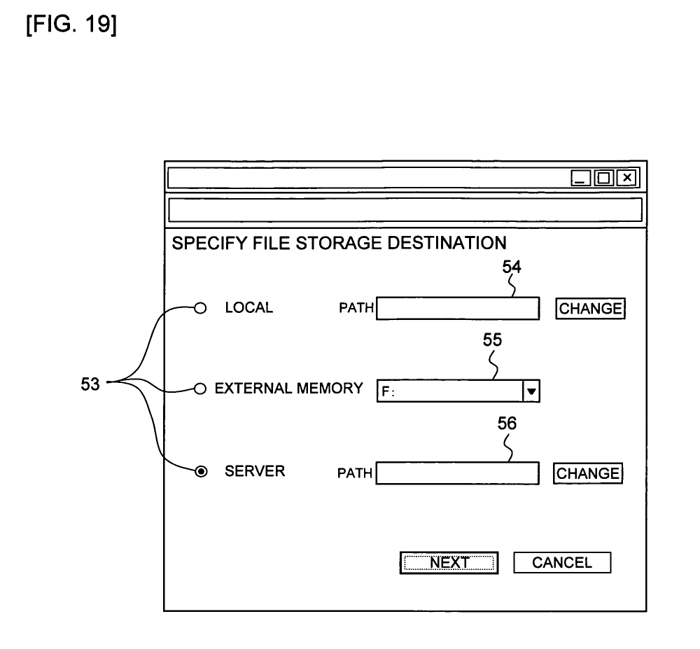

FIG. 19 is a diagram illustrating an example of the file storage destination setting screen displayed on the display portion 101 of the PC 100 when the file access information is set and input at the production of the tag card 1 by the apparatus 300 for producing RFID label. As shown in FIG. 19, in this embodiment, the “server” is selected by the radio button 53, and a path of the storage destination corresponding to the information server 7 (or the routine server 6) is input in the input window 56. As a result, the electronic file to be processed is stored in the information server 7 via the communication line 5.

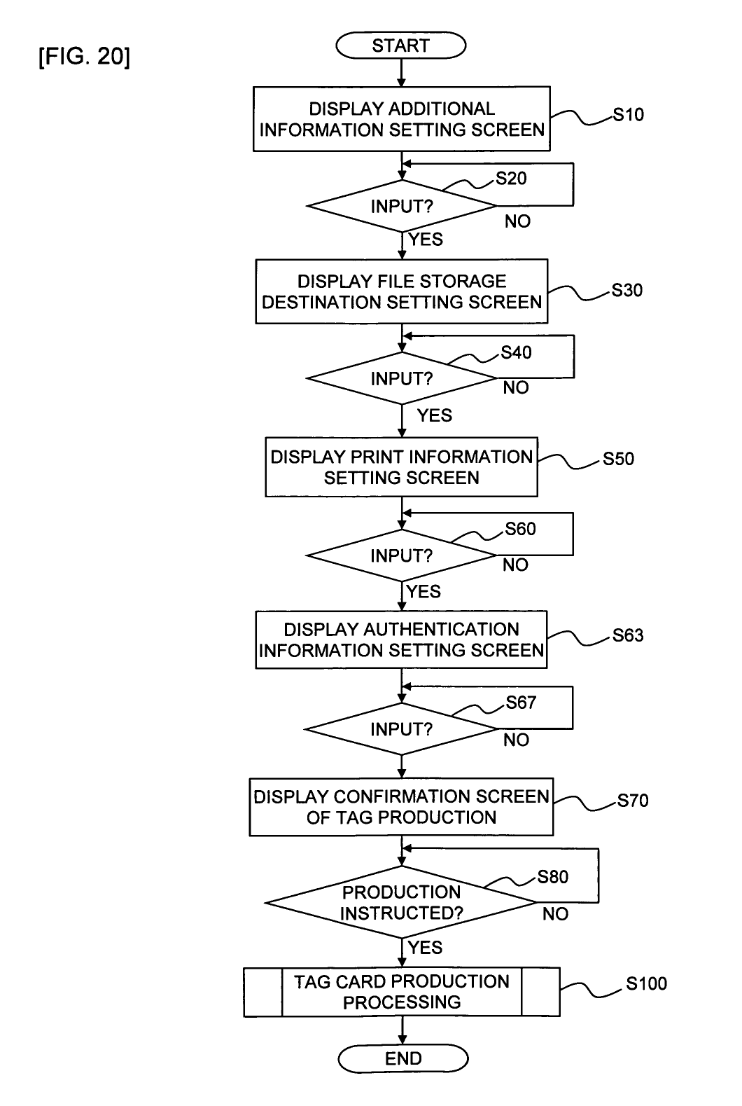

FIG. 20 is a flowchart illustrating a control procedure executed by a control circuit 302′ (not shown) of the apparatus 300 for producing RFID label when the file additional information and print information and the like are set and input and corresponds to the above-mentioned FIG. 3. The same procedures as those in FIG. 3 are given the same reference numerals and the description will be omitted.

In FIG. 20, a point different from the above-mentioned FIG. 3 is that Step S63 and Step S67 are added. That is, at Step S63, a control signal is output to the control circuit 105 of the PC 100 via the communication control portion 308 and the connecting member 2, a setting screen of authentication information (password) in order to access the information server 7 storing the electronic file to be processed is displayed on the display portion 101, and an operator is prompted to input the authentication information.

At the subsequent Step S67, according to the above authentication information setting screen, it is determined if the operator has input the authentication information using the operation portion 102. If the authentication information has been input and the information is received via the communication control portion 104 and the connecting member 2, the determination is satisfied and the routine goes to the subsequent Step S70. In this case, at the above-mentioned Step S110, an information signal corresponding to the authentication information is also created, and the information signal including this is transmitted at Step S120.

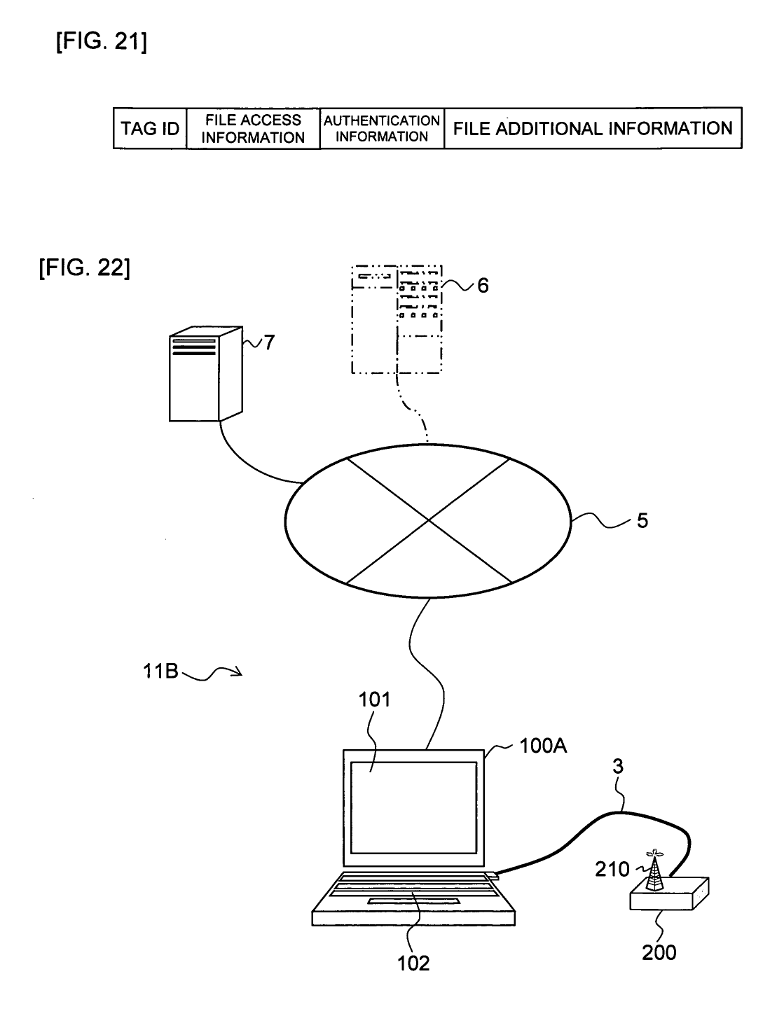

FIG. 21 is a diagram illustrating an example of data structure of the memory part 155 of the IC circuit part 150 in the RFID circuit element To provided at the tag card 1 produced by the apparatus 300 for producing RFID label as above.

In the example shown in FIG. 21, the data stored in the memory part 155 of the IC circuit part 150 in the RFID circuit element To is constituted by a tag ID as the writing information, the file access information as the information on the destination to store the electronic file to be processed, the authentication information to access the information server 7 (or the route sever 6) storing the electronic file, and the file additional information.

FIG. 22 is a system configuration diagram illustrating an entire RFID tag reading system 11B including a reader 200 of this embodiment and corresponds to the above-mentioned FIG. 12 and the like. The same portions as those in FIG. 12 and the like are given the same reference numerals and the description will be omitted.

In this embodiment, the user carries the tag card 1 produced by the apparatus 300 for producing RFID label and the reader 200 to an outside location (as for the reader, it does not have to be carried but a general-purpose reader may be borrowed at an outside location and the like, for example). Then, at the outside location (at a client company in which a presentation is to be made, for example), the PC 100A that can be connected to the communication line 5, which is the Internet, for example, is borrowed, and the reader 200 having been carried is attached to the PC 100A using the connecting member 3. As a result, the PC 100A is connected to the information server 7 (or the route server 6) via the communication line 5, and the RFID tag reading system 11B shown in FIG. 22 is constituted.

The subsequent operation is the same as that in the above-mentioned first embodiment and the like, and by bringing the tag card 1 having been carried close to the side of the reader 200 (to have it present in the communicable range), the file access information, authentication information, and the file additional information relating to the electronic file to be processed which are stored and held in the IC circuit part 150 of the RFID circuit element To in the tag card 1 are gotten by the side of the reader 200. Then, the electronic file is read out of the information server 7 via the communication line 5 based on the file access information, and the electronic file is opened on the basis of the file additional information thus gotten and displayed on the display portion 101. When an access is to be made to the information server 7, the access is allowed by transmitting the authentication information gotten from the RFID circuit element To of the tag card 1 to the information server 7.

In this embodiment with the above configuration, the electronic file is stored in the information server 7 connected to the apparatus 300 for producing RFID label via the PC 100A and the communication line 5, and the information corresponding thereto is written in the RFID circuit element To. As a result, by carrying out the reading from the RFID circuit element To using the reader 200 and by accessing the information server 7 at an outside location, for example, the electronic file can be taken out of the information server 7. In this case, as compared with the first embodiment and second embodiment in which the electronic file is stored in the PC 100 and the external memory 4, the user does not have to carry the PC 100 or the external memory 4, and the convenience can be further improved.

Also, particularly in this embodiment, by writing the authentication information in the IC circuit part 150 of the RFID circuit element To, even in a configuration in which authentication is required to access the information server 7 in order to take out an electronic file, an access can be made easily by reading and using the authentication information from the RFID circuit element To. Therefore, while security performance of the information server 7 storing the electronic file is ensured, the convenience can be improved.

Since the above is an example of a case in which connection is made through a wide-range communication line such as the Internet, for example, the authentication information is used in order to ensure the security of the information server 7, but not limited to that, in a case where connection is made via a narrow-range communication line such as an in-house LAN to make a presentation in a meeting in a company, for example, the authentication information does not have to be used.

Note that the first to third embodiments are not limited to each of the above modes but are capable of various variations in a range not departing from its gist and technical idea. The variations will be described below:

(A-1) When an Electronic File is Created Using a Scanner:

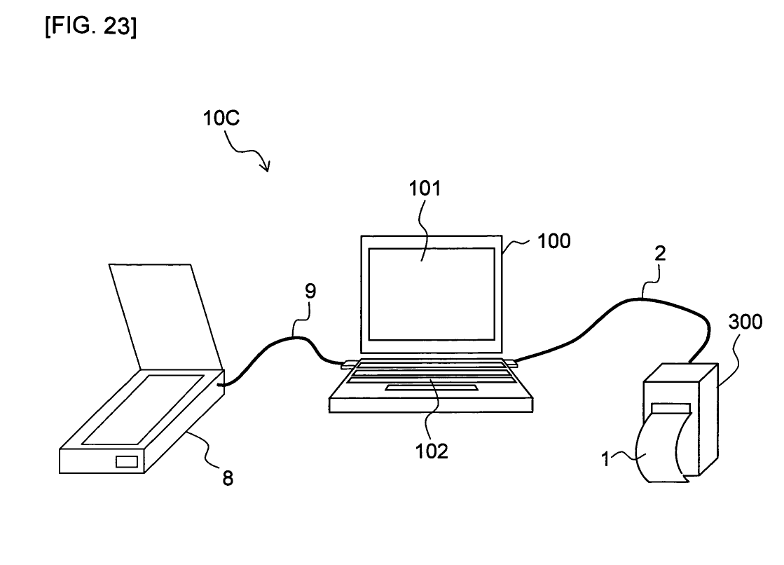

FIG. 23 is a system configuration diagram illustrating an entire RFID tag manufacturing system 10C including an apparatus 300 for producing RFID label in this variation and corresponds to the above-mentioned FIG. 1. The same portions as those in FIG. 1 are given the same reference numerals and the description will be omitted.

The RFID tag manufacturing system 10C shown in FIG. 23 includes: the apparatus 300 for producing RFID label that produces the tag card 1 having the RFID circuit element To; the PC 100 connected to the apparatus 300 for producing RFID label via the connecting member 2 such as a USB cable, for example, and having the display portion 101, the operation portion 102 and the like; and a scanner 8 (detecting device) that is connected to the PC 100 via a connecting member 9 and optically detects a target (printed matter and the like) to be made into an electronic file.

In the RFID tag manufacturing system 10C with the above configuration, if a desired target is to be made into an electronic file, by carrying out optical detection of the target with the scanner 8, an electronic file can be created according to a detection result and stored in the database 103 of the PC 100.

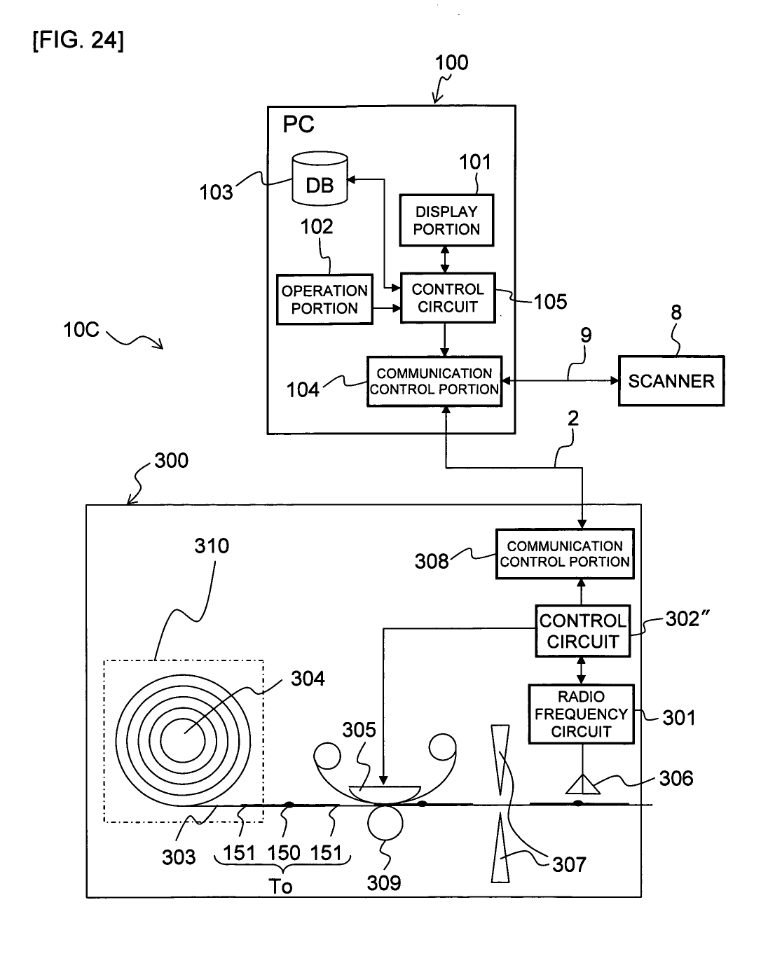

FIG. 24 is a functional block diagram illustrating detailed functions of the PC 100 and the apparatus 300 for producing RFID label constituting the RFID tag manufacturing system 10C and corresponds to the above-mentioned FIG. 2. The same portions as those in FIG. 2 are given the same reference numerals and the description will be omitted.

In FIG. 24, the scanner 8 is connected to the communication control portion 104 of the PC 100 via a connecting member 9, and thereby information can be transmitted/received among the apparatus 300 for producing RFID label, the PC 100, and the scanner 8. On the other hand, the apparatus 300 for producing RFID label has a control circuit 302″ having a control function for creation processing of an electronic file by the scanner 8.

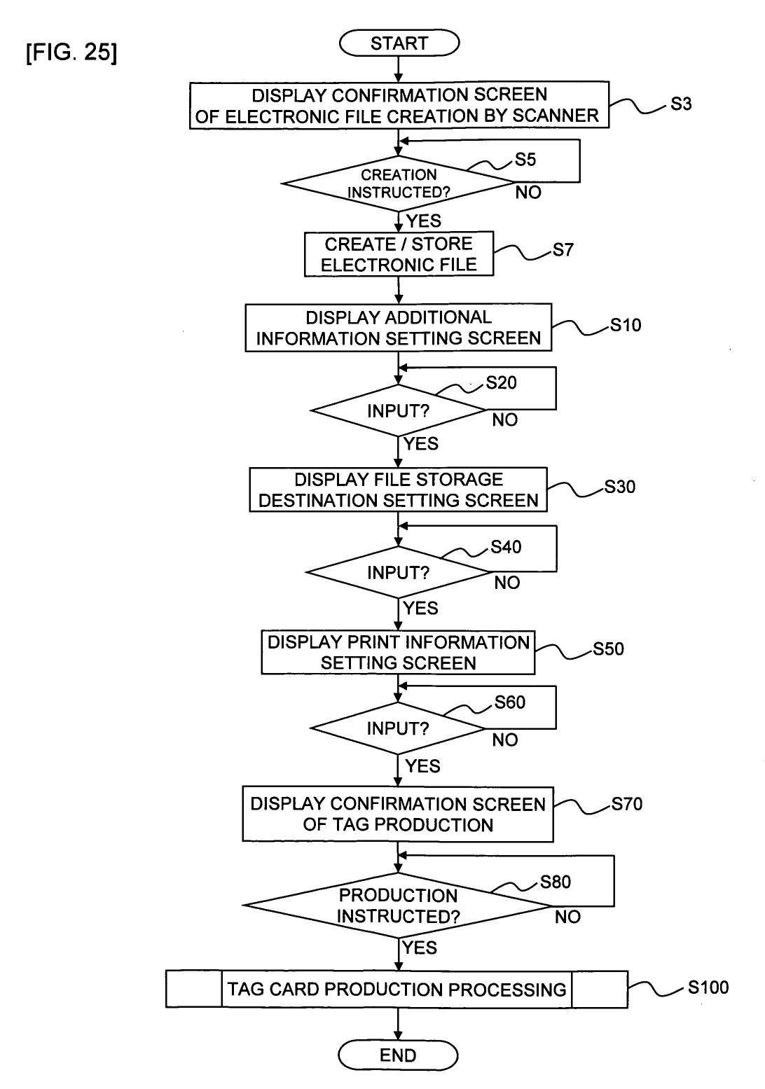

FIG. 25 is a flowchart illustrating a control procedure executed by the control circuit 302″ of the apparatus 300 for producing RFID label when the file additional information and the print information and the like are set and input, and corresponds to the above-mentioned FIG. 3. The same portions as those in FIG. 3 are given the same reference numerals and the description will be omitted.

In FIG. 25, a point different from the above-mentioned FIG. 3 is that Step S3, Step S5, and Step S7 are added. That is, at Step S3, a control signal is output to the control circuit 105 of the PC 100 via the communication control portion 308 and the connecting member 2, and a display signal is output to the display portion 101 from the control circuit 105. Thereby, a confirmation screen on whether or not a creation processing of an electronic file by the scanner 8 is performed is displayed on the display portion 101, and an operator is prompted to input an electronic file creation instruction (setting display signal output portion). At the subsequent Step S5, according to the above confirmation screen, it is determined if the operator has input the electronic file creation instruction using the operation portion 102. If the creation instruction has been input and the information has been received via the communication control portion 104 and the connecting member 2, the determination is satisfied and the routine goes to the subsequent Step S7. At Step 7, a control signal is output to the scanner 8 via the communication control portion 308 and the connecting member 2, 9 so that the scanner 8 is started and the target is detected. This detection signal is output to the PC 100 via the connecting member 9 and stored in an appropriate place (the database 103 in this example) as an electronic file (electronic file creating portion).

Since the subsequent Step S10 to Step S100 are the same as those in the above-mentioned FIG. 3, the description will be omitted. Note that, at this time, display of the additional information setting screen executed at Step S10 (See the above-mentioned FIG. 4), display of the print information setting screen executed at Step S50 (See the above-mentioned FIG. 6) and the like are made according to the electronic file created by being read by the scanner 8, unlike the above-mentioned presentation file. For example, in the additional information setting screen shown in FIG. 4, the “Check non-display slide” is changed to “Check non-display image” and an image read by the scanner 8 is displayed in the window 51, and in the print information setting screen shown in FIG. 6, a plurality of images read by the scanner 8 are displayed in the window 57 and thumb-nail images of the scanner images selected by the radio button 58 are displayed in the window 59.

According to this variation with the above configuration, if a desired target is to be made into an electronic file, by optically detecting the target by the scanner 8, the electronic file according to the detection result can be created.

In the above, a case in which the destination to store the electronic file is the database 103 of the PC 100 similarly to the above-mentioned first embodiment has been described as an example, but not limited to that, the storage destination of the electronic file may be the external memory or server as in the above-mentioned second embodiment or third embodiment.

If a plurality of targets is to be detected by the scanner 8, the plurality of targets in a lump or each of the predetermined number of plural targets (by a single page, for example) may be created into a single electronic file or may be associated with each other and made into a single electronic file group. As a result, if a series of associated plural targets to be an electronic file (plural pages of a single document and the like, for example) exist, the plural targets are not separately formed into independent electronic files but made into a single electronic file (or electronic file group associated with each other) so that they can be handled in a lump sum.

(A-2) Others:

In the above, the file attribute information (read-only) and the file processing mode information (display/non-display of each slide) have been described as an example of the file additional information, but not limited to that. That is, as the file attribute information, the information may be version information of an application when a file is created, confidentiality information representing a grade of confidentiality of the file and the like, for example, other than the above, and as the file processing mode information, the information may be shading of display, display speed and the like, for example, other than the above. Other than them, the file additional information may be product mode information relating to a mode of a product after the processing operation of the electronic file (font, language information and the like after file display, for example). In this case, when a processing device such as the PC is to carry out a file display operation, corresponding to the file additional information, the electronic file can be displayed in a desired font and language. Moreover, other than the above, a date of creation and version information of the electronic file or recommended application information and the like for the file processing may be the file additional information.

In the above, display on the display portion 101 of the PC 100 was explained as an example of the electronic file processing, but not limited to that, for example, processing such as printing by a printer and projection by a projector may be performed.

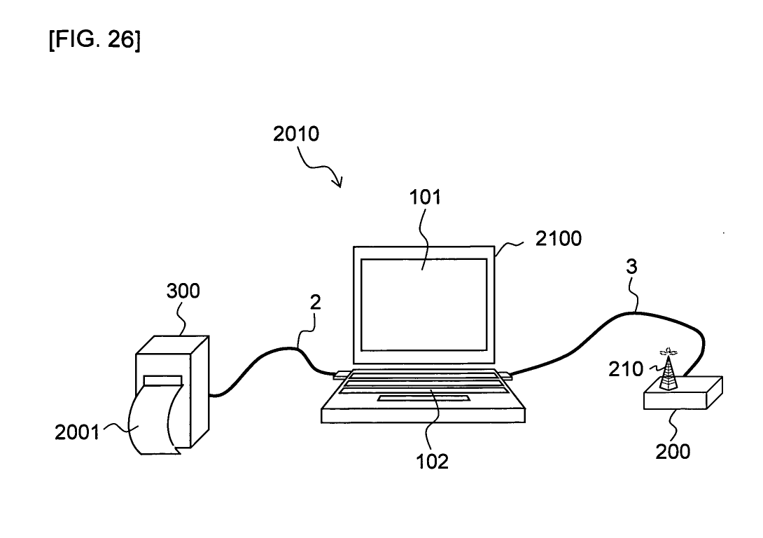

A fourth embodiment of the present invention will be described referring to FIGS. 26 to 34. In this embodiment, at a common terminal used by a plurality of operators, for example, the present invention is applied to a case in which an operator who interrupted a work in the middle is to resume the work by reproducing a work state at the same terminal after that. The same reference numerals are given to the equivalent portions as in the above first to third embodiments and the description will be omitted or simplified as appropriate.

FIG. 26 is a system configuration diagram illustrating an entire RFID tag system including a PC 2100, which is a processing device for communication with RFID tag (information terminal) of the fourth embodiment.

A RFID tag system 2010 shown in FIG. 26 has the apparatus 300 for producing RFID label (apparatus for communicating with RFID tag) provided with the configuration and function similar to those in the first embodiment, the reader 200 having the antenna 210 (antenna for reading, apparatus antenna) and provided with the configuration and function similar to those in the first embodiment, and a PC terminal (or a general-purpose computer. Hereinafter described as “PC”) 2100 (processing device for communication with RFID tag) connected to the apparatus 300 for producing RFID label via the connecting member 2 such as a USB cable, for example, and also connected to the reader 200 via the connecting member 3 such as a USB cable, for example.

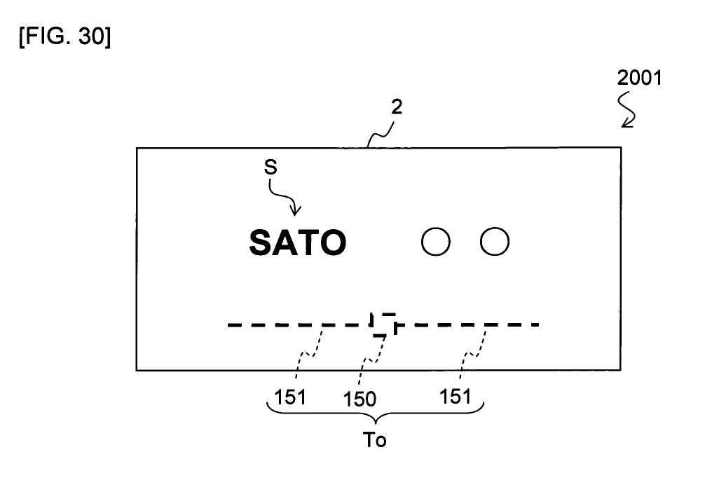

The apparatus 300 for producing RFID label produces a tag card 2001 (RFID tag) having the RFID circuit element To (See FIG. 30 and the like, which will be described later). The reader 200 reads out information via radio communication from the tag card 2001 produced by the apparatus 300 for producing RFID label via the antenna 210. The PC 2100 is provided with the display portion 101, the operation portion 102 and the like.

Functional configuration of the PC 2100 and the apparatus 300 for producing RFID label constituting the RFID tag system 2010 is as shown in FIG. 2 of the first embodiment.

That is, in FIG. 2, the PC 2100 has the operation portion 102 (operating device for work) provided with an appropriate button, key, mouse and the like for an operator to operate and input in order to carry out a work such as creation, editing and the like of a document, for example, the display portion 101 (first display device, second display device) that makes display to the operator, and the database as a storage portion such as a hard disk in which various application software, electronic files and the like are stored (hereinafter described simply as a database) 103. Since the others including the communication control portion 104 and the control circuit 105 are the same as those in the first embodiment and the like, and the description will be omitted.

Similarly, in FIG. 2, the apparatus 300 for producing RFID label has the print head 305 configured to apply a desired print on a print region S (See FIG. 30, which will be described later) corresponding to the RFID circuit element To in the tag tape 303 fed out of the roll 304 of a tape with RFID tags and the cutter 307 configured to cut the tag tape 303 with which the print on the tag tape 303 and the information writing in the RFID circuit element To have been finished to a predetermined length so as to produce the tag card 2001. Other than the above, since a holder portion 310 of roll of a tape with RFID tags, the antenna 306 (antenna for production, apparatus antenna), the radio frequency circuit 301, the communication control portion 308, and the feeding device 309 are the same as those in the above first embodiment and the like, the description will be omitted.

In the above configuration, if, during a predetermined work operation by an operator on data to be processed (document file, for example) using the operation portion 102 of the PC 2100, the operator interrupts the work in the middle due to some reasons such as a sudden guest and a telephone call, for example, personal work information (details will be described later) as processing assisting information for operator representing the work state at the work interruption by the operator is stored in the database 103 of the PC 2100 after a predetermined time has elapsed after the work interruption, and a tag production instruction signal is transmitted to the apparatus 300 for producing RFID label via the connecting member 2 from the PC 2100. The apparatus 300 for producing RFID label that received the signal applies a desired print by the print head 305 on the basis of the personal work information, creates access information by the radio frequency circuit 301, transmits it to the RFID circuit element To via the apparatus antenna 306 and writes the personal work information in the IC circuit part 150 of the RFID circuit element To. As mentioned above, the tag card 2001 storing the personal work information is produced.

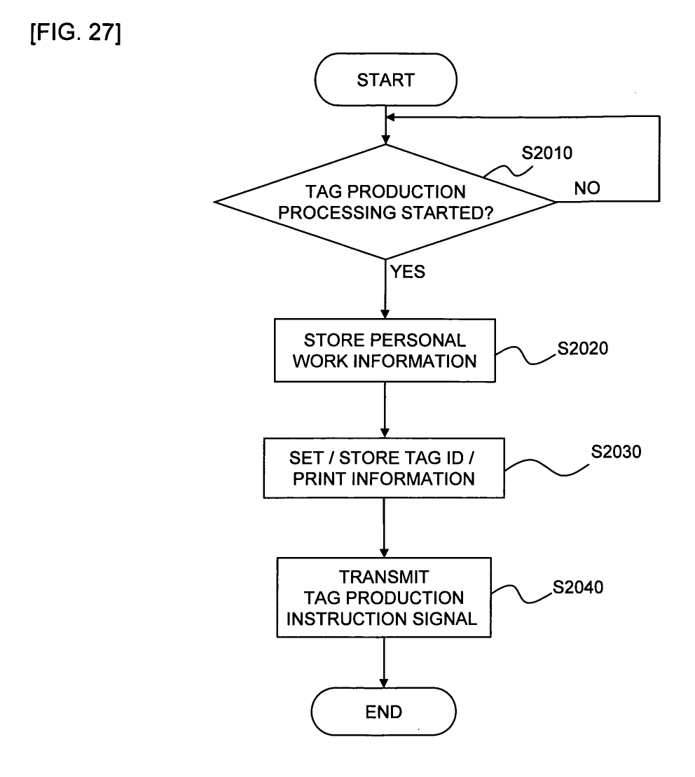

FIG. 27 is a flowchart illustrating a control procedure executed by the control circuit 105 of the PC 2100 at the production of the tag card.

In FIG. 27, first, at Step S2010, it is determined if the tag production processing is to be started or not. Specifically, for example, time till the operator starts the tag production processing after the work interruption (in other words, non-operation duration time of the operation portion 102) is set in advance, and it is determined if the set time has elapsed since the operator interrupts the work or not. In this fourth embodiment, the display portion 101 is set so that the display is switched (operation of a so-called screen saver) according to the set time, and the tag production processing is automatically started in an interlocking manner with the operation of the screen saver.

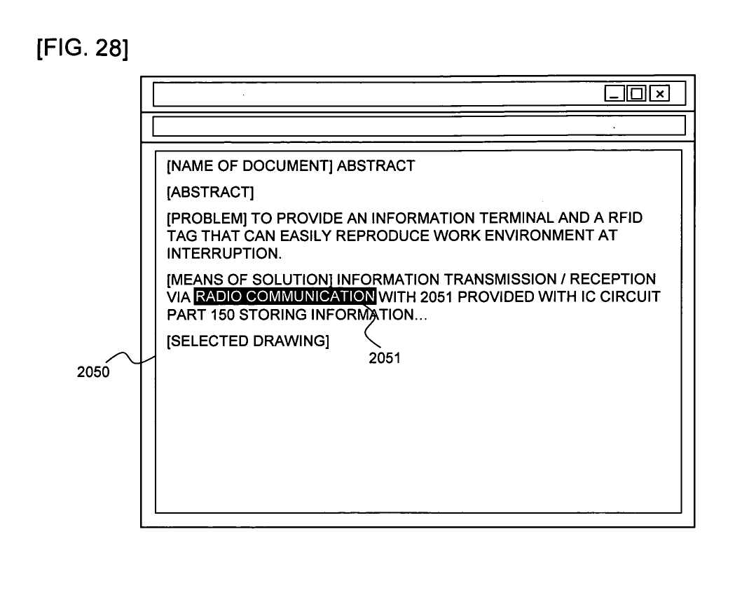

At the subsequent Step S2020, the personal work information representing the work state at the work interruption by the operator is stored in the database 103. This personal work information is constituted by application information representing an application used by the operator for the work, file information representing file contents of the work being carried out using the application, and work status information representing the work status of the file being carried out using the application (See FIG. 28, which will be described later).

At the subsequent Step S2030, the tag ID, which is identification information of the RFID circuit element To, and the print information to be printed on the print region S of the tag card 2001 are set. At this time, the tag ID is automatically allocated and set, and as for the print information, too, information relating to the operator or the personal work information (operator name, for example. See FIG. 30, which will be described later) is automatically set. Then, the set tag ID and print information are stored in the database 103. Note that the tag ID and the print information are associated with the personal work information and stored in the database 103 of the PC 2100.

In the above, the operator name is defined as the print information to be printed on the tag card 2001, but information relating to the personal work information such as the interrupted work procedure contents or application information used at that time, a work file name and the like, for example, may be the print information. Also, in the above, the tag ID and the print information are automatically set by the control circuit 105, but not limited to that, the operator may determine and set them in advance.

At the subsequent Step S2040, to the control circuit 302 of the apparatus 300 for producing RFID label via the communication control portion 104 and the connecting member 2, a tag production instruction signal that gives a production instruction of the tag card 2001 is transmitted. Then, this flow is finished.

FIG. 28 is a diagram illustrating an example of a display screen of the display portion 101 of the PC 2100 when the work is interrupted in the middle by the operator.

In FIG. 28, the operator is creating a document file (in this example, an “abstract”) in the input window 2050 displayed on the display portion 101 using a document creation application such as a Japanese word-processor software. In this example, as shown in a reversed portion 2051 in the document, the work is interrupted in a state where a text of “RFID circuit element To” is reversed (selected) for copy-and-paste (copy has not been carried out yet). In this example, the personal work information is constituted by the application information representing the word-processor software, the file information representing contents of the document file “abstract” created to the middle (up to the portion displayed in the input window 2050), and the work status information representing that the procedure to reverse (select) the text of the “RFID circuit element To” has been completed for copy-and-paste.

In the above, the reversal (selection) of the text was described as an example of a work procedure immediately before the interruption, but not limited to that. That is, other various work procedures are included as long as it is a work procedure that can be carried out on an application used by an operator for a document creation work such as hiragana conversion, character decoration such as shading, setting/change of a format and the like, for example.

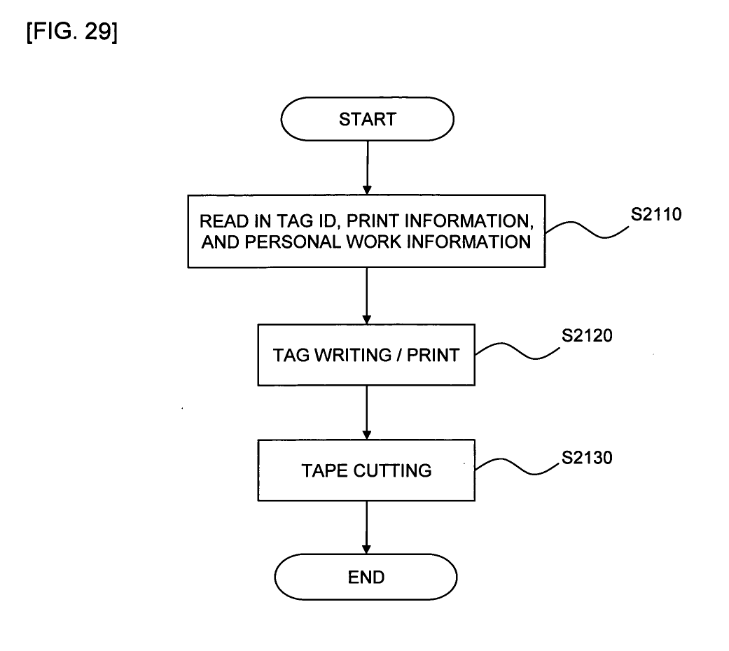

FIG. 29 is a flowchart illustrating a control procedure executed by the control circuit 302 of the apparatus 300 for producing RFID label at the production of the tag card and corresponds to FIG. 8 of the first embodiment. Note that the control circuit 302 starts this flow when the tag production instruction signal transmitted from the control circuit 105 of the PC 2100 is received at Step S2030.

First, at Step S2110, a control signal is transmitted to the control circuit 105 of the PC 2100 via the communication control portion 308 and the connecting member 2, and the tag ID, the print information, and the personal work information stored in the database 103 of the PC 2100 are read out and gotten at Step S2020 and Step S2030.

After that, the routine goes to Step S2120, where the access information is created by the radio frequency circuit 301 and transmitted to the RFID circuit element To via the apparatus antenna 306, and the tag ID and the personal work information gotten at Step S2110 is written in the IC circuit part 150. Also, the print is applied by the print head 305 on the basis of the print information gotten at Step S2110.

Then, at the subsequent Step S2130, the tape cutting is carried out so as to produce the tag card 2001 provided with one RFID circuit element To, and this routine is finished.

FIG. 30 is a top view illustrating an example of an entire schematic configuration of the tag card 2001 produced by the apparatus 300 for producing RFID label by the above control.

In FIG. 30, the tag card 2001 is formed in the card shape in this example, and is constituted by a substantially square thin-plate shaped base 2 and the RFID circuit element To positioned on the base 2.

On the front side (upper face) of the base 2, the region S on which a name of an operator holding the tag card 2001 is printed is provided. Note that, as mentioned above, the print information to be printed on the print region S may be information relating to the personal work information, and not limited to characters, but figures, symbols, or simply color painted, pattern and the like may be used. That is, it is only necessary that the operator or personal work information contents can be recognized/identified in some form. Also, the size of the tag card 2001 can be constituted in various sizes such as a name card, for example. The RFID circuit element To may be attached (a label-like one is affixed, for example) on paper of usual A4-size, B-5 size or the like (does not have to be printed).

The RFID circuit element To is positioned in a biased manner to one side (in this example, lower side in FIG. 30) from the center part in the plane direction of the base 2 (in this example, center part in the vertical direction in FIG. 30) in this example. In other words, the region S and the RFID circuit element To are arranged so that they are not overlapped with each other as much as possible on plan view. Since the functional configuration of the RFID circuit element To is sufficient with that similar to FIG. 10 in the first embodiment, the description will be omitted.

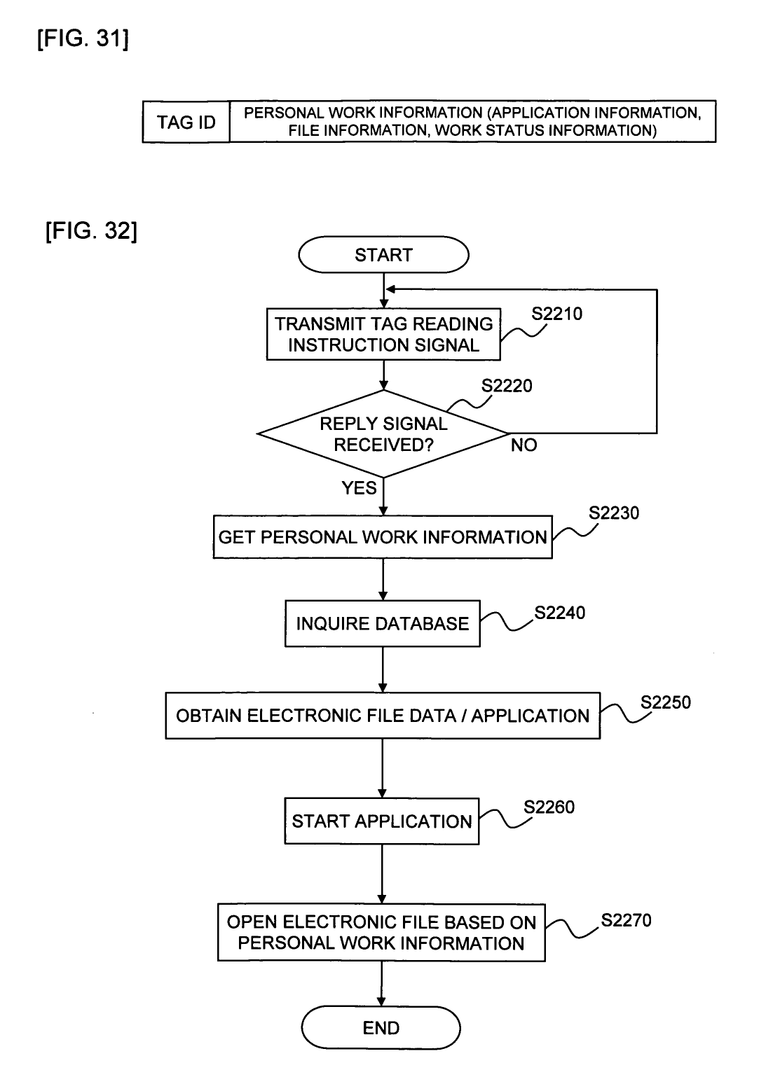

FIG. 31 is a diagram illustrating an example of data structure of the memory part 155 of the IC circuit part 150 in the RFID circuit element To provided at the tag card 2001 produced by the apparatus 300 for producing RFID label as above.

In the example shown in FIG. 31, the data stored in the memory part 155 of the IC circuit part 150 in the RFID circuit element To has the tag ID, which is the above-mentioned tag identification information, and the personal work information representing the work state at the work interruption by the operator and constituted by the application information, the file information, and the work status information. The application information in the personal work information is constituted by electronic address information showing a location of the application software in the database 103 in the PC 2100 like “C:¥ . . . ¥ . . . ¥application name.EXE”, for example, and the file information is also constituted by the electronic address information showing the location of the file data like “C:¥ . . . ¥ . . . ¥file name”, for example.

The work status information in the personal work information includes information such as a work code (usual: 00, being selected: 01, being converted: 02, character decoration: 03, format being set: 04, . . . ), a cursor position (X1, Y1), position during work (X2, Y2), and the number of characters to be worked and the like and includes information representing a specific work status such that a desired text is reversed (selected) for copy-and-paste, for example, as mentioned above.

Note that as the application information and the file information, not limited to the above-mentioned address information, but program data itself of the application software or the file data itself may be stored in the memory part 155 of the RFID circuit element To, for example. Also, the data stored in the memory part 155 includes data representing a format type and a separator held between each data and the like in detail, but illustration is omitted here for simplification.

On the other hand, in the RFID tag system 2010, the functional configuration of the reader 200 is as shown in FIG. 13 in the first embodiment. That is, in FIG. 13, the reader 200 of this embodiment has the antenna 210 that transmits/receives a signal via radio communication with the antenna 151 of the RFID circuit element To provided at the tag card 2001. Other than the above, since the radio frequency circuit 201, the operation portion 203, and the communication control portion 204 are the same as those mentioned above, the description will be omitted.

In the above configuration, when the RFID tag information of the tag card 2001 is read out by the reader 200, the tag card 2001 is brought close to the side of the reader 200 (to have it present in a communicable range). At this time, as mentioned above, the IC circuit part 150 of the RFID circuit element To in the tag card 2001 stores and holds the personal work information representing the work state at the work interruption by the operator, and when the information is gotten by the side of the reader 200, the application is read out of the database 103 of the PC 2100 on the basis of the application information, the file information, and the work status information in the personal work information, the file is opened as well in the state at the work interruption, and the work status at the work interruption is reproduced on the display portion 101.

FIG. 32 is a flowchart illustrating a control procedure executed by the control circuit 105 of the PC 2100 when the RFID tag information of the tag card 2001 is read out.

In FIG. 32, first, at Step S2210, a tag reading instruction signal for reading the RFID tag information of the tag card 2001 is transmitted to the control circuit 202 of the reader 200 via the communication control portion 104 and the connecting member 3.

At the subsequent Step S2220, the reader 200 having received the tag reading instruction signal transmits a signal for reading the stored information to the RFID circuit element To of the tag card 2001, and it is determined whether or not a reply signal transmitted (returned) from the RFID circuit element To in response to that has been received from the reader 200 via the connecting member 3. If the reply signal has not been received from the reader 200, the determination is not satisfied but this step is repeated. If the reply signal has been received, the determination is satisfied, and the routine goes to the subsequent Step S2230.

At step S2230, from the reply signal received from the reader 200, the personal work information representing the work state at the work interruption by the operator is read out and gotten. The read-out information is temporarily stored in an appropriate storage device (such as a memory provided at the control circuit 105, for example).

Subsequently, at Step S2240, on the basis of the application information and the file information in the personal work information obtained at Step S2230, an inquiry is made on the electronic file data and application to the database 103.

At the subsequent Step S2250, data of the electronic file having responded to the inquiry at Step S2240 is read out of the database 103 and the application (such as Japanese software, drawing software) corresponding to the inquiry is obtained. The read-out electronic file data and application data are temporarily stored in an appropriate storage device (such as a memory provided at the control circuit 105, for example).

Then, at Step S2260, the application obtained at Step S2250 is started.

After that, at Step S2270, on the basis of the work status information in the personal work information gotten at Step S2230, the electronic file is opened on the above-started application. That is, in this example, as shown in the above-mentioned FIG. 28, the Japanese word-processor software is started as the application, the document “abstract” in the middle of creation is opened, and a state where the text of the “RFID circuit element To” is reversed (selected) is reproduced on the display portion 101. As a result, the operator can immediately resume the work which was to be done before the interruption, that is, the copy-and-paste of the text of “RFID circuit element To”. Then, this flow is finished.

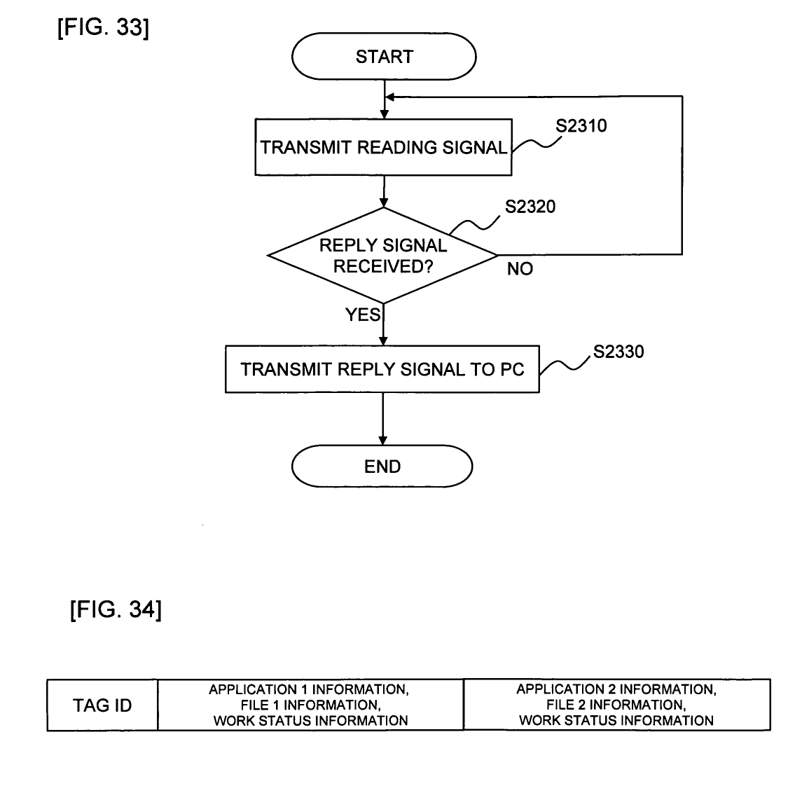

FIG. 33 is a flowchart illustrating a control procedure executed by the control circuit 202 of the reader 200 at reading of the RFID tag information of the tag card 2001. The control circuit 202 starts this flow when the tag reading instruction signal transmitted from the control circuit 105 of the PC 2100 at Step S2210 is received.

In FIG. 33, first at Step S2310, a signal for reading the information stored in the IC circuit part 150 of the RFID circuit element To in the tag card 1 is transmitted via the radio frequency circuit 201 and the antenna 210. In detail, for example, the “Scroll ALL ID” signal (or the “Ping” signal) to read out the information stored in the RFID circuit element To is created and transmitted to the RFID circuit element To present in the communication range via the radio frequency circuit 201, and a reply is prompted.

After that, the routine goes to Step S2320, where it is determined if the reply signal transmitted (returned) from the RFID circuit element To in response to the “Scroll ALL ID” signal has been received via the antenna 210 of the reader 200 and taken into the control circuit 202 via the radio frequency circuit 201. The determination is made based on whether or not the reply signal has been received from the control circuit 202 of the reader 200 having obtained the reply signal.

If the reply signal has not been received from the reader 200, the determination is not satisfied, the routine returns to Step S2310 and the similar procedure is repeated. If the reply signal has been received, the determination at Step S2320 is satisfied, and the routine goes to the subsequent Step S2330.

At Step S2330, the above-received reply signal is transmitted to the control circuit 105 of the PC 2100 via the communication control portion 204 and the connecting member 3, and this flow is finished.

In the above, Step S2040 executed by the control circuit 105 of the PC 2100 constitutes a writing control signal output portion and also constitutes a transmission/reception instructing portion, described in each claim.

Also, Step S2210 executed by the control circuit 105 of the PC 2100 constitutes a reading control signal output portion that outputs a reading control signal for reading the personal work information or the information corresponding to that from the RFID circuit element and also constitutes a transmission/reception instructing portion.

In the PC 2100 of the fourth embodiment constituted as above, the operator carries out operation input via the operation portion 102 and conducts a predetermined work while the display portion 101 makes a display. At this time, the PC 2100 is connected to the apparatus 300 for producing RFID label provided with the antenna 306 that can make radio communication with the RFID circuit element To, and a tag production instruction signal is output to the apparatus 300 for producing RFID label by the control circuit 105 of the PC 2100. As a result, the current personal work information of the operator is written in the IC circuit part 150 of the RFID circuit element To via the antenna 306 of the apparatus 300 for producing RFID label and the tag card 2001 is produced.

Then, when the work is to be resumed, the personal work information stored in the RFID circuit element To of the tag card 2001 produced by the apparatus 300 for producing RFID label is read out by the reader 200, and the work status at the work interruption is reproduced on the display portion 101 on the basis of the personal work information.

As mentioned above, if the operator interrupts the work in the middle of the work due to some reasons such as a sudden guest, a telephone call, for example, and wants to resume the work from the work status at the interruption later with the same terminal at a different time, by using the personal work information read out of the RFID circuit element To, the work status at the interruption can be easily reproduced. As a result, the labor of the operator can be reduced and the convenience can be improved.

Also, particularly in the fourth embodiment, the personal work information to be written in the RFID circuit element To of the tag card 2001 includes the work status information representing the work status of the file being executed using the application. As a result, when the operator is using the file while the file is displayed on the display portion 101 (or edited by the operation portion 102) using a predetermined application and even if the work is interrupted in the middle of the work due to some reasons, the display state (or edited state) of the application file at the interruption can be easily reproduced later.

Also, particularly in the fourth embodiment, after a predetermined time has elapsed after the work is stopped, the control circuit 105 of the PC 2100 automatically starts the tag production processing and transmits a tag production instruction signal to the apparatus 300 for producing RFID label. As a result, without operator's any operation, the current personal work information of the operator is automatically written in the IC circuit part 150 of the RFID circuit element To at a predetermined timing, and the work status at the interruption can be further easily reproduced without an operation burden on the operator.

Also, particularly in the fourth embodiment, the tag production processing is automatically started in interlocking manner with the display switching (so-called screen saver operation) on the display portion 101 by the control circuit 105 of the PC 2100. As mentioned above, by starting the tag production processing in interlocking manner with the display switching, start of the tag production can be visually notified to the operator.

Note that in the fourth embodiment, a case where the work is carried out using a single application (in this example, a document creating work using Japanese word-processor software) was described as an example, but not limited to that, the invention can be applied to a case where a plurality of works is carried out using a plurality of applications such that a drawing is created using drawing software while a document is created using word-processor software, for example. In this case, as shown in FIG. 34, application information, file information and work status information corresponding to an application 1 (drawing software, for example) as well as application information, file information and work status information corresponding to an application 2 (word-processor software, for example) are written in the memory part 155 of the IC circuit part 150 of the RFID circuit element To so that the tag card 2001 is produced. As a result, even if the operator is carrying out a work using a plurality of applications, work status thereof can be reproduced.

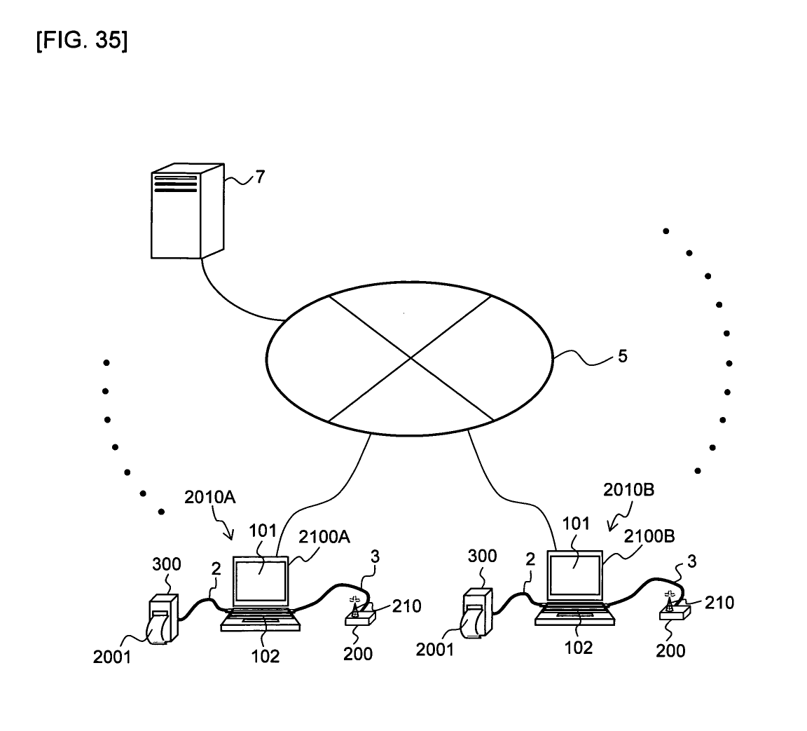

Subsequently, a fifth embodiment of the present invention will be described referring to FIGS. 35 to 46. This embodiment is a case in which a plurality of terminals is connected to a network, an operator who interrupted the work in the middle at the terminal and then recovers the work environment at another terminal later and resumes the work.

FIG. 35 is a system configuration diagram illustrating an entire configuration of a network system including RFID tag systems 2010A, 2010B . . . having PC's 2100A, 2100B . . . , which are processing devices for communicating with RFID tags (information terminals) of the fifth embodiment.

As shown in FIG. 35, in this embodiment, the plural PC's 2100A, 2100B . . . are connected to the server 7 that reads out a plurality of various electronic files and stores and holds them capable of being read out via the wired or radio communication line 5 such as the Internet, for example. The PC's 2100A, 2100B . . . are, similarly to the above fourth embodiment, connected to each of the apparatus 300 for producing RFID label that produces the tag card 2001 and the reader 200 that reads out the radio information of the tag card 2001 via the connecting member 2, 3, by which the plural RFID tag systems 2010A, 2010B . . . are constructed, respectively.

In this network system, various applications, various file data and the like are stored in the server 7, and the work carried out by the operator at the PC's 2100A, 2100B . . . is executed by reading the various applications and various file data from the server 7 onto a memory on each PC. In addition, various file data created, edited and the like by the work are stored in the server 7.

A case where the operator interrupts the work being carried out at the PC 2100A of the RFID tag system 2010A and resumes the work at another terminal, that is, the PC 2100B of the RFID tag system 2010B will be described below as an example. First, production of the tag card 2001 carried out at the RFID tag system 2010A will be described.

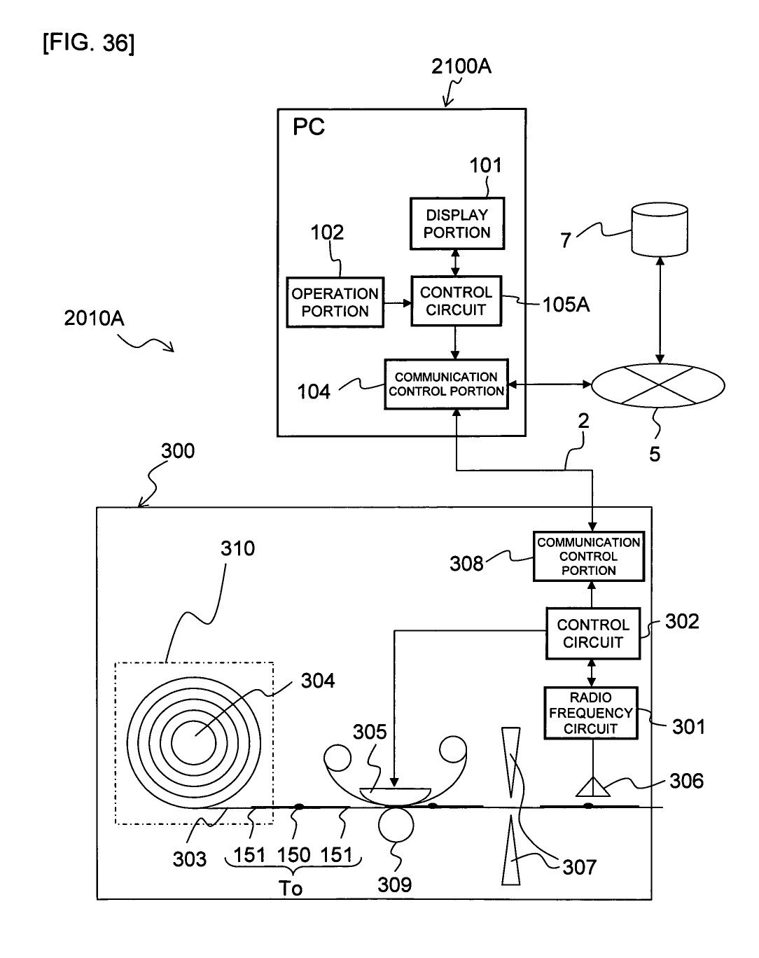

FIG. 36 is a functional block diagram obtained by extracting the PC 2100A and the apparatus 300 for producing RFID label in the RFID tag system 2010A among the plurality of RFID tag systems of the network system and illustrating its detailed function and corresponds to FIG. 2 of the first embodiment.

In FIG. 36, the PC 2100A (processing device for communication with RFID tag) has the display portion 101 and the operation portion 102 similar to the above, the communication control portion 104 that controls communication with the server 7 in which the various application software, electronic files and the like are stored via the communication line 5 and the communication with the apparatus 300 for producing RFID label (apparatus for communicating with RFID tag) via the connecting member 2, and a control circuit 105A that controls an entire operation of the PC 2100A including the display portion 101, the operation portion 102, and the communication control portion 104.

In this fifth embodiment, if, during a predetermined work operation by an operator on data to be processed (a document file, for example) using the operation portion 102 of the PC 2100A, the operator interrupts the work due to some reasons such as a sudden guest, a telephone call, for example, personal work information (short-cut information relating to short-cut created on the desk top by the operator in this example) is stored in the server 7 as processing assisting information for operator representing the work environment by the operator at the display portion 101 of the PC 2100A after a predetermined time has elapsed after the work interruption. Also, the tag production instruction signal is transmitted from the PC 2100A to the apparatus 300 for producing RFID label via the connecting member 2. The apparatus 300 for producing RFID label having received the signal applies a desired print by the print head 305 on the basis of the operator or the personal work information, creates the access information by the radio frequency circuit 301 and transmits it to the RFID circuit element To via the apparatus antenna 306 and writes the personal work information (short-cut information) in the IC circuit part 150 of the RFID circuit element To. As mentioned above, the tag card 2001 storing the personal work information is produced.

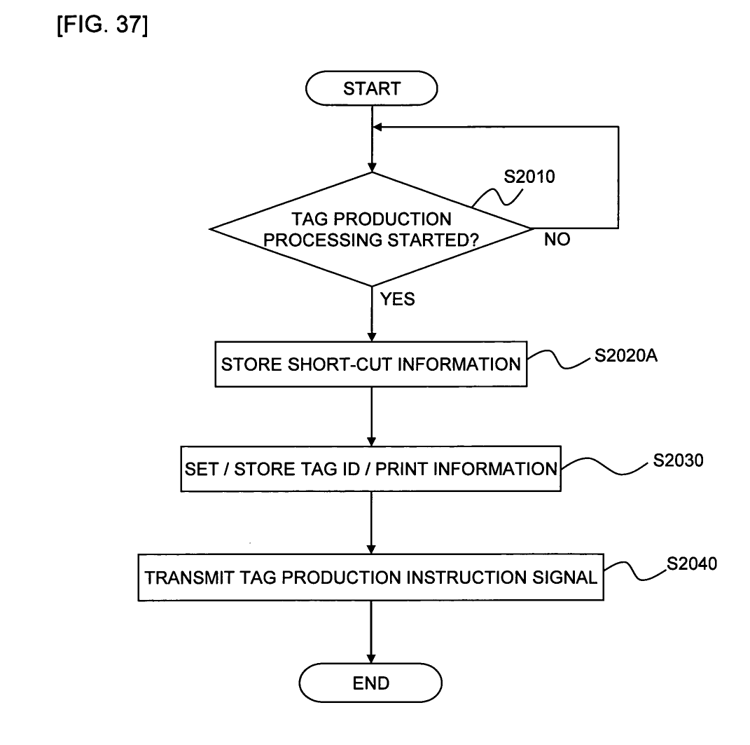

FIG. 37 is a flowchart illustrating a control procedure executed by the control circuit 105A of the PC 2100A at the tag card production and corresponds to the above-mentioned FIG. 27. The same reference numerals are given to the procedures similar to those in FIG. 27 and the description will be omitted.

Step S2010 is similar to that of the above-mentioned FIG. 27, in which it is determined whether or not the tag creation processing should be started based on whether or not a set time has elapsed since the work interruption by the operator, if elapsed, the determination is satisfied and the routine goes to the subsequent Step S2020A.

At Step S2020A, the personal work information (short-cut information in this example) representing the work environment at the work interruption in the display portion 101 of the PC 2100A by the operator is stored in the server 7 via the communication control portion 104 and the communication line 5. This short-cut information is constituted by drawing information representing a pattern of the short cut on the desk top, electronic address information representing a location in the server 7 of the application or file data corresponding to the short cut and the like.

Since the subsequent Step S2030 and Step S2040 are similar to those in the above-mentioned FIG. 27, the description will be omitted. The flow is finished here.

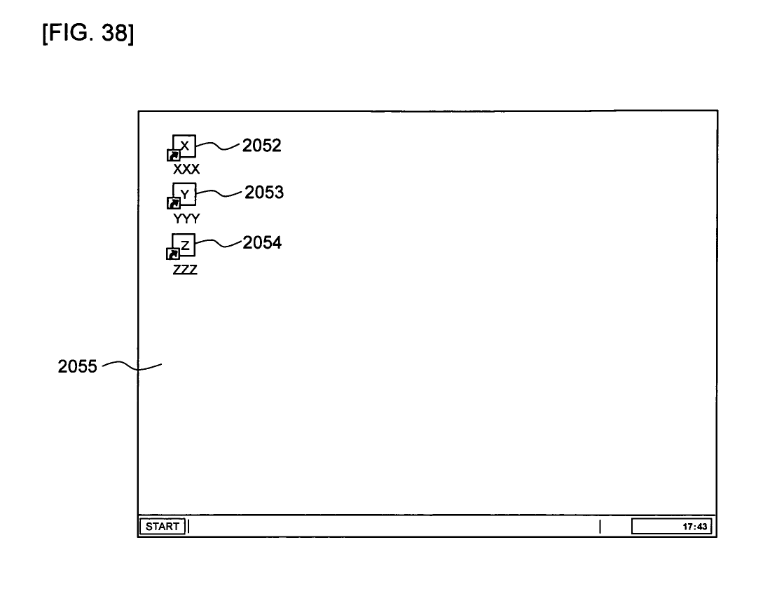

FIG. 38 is a diagram illustrating an example of a display screen of the display portion 101 of the PC 2100A when the operator interrupts the work in the middle.

In FIG. 38, on a desk top 2055 of the display portion 101, a plurality of (three in this example) short cuts 2052, 2053 and 2054 configured to start an application that carries out a desired work is created by an operator. In the example shown in FIG. 38, the personal work information is constituted by the short-cut information having drawing information representing each pattern of all the short cuts 2052, 2053 and 2054 on the desk top 2055 and electronic address information representing a location in the server 7 of the application (or file data) corresponding to each of the short cuts. The electronic address information representing the location of the corresponding application and the like in the server 7 is constituted by electronic address information such as ¥¥server¥ . . . ¥, for example.

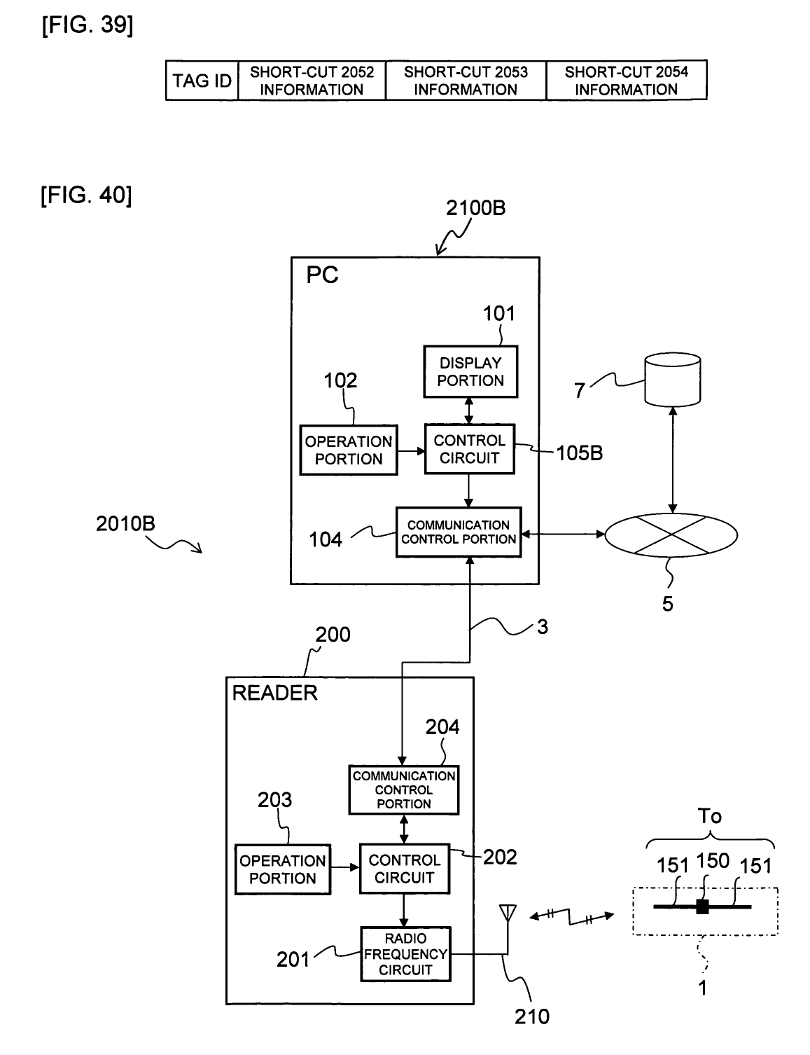

Since the control contents executed by the control circuit 302 of the apparatus 300 for producing RFID label are similar to those in the above-mentioned FIG. 29, the description will be omitted. FIG. 39 is a diagram illustrating an example of data structure of the memory part 155 in the IC circuit part 150 of the RFID circuit element To provided at the tag card 2001 produced by the apparatus 300 for producing RFID label as above.

As shown in FIG. 39, the data stored in the memory part 155 of the IC circuit part 150 in the RFID circuit element To has the tag ID, which is tag identification information, and the personal work information. The personal work information includes, as mentioned above, the short-cut information made of drawing information and electronic address information relating to the short cut 2052, the short-cut information made of the drawing information and the electronic address information relating to the short cut 2053, and the drawing information and the electronic address information relating to the short cut 2054.

Subsequently, reading of the RFID tag information of the tag card 2001 executed in the RFID tag system 2010B will be described. FIG. 40 is a functional block diagram obtained by extracting the PC 2100B and the reader 200 of the RFID tag system 2010B among the plurality of RFID tag systems of the network system and illustrating their detailed functions and corresponds to FIG. 13 and the like of the first embodiment.

In FIG. 40, the PC 2100B (processing device for communication with RFID tag) has, similarly to the PC 2100A, the display portion 101 and the operation portion 102, the communication control portion 104 configured to control communication with the server 7 in which various application software, electronic files and the like are stored via the communication line 5 and to control communication with the reader 200 (apparatus for communicating with RFID tag) via the connecting member 3, and a control circuit 105B configured to control an entire operation of the PC 2100B including the display portion 101, the operation portion 102, the database 103, and the communication control portion 104.

In this fifth embodiment, in order to read out the RFID tag information of the tag card 2001 by the reader 200, the tag card 2001 is brought close to the side of the reader 200 (to have it present in the communicable range). At this time, the personal work information (short-cut information) representing the work environment in the display portion 101 of the PC 2100A by the operator is stored and held in the IC circuit part 150 of the RFID circuit element To in the tag card 2001 as mentioned above, and this information is read out by the reader 200 and gotten by the PC 2100. As a result, on the basis of the short-cut information, the work environment (that is, short cut) at the work interruption is recovered on the desk top of the display portion 101 of the PC 2100B.

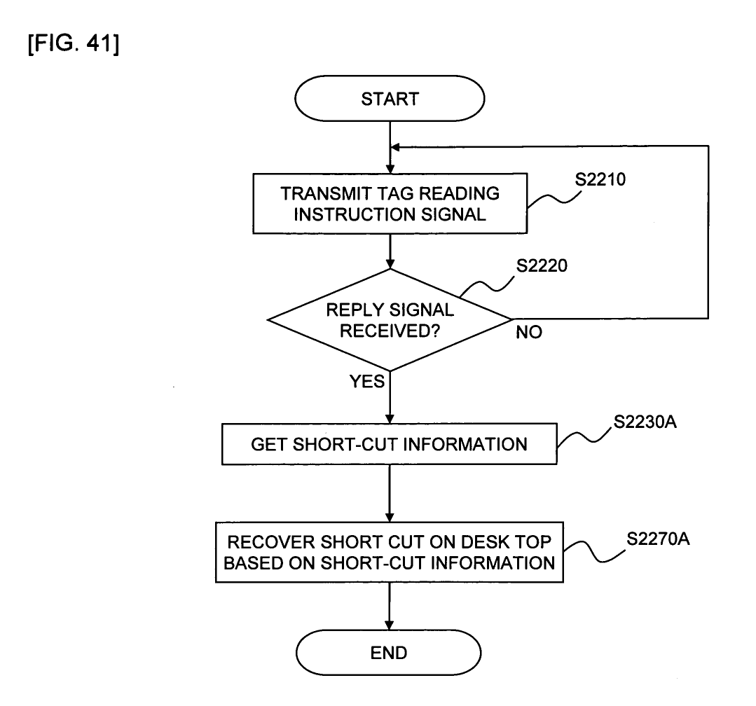

FIG. 41 is a flowchart illustrating a control procedure executed by the control circuit 105B of the PC 2100B when the RFID tag information of the tag card 2001 is read out and corresponds to the above-mentioned FIG. 32. In FIG. 41, the same reference numerals are given to the procedures similar to those in FIG. 32 and the description will be omitted.

In FIG. 41, Step S2210 and Step S2220 are the same as those in the above-mentioned FIG. 32, in which a tag reading instruction signal is transmitted to the reader 200, and it is determined whether or not a reply signal transmitted (returned) from the RFID circuit element To has been received from the reader 200. If the reply signal has been received, the determination is satisfied, and the routine goes to the subsequent Step S2230A.

At Step S2230A, from the reply signal received from the reader 200, the short-cut information representing the work environment in the display portion 101 of the PC 2100A by the operator is read out and gotten. The read-out information is temporarily stored in an appropriate storage device (such as a memory provided at the control circuit 105B, for example).

At the subsequent Step S2270A, on the basis of the short-cut information gotten at Step S2230A, the work environment at the work interruption is recovered on the desk top of the display portion 101 of the PC 2100B. That is, in this example, the state where the short cuts 2052, 2053 and 2054 are arranged on the desk top 2055 as shown in the above-mentioned FIG. 38 is recovered on the desk top of the display portion 101 of the PC 2100B. As a result, the operator can recover the work environment in the PC 2100A in the PC 2100B so as to resume the work. Then, this flow is finished.

According to the fifth embodiment configured as above, if the operator interrupts the work in the middle due to some reasons such as a sudden guest, a telephone call, for example, and wants to resume the work in the work environment at the interruption later at a different terminal, the work environment at the interruption (the short cut on the desk top in this example) can be easily reproduced using the personal work information (short-cut information) read out by the RFID circuit element To. As a result, the labor of the operator can be reduced, and convenience can be improved.

Also, particularly in this fifth embodiment, the short-cut information relating to all the short cuts displayed on the display portion 101 of the PC 2100A is written in the IC circuit part 150 of the RFID circuit element To. As a result, all the short cuts set by the operator in the original PC 2100A can be reproduced (in other words, the short cut setting is duplicated) in the different PC 2100B.

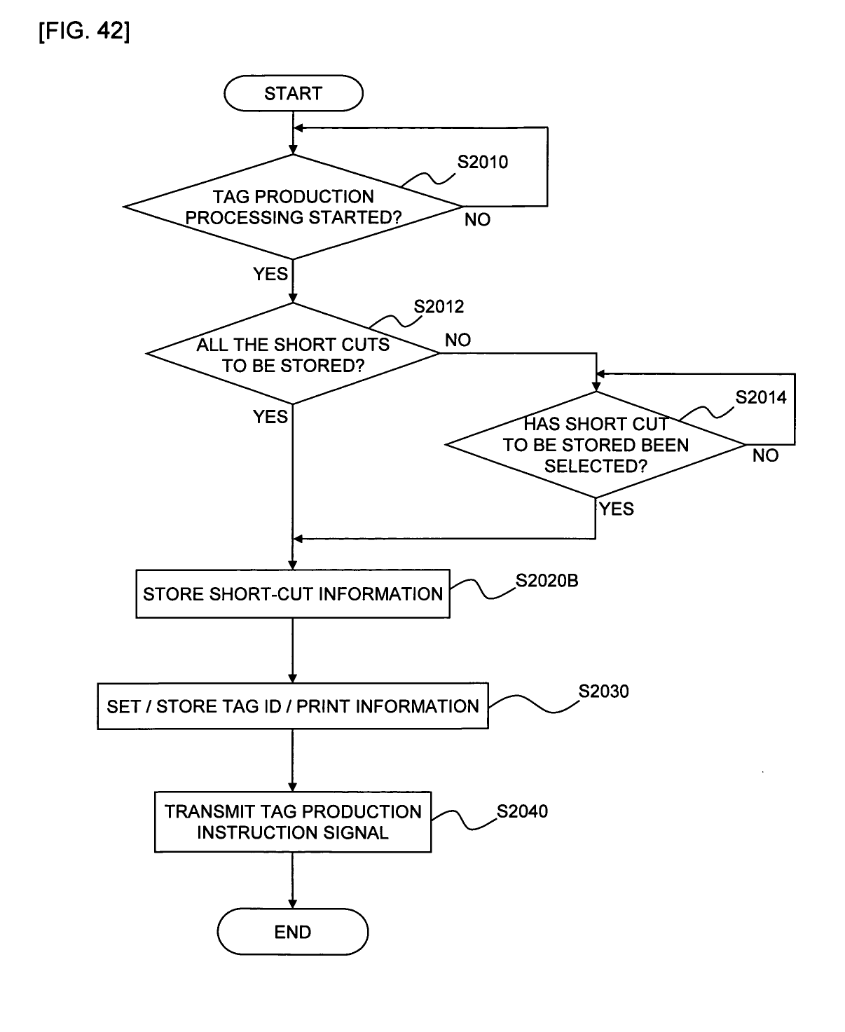

In the above fifth embodiment, all the short cuts on the desk top are automatically stored, but since various short cuts are usually created on the desk top and there might be short cuts not particularly required for the work, only a selected part of the short cuts may be stored in the short cuts on the desk top. FIG. 42 is, in a variation of this case, a flowchart illustrating a control procedure executed by the control circuit 105B of the PC 2100B at the tag card production and corresponds to the above-mentioned FIG. 37. The same reference numerals are given to the procedures similar to those in FIG. 37 and the description will be omitted.

In FIG. 42, Step S2010 is similar to that in the above-mentioned FIG. 37, in which it is determined whether or not the tag production processing is to be started based on whether or not a set time has elapsed since the operator stopped the work, and if elapsed, the determination is satisfied and the routine goes to the subsequent Step S2012.

At Step S2012, it is determined if all the short cuts are stored or not. This determination can be made by outputting a control signal to the display portion 101, displaying an inquiry screen on whether or not all the short cuts are to be stored, and checking whether or not there is an input indicating that all the short cuts are to be stored by the operator via the operation portion 102, for example. If all are to be stored, the determination is satisfied, and the routine goes to the subsequent Step S2020B. On the other hand, if there is an input by the operator that a part of the short cuts are to be stored, the determination is not satisfied and the routine goes to Step S2014.

At Step S2014, it is determined whether or not the short cut to be stored has been selected. This determination is made by outputting a control signal to the display portion 101 so as to display a short-cut selection screen (such as a short-cut list, for example) and checking whether or not there is a selection input on the short cut to be stored by the operator via the operation portion 102, for example. Note that instead of the selection input by the operator at the production of the tag card, short cuts to be stored may be selected in advance and stored. This step is repeated till selection, and if selected, the determination is satisfied and the routine goes to the subsequent Step S2020B.

At the subsequent Step S2020B, if all the short cuts are to be stored, all the short cut information on the desk top at the work interruption is stored in the server 7 via the communication control portion 104 and the communication line 5 or if a part of the short cuts are to be stored, the short-cut information selected at Step S2014 is stored therein.

Since the subsequent Step S2030 and Step S2040 are similar to those in the above-mentioned FIG. 37, the description will be omitted.

As mentioned above, the operator can recover only the desired selected short cuts.

Also, in the fifth embodiment, the short-cut information is stored in the RFID circuit element To as the personal work information and the short cut on the desk top is recovered, but not limited to that, information of an electronic holder storing file data and the like may be stored in the RFID circuit element To so that the holder on the desk top is recovered.

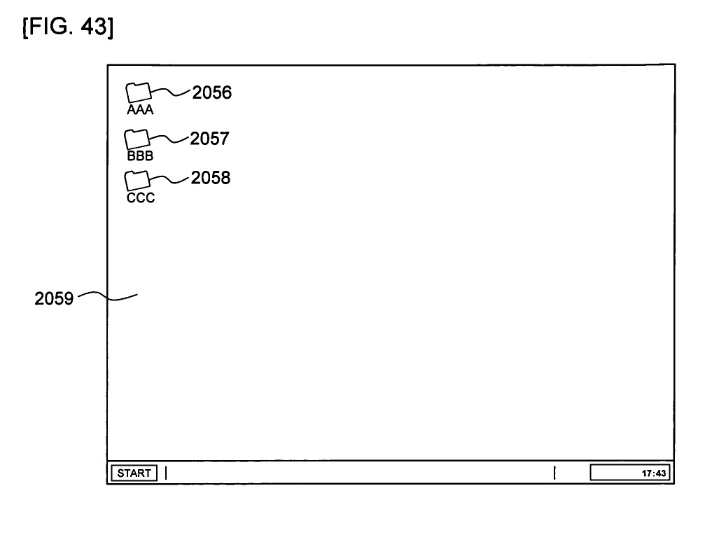

FIG. 43 is a diagram illustrating an example of a display screen of the display portion 101 of the PC 2100A when the operator interrupts the work in the middle.

In FIG. 43, on a desk top 2059 of the display portion 101, holders 2056, 2057 and 2058 that store data such as electronic file and the like are created in plural (three in this example) by the operator. In the example shown in FIG. 43, the personal work information is constituted by holder information having drawing information representing each pattern of the holders 2056, 2057 and 2058 on the desk top 2059 and information of data such as electronic file and the like stored in each holder, and the personal work information is written in the RFID circuit element To so that the tag card 2001 is produced.

Both the above-mentioned short-cut information and the holder information may be stored in the RFID circuit element To and recovered on the desk top.

The fourth and fifth embodiments are not limited to the above modes but are capable of various variations in a range not departing from its gist and technical idea. The variations will be described below:

(B-1) When the Operator Manually Inputs a Tag Production Instruction:

In the fourth and fifth embodiments, the tag production processing is automatically carried out after a set time has elapsed since the operator stopped the work, but not limited to that, it may be so configured that it is confirmed with the operator whether or not the tag production is to be carried out and the tag production processing is not carried out till the production instruction is input.

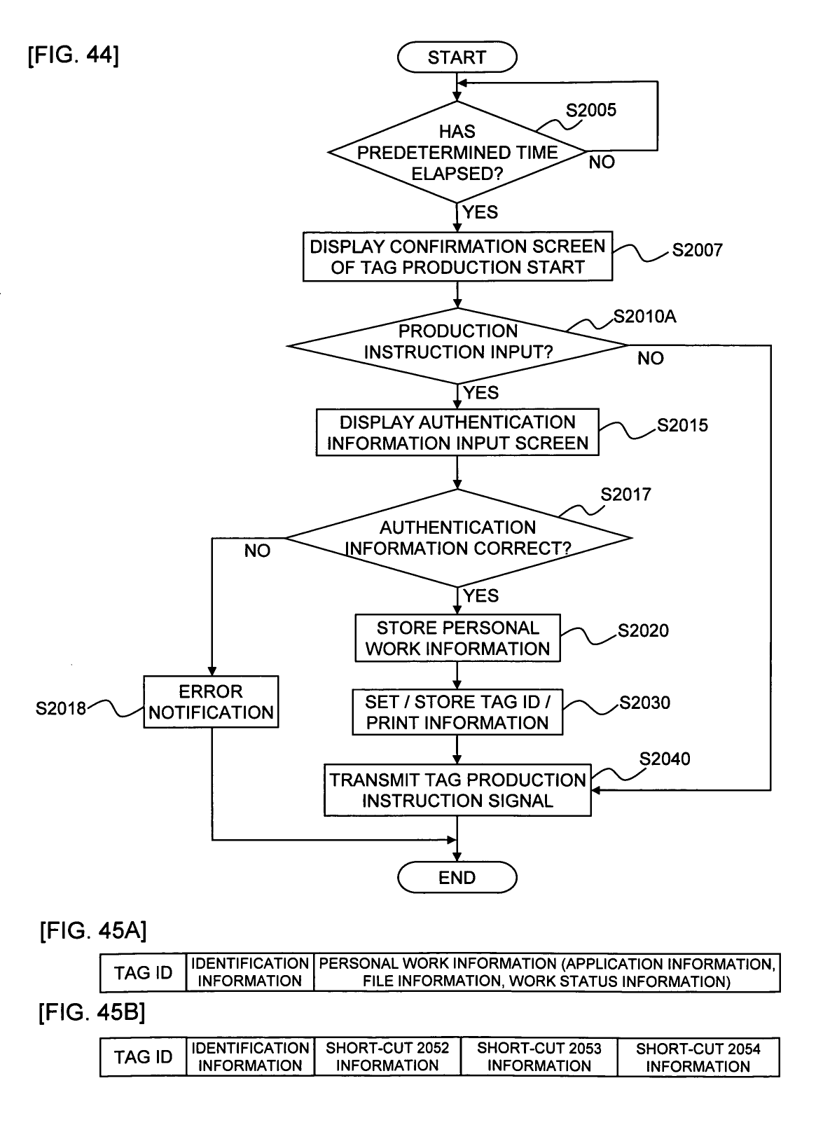

FIG. 44 is, in this variation, a flowchart illustrating a control procedure executed by the control circuit 105 of the PC 2100 at the tag card production and corresponds to the above-mentioned FIG. 27 and the like. The same reference numerals are given to the procedures similar to those in FIG. 27 and the like and the description will be omitted.

In FIG. 44, first, at Step S2005, it is determined if a predetermined time set in advance has elapsed since the operator stopped the work or not. This set time is a set time and the like till the display switching of the display portion 101 (so-called screen saver operation), for example. If the set time has elapsed, the determination is satisfied, and the routine goes to the subsequent Step S2007.

At Step S2007, a control signal is output to the display portion 101, and an inquiry screen on whether or not the tag production processing is started (such as “Stop work and create tag? Or continue work?”) is displayed.

At the subsequent Step S2010A, it is determined if the operator who saw the screen display has input the tag production start instruction via the operation portion 102 (operating portion for writing instruction) or not. If a production instruction has not been input (if the “continue work” is selected in the above example, for example), the determination is not satisfied and the flow is terminated. If the production instruction has been input, the determination is satisfied, and the routine goes to the subsequent Step S2015.

At Step S2015, a control signal is output to the display portion 101 and an input screen for authentication information (such as a password, for example) for authentication of the operator is displayed.

At the subsequent Step S2017, it is determined if the authentication information input by the operator via the operation portion 102 according to the above screen is correct or not. If not, the determination is not satisfied but the routine goes to Step S2018, where a control signal is output to the display portion 101 and an error message (such as “password is not correct”, for example), is displayed. Then, this flow is terminated. On the other hand, if the input authentication information is correct, the determination is satisfied and the routine goes to the subsequent Step S2020. Since the subsequent Step S2020 to Step S2040 are similar to those in the above-mentioned FIG. 27, the description is omitted.

In the variation described above, if the operator interrupts the work in the middle due to some reason such as a sudden guest and leaves his/her desk, for example, when a predetermined time has elapsed since then, the confirmation screen is displayed on the display portion 101 in a state before the tag production processing is started. If the operator who has finished the errand and returned to his/her desk is to continue the work, the “continue work” is selected and the tag production processing is not carried out, while if the work is to be interrupted, the “start tag production” is selected, the tag production instruction signal is transmitted from the PC 2100 to the apparatus 300 for producing RFID label, and the tag card 2001 in which the personal work information (including application information and the like representing the work state and short-cut information representing the work environment) is produced. According to this variation, as mentioned above, the final tag production execution can be confirmed with the operator.

In the above, the input of the authentication information is required after the production instruction is input by the operator, but not limited to that, but the tag production may be carried out without input of the authentication information when the production instruction is input.

(B-2) When Identification Information of the Personal Work Information is Written in a Tag:

In the above, the case in which the application information and the like representing the work state (application information, file information, and work status information) are written in the RFID circuit element To as the personal work information and the work status is reproduced when the work is resumed, and the case in which the short-cut information representing the work environment is written in the RFID circuit element To as the personal work information and the work environment is recovered when the work is resumed were described separately as the fourth embodiment and the fifth embodiment, but it may be configured so that the both can be handled.

In this case, the identification information (identifier) that identifies whether the personal work information is the application information and the like representing the work state or the short-cut information representing the work environment is stored in the RFID circuit element To with the personal work information. FIG. 45 is a diagram illustrating an example of the data structure of the memory part 155 of the IC circuit part 150 in the RFID circuit element To at this time. FIG. 45A illustrates a case in which the identification information showing that the personal work information is the application information and the like is written, while FIG. 45B illustrates a case in which the identification information showing that the personal work information is the short-cut information is written.

By employing such configuration, in this variation, the identification information is gotten by the side of the reader when the RFID tag information of the tag card 2001 is read out by the reader, and the flow in the above-mentioned FIG. 32 or FIG. 41 is executed by the PC according to the contents of the personal work information. As a result, if the personal work information is the application information and the like, the work state using the application is reproduced on the display portion 101, while if the personal work information is the short-cut information, the short cut at the work interruption is recovered on the desk top of the display portion 101. As mentioned above, according to this variation, the work status corresponding to the identification information can be reproduced or the work environment can be recovered rapidly and smoothly according to the type of the identification information.

(B-3) When Those to be Written in the Tag and Those not to are Discriminated Among the Personal Information:

Among the current personal work information by the operator, the information to be written in the IC circuit part 150 of the RFID circuit element To and the information not to may be discriminated.

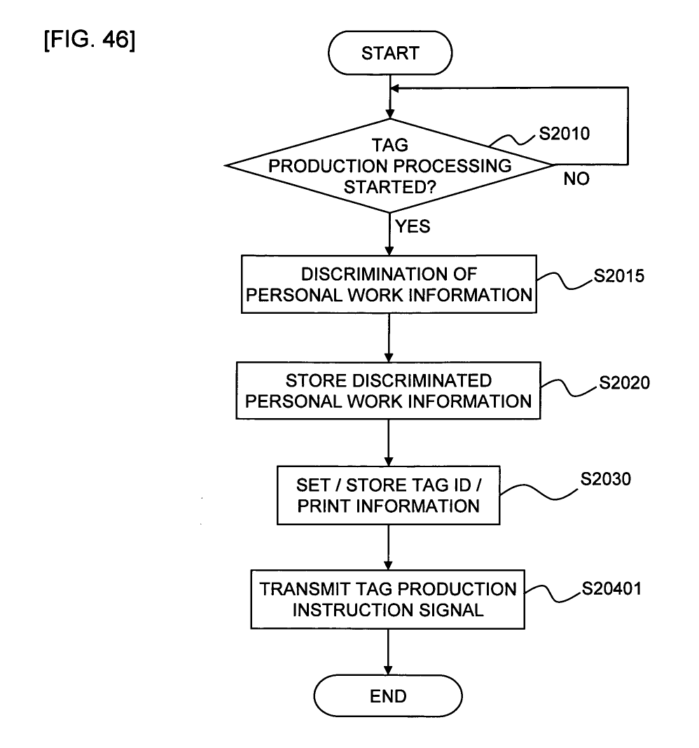

FIG. 46 is a flowchart illustrating a control procedure executed by the control circuit of the PC 2100 at the tag card production in this variation and corresponds to the above-mentioned FIG. 27 and the like. In FIG. 46, the same reference numerals are given to the procedures similar to those in FIG. 27 and the description will be omitted.

In FIG. 46, Step S2010 is the same as that of FIG. 27, and if the set time has elapsed since the operator stopped the work, the determination is satisfied and the routine goes to the subsequent Step S2015.

At Step S2015, among the personal work information representing the work state when the work is interrupted by the operator, the information to be written in the IC circuit part 150 of the RFID circuit element To and the information not to be written therein are discriminated. This discriminant criterion can be set by the operator in advance. Specifically, if a work is being executed using a plurality of applications, for example, a case in which the work information only of a specific application is discriminated and written, a case in which only specific short-cut information among a plurality of short cuts on the desk top is discriminated and written, and the like may be cited, but not limited to them.

At the subsequent Step S2020, thus discriminated personal work information is stored in the database 103. Since the subsequent Step S2030 to Step S2040 are the same as those in the above-mentioned FIG. 27, the description will be omitted.

In the above, Step S2015 executed by the control circuit constitutes a discriminating portion configured to discriminate the information to be written in the IC circuit part of the RFID circuit element from the information not to among the current personal work information by the operator described in each claim.

According to this variation, writing of unnecessary information in the IC circuit part 150 of the RFID circuit element To can be prevented and only necessary personal work information can be written in by the operator, and convenience can be further improved, and useless use of a storage capacity of the IC circuit part 150 can be prevented.

(B-4) Others:

In the above, the data itself of the personal work information (including application information and the like representing the work state and the short-cut information representing the work environment) is written in the IC circuit part 150 of the RFID circuit element To, but not limited to that, the personal work information may be stored in the database 103 of the PC 2100, the server 7 and the like, and only the identification information (tag ID and the like) associated with that may be written in the IC circuit part 150 of the RFID circuit element To.

Also, in the fourth embodiment, the case in which the application and the data of the work file are stored in the database 103 of the PC 2100 as the common terminal and the common terminal PC 2100 is used by a plurality of operators was described as an example, but not limited to that, the present invention may also be applied to a case in which the application and the data of the work file are stored in a sever connected to the network and the operator who interrupted the work in the middle at the terminal reproduces the work state at another terminal later and resumes the work as in the fifth embodiment.

In the above, reuse of the produced tag card 2001 was not particularly mentioned, but by rewriting the RFID tag information of the RFID circuit element To provided at the tag card 2001 and by attaching a usual label on which a print corresponding to the rewritten information is applied (label not having the RFID circuit element To) on the print region S, for example, the tag card 2001 can be used for another application (for writing of personal work information of another operator and the like).

In the above, a cancellation procedure is not included in the flowchart, but a cancellation procedure by an operator (a procedure to display a confirmation screen to confirm the operator's intention of cancellation and a procedure to determine if a cancellation input has been made or not) may be included at an appropriate position. For example, the cancellation procedure may be provided at an appropriate position in Step S2020 to Step S2040 so that the processing can be cancelled even after the tag production processing is started (that is, after the determination at Step S2010 is satisfied) in FIG. 27 and the like, or the processing may be able to be cancelled during selection of the short cut to be stored by including the cancellation procedure between Step S2012 and Step S2014 in FIG. 42, for example.

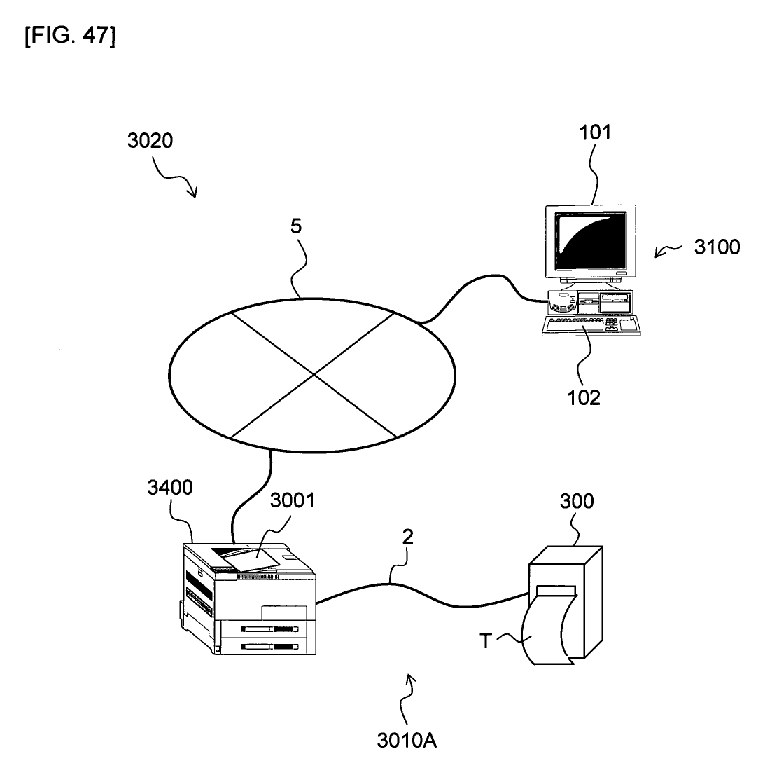

A sixth embodiment of the present invention will be described referring to FIGS. 47 to 68. The same reference numerals are given to the portions equivalent to those in the above first to fifth embodiment, and the description will be omitted or simplified as appropriate.

FIG. 47 is a system configuration diagram illustrating entire configuration of a manufacturing system for printed matter with tag including a printing management system having the printing device of this embodiment.

In FIG. 47, a printing management system 3010A as the RFID tag communication system (here a state when the printed matter with tag is produced is shown) is provided with the apparatus 300 for producing RFID label (apparatus for communicating with RFID tag) configured to produce a RFID label T having the RFID circuit element To and a printer 3400 (printing device, processing device for communication with RFID tag) connected to the apparatus 300 for producing RFID label via the connecting member 2 such as a USB cable, for example, and configured to produce a printed matter 3001 by printing file data, which is data to be processed, on an object to be printed (A4 sheet and the like, not shown). The printing management system 3010A (to be exact, the printer 3400 constituting the system) and the PC terminal (or a general-purpose computer. Hereinafter described as “PC”) 3100 having the display portion 101, the operation portion 102 and the like are connected to each other via the wired or radio communication line 5, by which a manufacturing system 3020 for printed matter with tag is constituted.

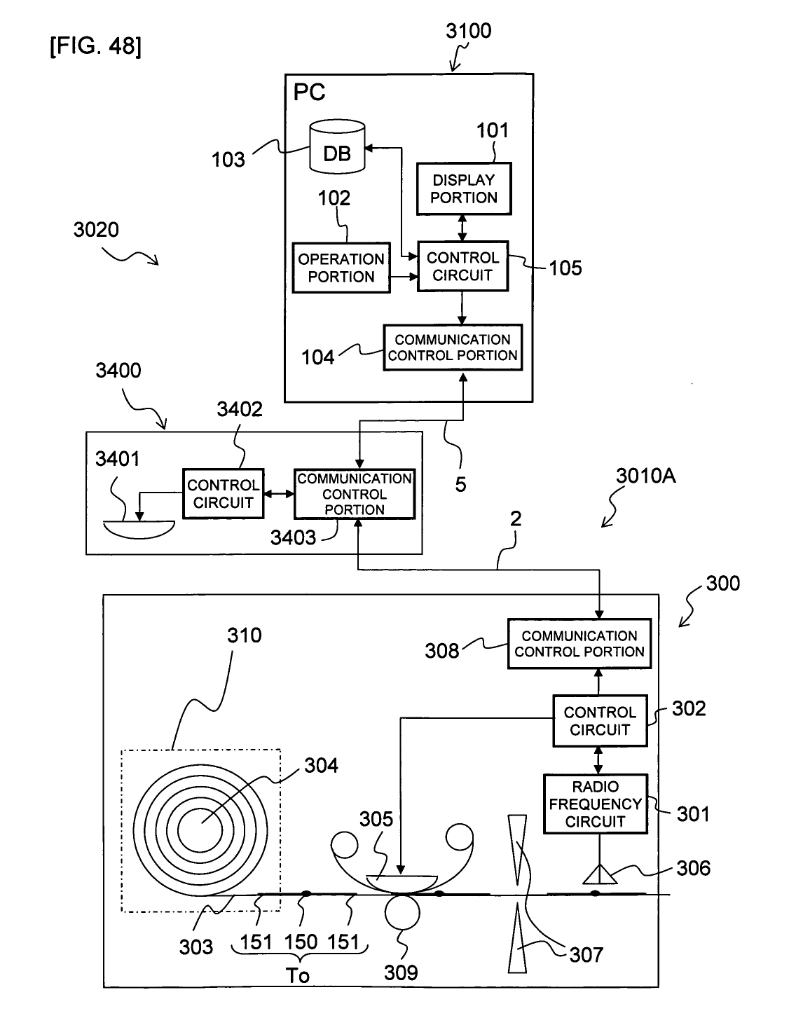

FIG. 48 is a functional block diagram illustrating detailed functions of the PC 3100 (operation terminal), the printer 3400, and the apparatus 300 for producing RFID label constituting the manufacturing system 3020 for printed matter with tag and corresponds to FIG. 2 and the like of the first embodiment.

In FIG. 48, the PC 3100 has the display portion 101 configured to make a predetermined display such as various input screens, the operation portion 102 provided with an appropriate button, key, mouse and the like for operation input by an operator, the database 103 (hard disk or memory and the like) in which the file data and the like to be printed on the printed matter 3001 are stored, the communication control portion 104 configured to control communication with the printer 3400 via the communication line 5, and the control circuit 105 configured to control an entire operation of the PC 3100 including the display portion 101, the operation portion 102, the database 103, and the communication control portion 104.

The printer 3400 has a print head 3401 (printing device) configured to print the file data stored in the database 103 of the PC 3100 on an object to be printed (A4 sheet and the like), a control circuit 3402 configured to control the entire operation of the printer 3400 including the print head 3401, and a communication control portion 3403 configured to control communication with the PC 3100 via the communication line 5 and to control communication with the apparatus 300 for producing RFID label via the connecting member 2.

On the other hand, the apparatus 300 for producing RFID label has, similar to each of the above embodiments, the print head 305 (second printing device) configured to apply a desired print on a region corresponding to the RFID circuit element To in the tag tape 303 fed out of roll 304 of a tape with RFID tags, and the communication control portion 308 configured to control communication made with the printer 3400 via the connecting member 2. Other than the above, since the holder portion 310 of roll of a tape with RFID tags, the antenna 306 (antenna for production, apparatus antenna), the radio frequency circuit 301, the control circuit 302, the cutter 307, and the feeding device 309 (feeding device) and the like are similar to the above, the description will be omitted.

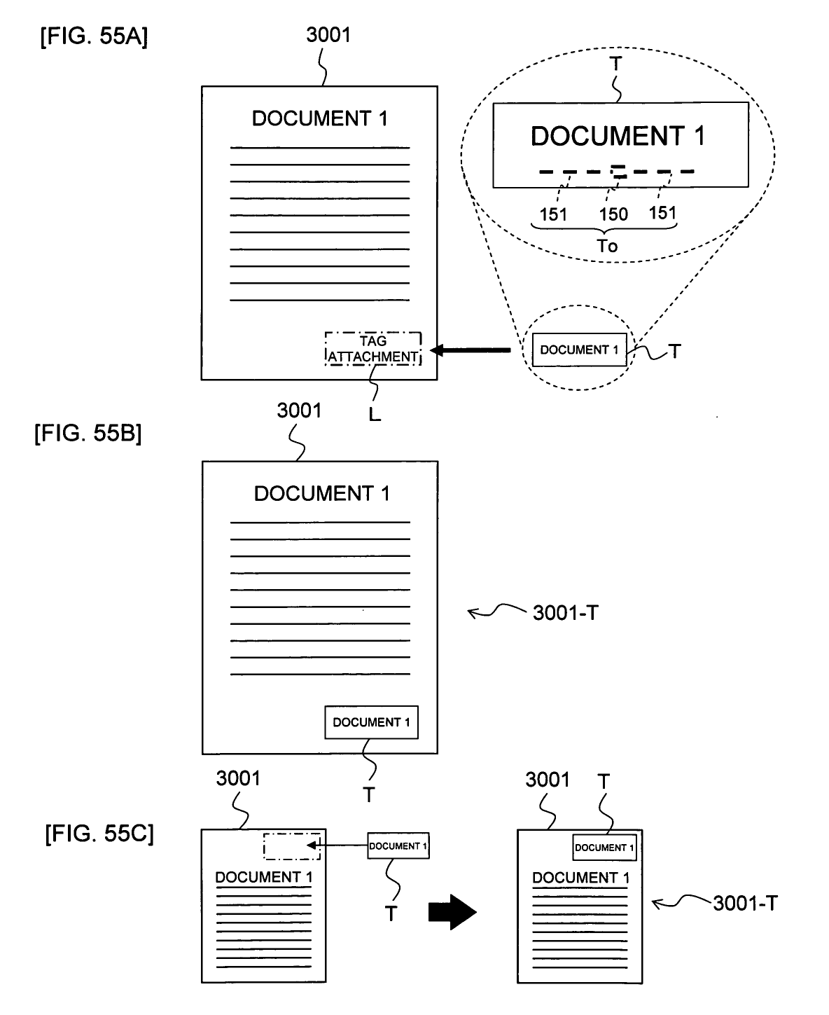

In the manufacturing system 3020 for printed matter with tag with the above configuration, if the printed matter with tag (details will be described later) is to be produced, the operator edits and inputs file data to be printed and tag layout and the like using the operation portion 102 of the PC 3100 and stores the file data in the database 103. As a result, print data is transmitted to the printer 3400 from the PC 3100, printing on the basis of the print data is applied on an object to be printed, and the printed matter 3001 is produced, while tag data is transmitted to the apparatus 300 for producing RFID label via the printer 3400 from the PC 3100, and the RFID label T is produced on the basis of the tag data. That is, by the control of the control circuit 302 of the apparatus 300 for producing RFID label, the print is applied by the print head 305 on the basis of the print information in the tag data, and access information is created by the radio frequency circuit 301 and transmitted to the RFID circuit element To via the apparatus antenna 306, file access information (details will be described later) in the tag data and the like are written in the IC circuit part 150 of the RFID circuit element To, and the RFID label T is produced. Then, when the operator attaches the RFID label T produced by the apparatus 300 for producing RFID label on a tag attachment region of the printed matter 3001 produced by the printer 3400, a printed matter with tag 3001-T is produced (See FIG. 55, which will be described later).

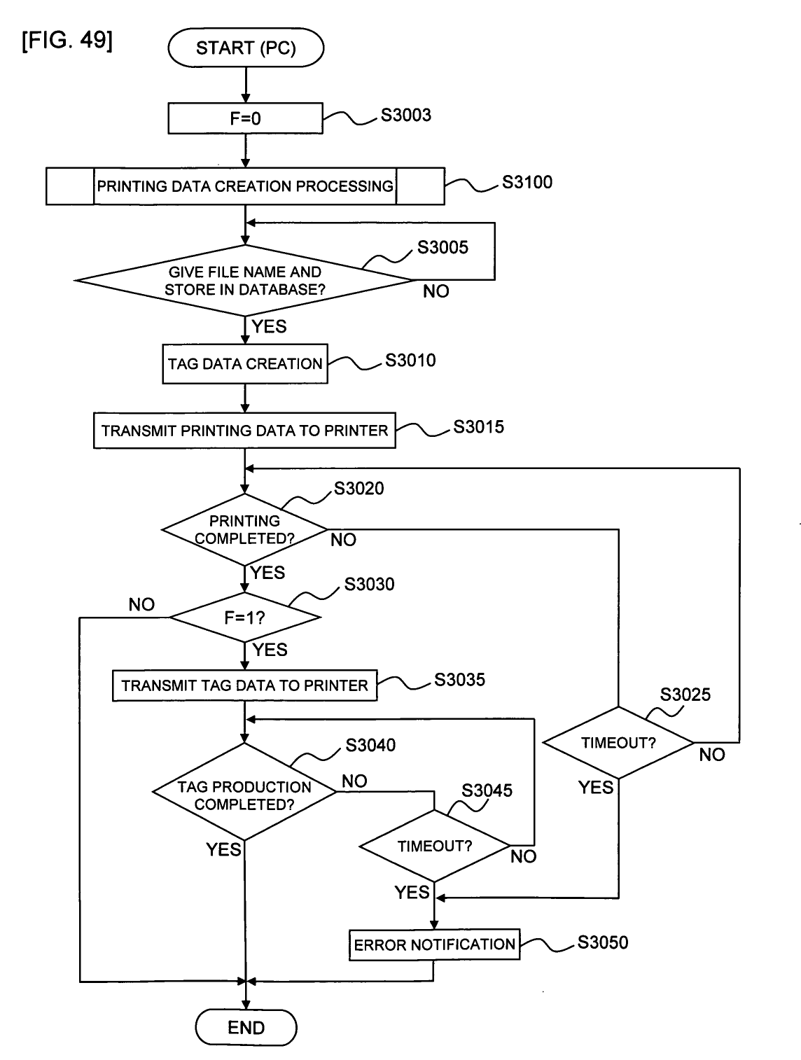

FIG. 49 is a flowchart illustrating a control procedure executed by the control circuit 105 of the PC 3100 when the printed matter with tag is produced. This flow is started by the control circuit 105 when an appropriate instruction to manufacture the printed matter with tag is input by the operator.

First, at Step S3003, a flag F indicating if it is in a “tag production printing mode” in which the printed matter with tag 3001-T is produced by attaching the RFID label T onto the printed matter 3001 or in a “usual printing mode” in which the usual printed matter 3001 is produced without attaching the RFID label T is initialized to zero indicating the “usual printing mode”.

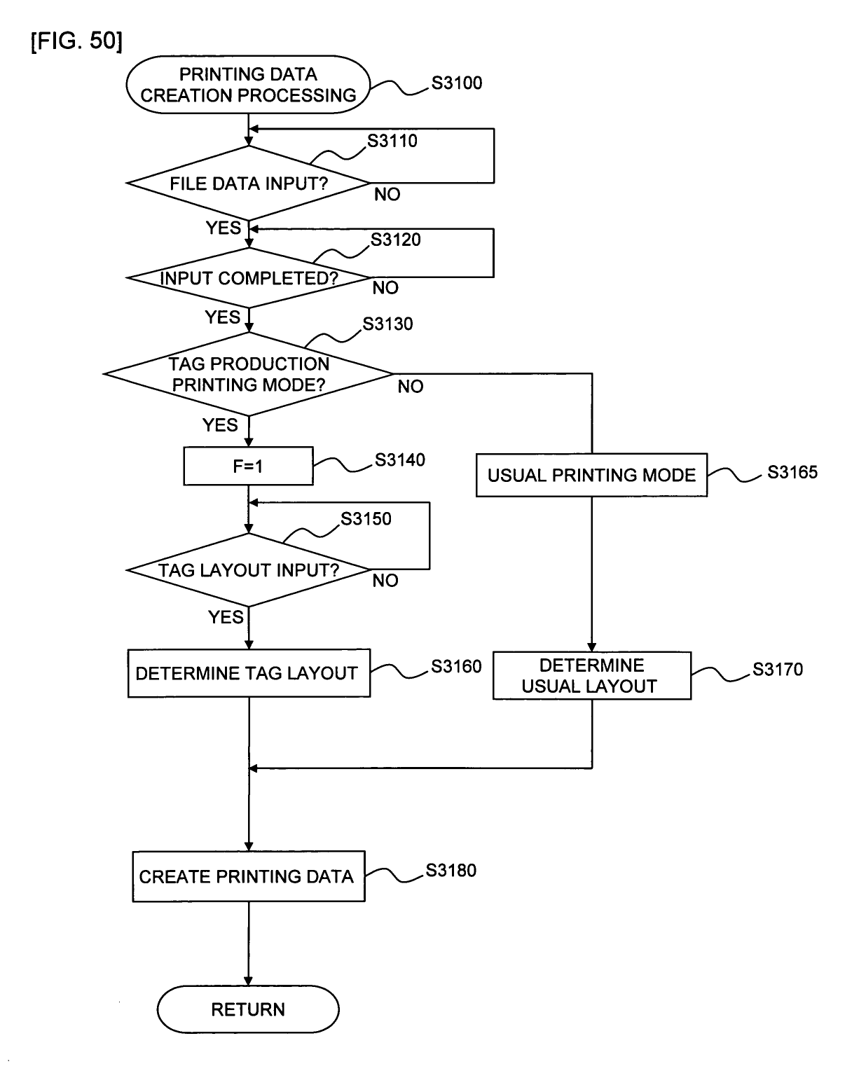

At the subsequent Step S3100, on the basis of the file data input by the operator via the operation portion 102 and its layout information, printing data creation processing for creating the printing data is carried out (for detailed procedures, see FIG. 50, which will be described later).

At the subsequent Step S3005, it is determined whether or not the file data input at Step S3100 has been stored in the data base 103 with a file name. This Step S3005 is repeated till a storage instruction is input by the operator via the operation portion 102, and if an input is made, the determination is satisfied, and the routine goes to the subsequent Step S3010.

At Step S3010, tag data is created which includes the print information containing the file name input at Step S3005 (print information printed on the RFID label T) and tag writing information having the identification information (tag ID) of the RFID circuit element To and file access information (storage destination information, processing assisting information for operator) indicating a storage destination where the file data are stored. The file access information is electronic address information such as “C:¥ . . . ¥ . . . ¥file name”, for example, and includes file name information of usual file data.

At the subsequent Step S3015, the printing data (printing instruction signal) created at the previous Step S3100 is transmitted to the printer 3400 via the communication control portion 104 and the communication line 5.

At the subsequent Step S3020, it is determined if the printing by the printer 3400 has been completed or not based on whether or not a printing completion signal has been received from the printer 3400 via the communication line 5. If the printing completion signal has not been received from the printer 3400, the routine goes to Step S3025, where it is determined if a predetermined time set in advance has elapsed or not. If not elapsed, the routine returns to Step S3020, where it is determined again if the printing completion signal has been received from the printer 3400 or not. If the predetermined time has elapsed, the routine goes to Step S3050, which will be described later, where a control signal is output to the display portion 101 so as to make a corresponding error display (such as “printing has not been completed normally”, for example) and an error is notified to the operator (not limited to the display but may be notified in voice). Then, this flow is finished.

On the other hand, at Step S3020, if the printing completion signal has been received from the printer 3400, the determination is satisfied, and the routine goes to the subsequent Step S3030.

At Step S3030, it is determined if the flag F is one indicating the “tag production printing mode” or not. If the tag production printing mode has been input by the operator, the flag F is one (See Step S3140 in FIG. 50, which will be described later), and the determination is satisfied and the routine goes to the subsequent Step S3035.

At Step S3035, the tag data created at the previous Step S3010 is transmitted to the printer 3400 via the communication control portion 104 and the communication line 5. This tag data is transmitted from the printer 3400 to the apparatus 300 for producing RFID label after that.

At the subsequent Step S3040, it is determined if the production of the RFID label T by the apparatus 300 for producing RFID label has been completed or not based on whether or not the tag production completion signal to be transmitted from the apparatus 300 for producing RFID label via the printer 3400 has been received. If the tag production completion signal has not been received, the routine goes to Step S3045, where it is determined if a predetermined time set in advance has elapsed or not. If not elapsed, the routine returns to Step S3040, where it is determined again if the tag production completion signal has been received from the apparatus 300 for producing RFID label (via the printer 3400) or not. If the predetermined time has elapsed, the routine goes to Step S3050, where a control signal is output to the display portion 101 so as to make a corresponding error display (such as “tag label production has not been completed normally”, for example) and an error is notified to the operator (not limited to the display but may be notified in voice). Then, this flow is finished.

On the other hand, at Step S3040, if the tag production completion signal has been received from the apparatus 300 for producing RFID label (via the printer 3400), this flow is finished.

At the previous Step S3030, if the tag production printing mode has not been input by the operator, the flag F is still zero (See Step S3140 and the like in FIG. 50, which will be described later), the determination is not satisfied and this flow is finished.

FIG. 50 is a flowchart illustrating a detailed procedure of Step S3100.

First, at Step S3110, it is determined whether or not the file data as a target to be printed by the printer 3400 on an object to be printed has been input by the operator via the operation portion 102. The Step S3110 is repeated till the input is made, and upon input, the determination is satisfied, and the routine goes to the subsequent Step S3120.

At Step S3120, it is determined whether or not input of the file data executed by the operator via the operation portion 102 has been completed. This determination is made based on whether the file data has been stored or not or a printing instruction input has been made or not and the like, for example. The Step S3120 is repeated till the input of the file data has been completed, and if the input is completed, the determination is satisfied, and the routine goes to the subsequent Step S3130.

At Step S3130, it is determined if it is in the tag production printing mode or not. This determination is made based on whether the tag production printing mode has been selected and input by the operator or not. The mode selection is made by displaying a selection screen of the “tag production printing mode” or the “usual printing mode” on the display portion 101 and by making selection and input by the operator via the operation portion 102 according to the screen. In the case of the tag production printing mode, the determination is satisfied and the routine goes to the subsequent Step S3140.

At Step S3140, the flag is set to one indicating the “tag production printing mode” and the routine goes to the subsequent Step S3150.

At Step S3150, it is determined whether or not tag layout data (layout information of an attachment region of the RFID label T to an object to be printed) has been input by the operator via the operation portion 102. For the input of the tag layout data, a plurality of formats is set in advance such that the attachment region of the RFID label T is at the upper end or lower end of the object to be printed (A4 sheet and the like), at a position further biased to right or left, the RFID label is oriented vertically or laterally and the like, and the input is made by being selected and input by the operator from among the formats via the operation portion 102. Step S3150 is repeated till the tag layout is input, and upon input, the routine goes to the subsequent Step S3160.

At Step S3160, on the basis of the tag layout data input at Step S3150, the tag layout is determined, and the routine goes to the subsequent Step S3180.

At the previous Step S3130, if the usual printing mode has been selected and input by the operator, the determination is not satisfied but the routine goes to Step S3165 to the usual printing mode, and at the subsequent Step S3170, layout as a usual printed matter not including the attachment region of the RFID label T is determined, and the routine goes to the subsequent Step S3180.

At Step S3180, on the basis of the file data and the layout data set by the above procedure, the printing data to be transmitted to the printer 3400 is created. In the case of the tag production printing mode, drawing data of a tag attachment frame L on the basis of the above-set layout data is included in the printing data (text data may be further included in the attachment frame. See FIG. 55, which will be described later) Then, this routine is finished.

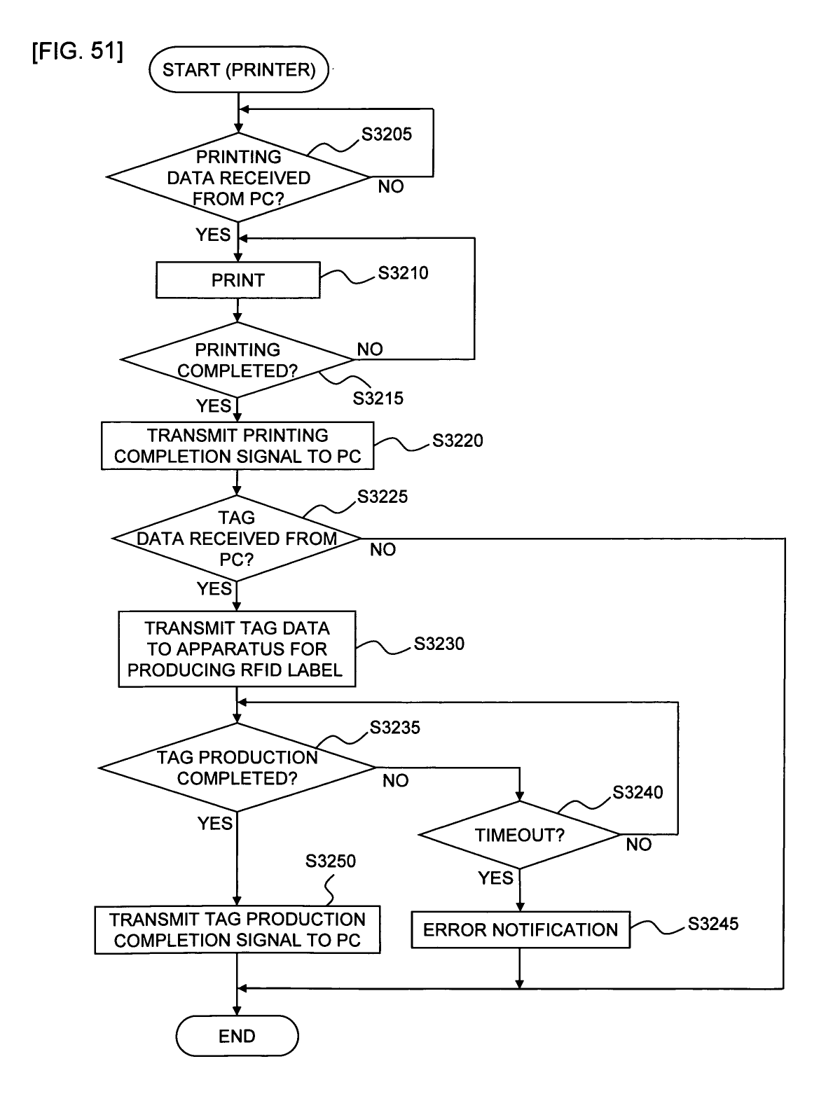

FIG. 51 is a flowchart illustrating a control procedure executed by a control circuit 3402 of the printer 3400 when the printed matter with tag is produced.

First, at Step S3205, it is determined if the printing data has been received or not from the PC 3100 via the communication line 5. Step S3205 is repeated till the printing data is received. If the printing data is transmitted from the PC 3100 at the above-mentioned Step S3015 and the data is received, the determination is satisfied, and the routine goes to the subsequent Step S3210.

At Step S3210, a control signal is output so as to start the print head 3401, and on the basis of the printing data received at Step S3205, printing is applied on the object to be printed.

At the subsequent Step S3215, it is determined whether or not all the printing data (in other words, the file data to be printed) received at Step S3205 have been printed on the object to be printed. If the printing has not been completed, the determination is not satisfied and the routine returns to Step S3210, where the printing is continued. If the printing has been completed, the determination is satisfied, and the routine goes to the subsequent Step S3220.

At Step S3220, a printing completion signal is transmitted to the PC 3100 via the communication control portion 3403 and the communication line 5.

At the subsequent Step S3225, it is determined if the tag data has been received or not from the PC 3100 via the communication line 5. If the tag data has not been received, it is in the usual printing mode, and this flow is finished. On the other hand, if the tag data is transmitted from the PC 3100 at the above-mentioned Step S3025 and the data is received, the determination is satisfied, and the routine goes to the subsequent Step S3230.

At Step S3230, the tag data (tag production instruction signal) received at Step S3225 is transmitted to the apparatus 300 for producing RFID label via the communication control portion 3403 and the connecting member 2.

At the subsequent Step S3235, it is determined whether or not the production of the RFID label T by the apparatus 300 for producing RFID label has been completed based on whether or not the tag production completion signal transmitted from the apparatus 300 for producing RFID label has been received via the connecting member 2. If the tag production completion signal has not been received, the routine goes to Step S3240, where it is determined if a predetermined time set in advance has elapsed or not. If not elapsed, the routine returns to Step S3235, where it is determined again if the tag production completion signal has been received or not from the apparatus 300 for producing RFID label. If the predetermined time has elapsed, the routine goes to Step S3245, where a control signal is output to the display portion, not shown, of the printer 3400 so as to make a corresponding error display (such as “tag label production has not been completed normally”, for example) and an error is notified to the operator (not limited to the display but may be notified in voice). Then, this flow is finished.

On the other hand, at Step S3235, if the tag production completion signal has been received from the apparatus 300 for producing RFID label, the routine goes to Step S3250.

At Step S3250, the tag production completion signal is transmitted to the PC 3100 via the communication control portion 3403 and the communication line 5. Then, this flow is finished.

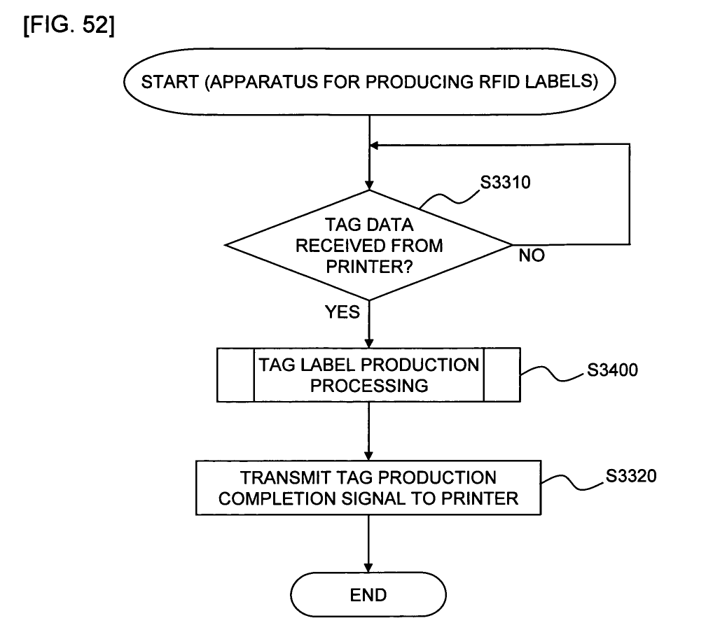

FIG. 52 is a flowchart illustrating a control procedure executed by the control circuit 302 of the apparatus 300 for producing RFID label when the printed matter with tag is produced.

First, at Step S3310, it is determined if the tag data has been received or not from the printer 3400 via the connecting member 2. This Step S3310 is repeated till the tag data is received. If the tag data is transmitted from the printer 3400 at the previous Step S3230 and the data is received, the determination is satisfied, and the routine goes to the subsequent Step S3400.

At Step S3400, on the basis of the tag data received at Step S3310, the print corresponding to the print information in the tag data (file name in this example) is applied by the print head 305, the writing information in the tag data (tag ID, file access information) is written in the IC circuit part 150 of the RFID circuit element To as well, and the tag label production processing for producing the RFID label T is carried out.

At the subsequent Step S3320, the tag production completion signal is transmitted to the printer 3400 via the communication control portion 308 and the connecting member 2. Then, this flow is finished.

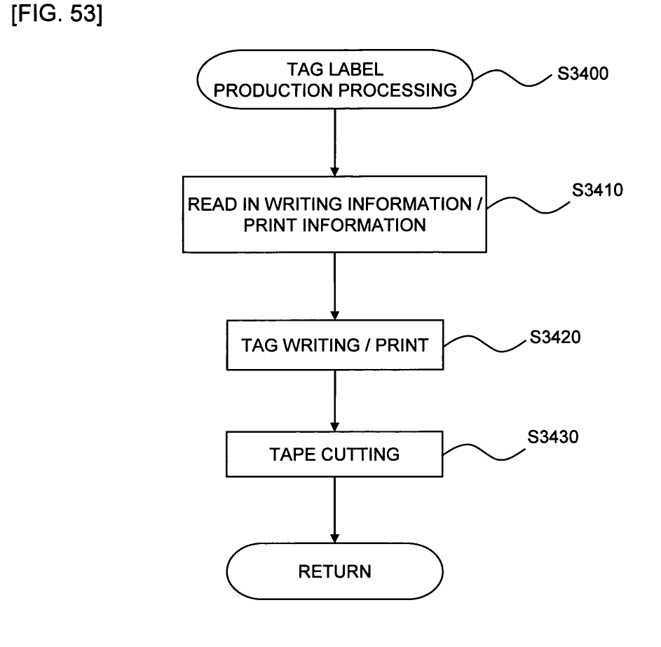

FIG. 53 is a flowchart illustrating a detailed procedure of Step S3400.

First, at Step S3410, on the basis of the tag data received from the printer 3400 at Step S3310, the print information (file name in this example) and the writing information (tag ID, file access information) in the tag data are gotten.

After that, the routine goes to Step S3420, the access information is created by the radio frequency circuit 301 and transmitted to the RFID circuit element To via the apparatus antenna 306, and the writing information gotten at Step S3410 is written in the IC circuit part 150. Also, the print is applied by the print head 305 on the basis of the print information gotten at Step S3410.

At the subsequent Step S3430, tape cutting is carried out so as to produce the RFID label T provided with one RFID circuit element To, and this routine is finished.

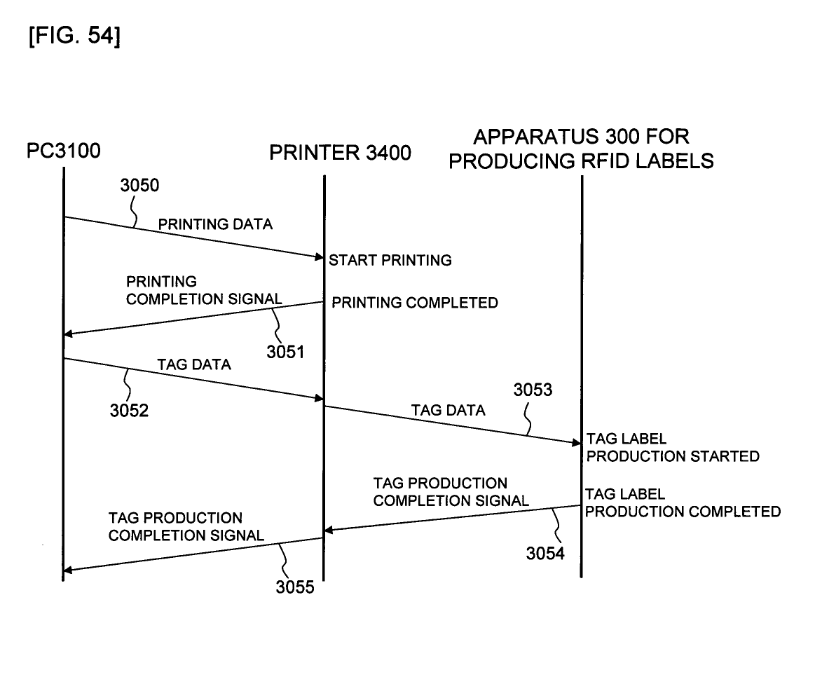

FIG. 54 is a diagram illustrating signal transmission/reception made among the PC 3100, the printer 3400, and the apparatus 300 for producing RFID label in a time sequence in the control executed when the printed matter with tag is produced as mentioned above.

In FIG. 54, the printing data created by the PC 3100 is transmitted to the printer 3400 as shown by an arrow 3050 in the figure (See the above-mentioned Step S3015), by which the printer 3400 starts printing (See the above-mentioned Step S3205, Step S3210). Then, when the printing is completed and the production of the printed matter 3001 is completed, the printer 3400 transmits the printing completion signal to the PC 3100 as shown by an arrow 3051 in the figure (See the above-mentioned Step S3215, Step S3220). The PC 3100 having received the printing completion signal transmits the created tag data to the printer 3400 as shown by an arrow 3052 in the figure if it is in the tag production printing mode (See the above-mentioned Step S3020, Step S3030, and Step S3035). The printer 3400 having received the tag data transmits the tag data to the apparatus 300 for producing RFID label as shown by an arrow 3053 in the figure (See the above-mentioned Step S3225, Step S3230). The apparatus 300 for producing RFID label having received the tag data starts production of the RFID label T (See the above-mentioned Step S3310, Step S3400).

The apparatus 300 for producing RFID label transmits the tag production completion signal to the printer 3400 as shown by an arrow 3054 in the figure (See the above-mentioned Step S3400, Step S3320) when the production of the RFID label T is completed. The printer 3400 having received the tag production completion signal transmits the tag production completion signal to the PC 3100 as shown by an arrow 3055 in the figure (See the above-mentioned Step S3235, Step S3250).

FIG. 55A is a top view illustrating an example of an entire schematic configuration of the printed matter 3001 produced by the printer 3400 and the RFID label T produced by the apparatus 300 for producing RFID label by the above procedure, and FIG. 55B is a top view illustrating an example of the entire schematic configuration of the printed matter with tag 3001-T produced by attaching the RFID label T on the printed matter 3001.

In FIG. 55A, on the surface of the printed matter 3001, the file data to be printed (file name of the file data in this example is “document 1”) is printed, and the tag attachment frame L (identifier) indicating the attachment position of the RFID label T is printed on its lower end on the right side (moreover, the characters of “tag attachment” are printed inside the attachment frame L in this example). Note that the tag attachment frame L is shown in a shape in conformity to the shape of the RFID label T here, but not limited to that, it may be any shape as long as the layout position of the RFID circuit element To can be identified such as a shape of the RFID circuit element To itself or a shape of an antenna base (not shown) provided in order to protect the RFID circuit element To before the RFID circuit element To is arranged on the tag tape 303, for example. Also, the characters within the attachment frame L may be characters other than the above, for example, the file name “document 1” and the like, or does not necessarily have to be printed.

On the other hand, the RFID label T is formed in the label shape and is constituted by a substantially square base and the RFID circuit element To arranged on the base. On the front side (upper face) of the base, the print region S is provided on which the file name “document 1”, which is the identification information of the printed file data of the printed matter 3001 on which the RFID label T is to be attached.

Then, as shown in FIG. 55B, when the user attaches the RFID label T on the printed matter 3001 in conformity to the tag attachment frame L, the printed matter with tag 3001-T is produced. A case where the user selects another format is shown in FIG. 55C. This is the case where the format in which the RFID label T is attached upper right is selected.

Since the functional configuration of the RFID circuit element To provided at the RFID label T is similar to the above description using FIG. 10, the detailed description will be omitted.

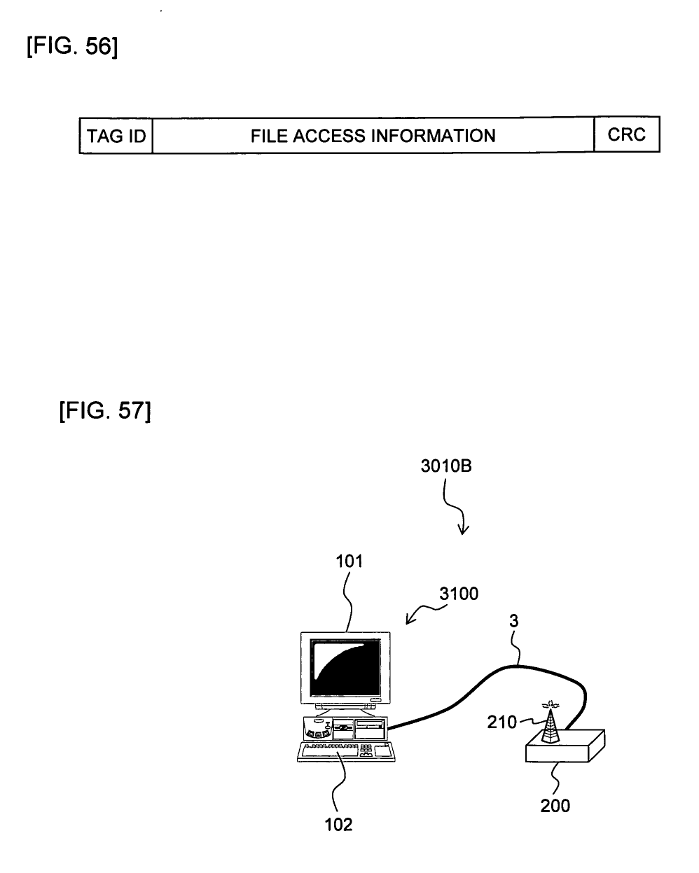

FIG. 56 is a diagram illustrating an example of the data structure of the memory part 155 of the IC circuit part 150 in the RFID circuit element To provided at the RFID label T produced by the apparatus 300 for producing RFID label.

In the example shown in FIG. 56, the data stored in the memory part 155 of the IC circuit part 150 in the RFID circuit element To is constituted by the tag ID, which is the above-mentioned identification information of the RFID circuit element To, the file access information, which is the information on the storage destination of the file data, which is the data to be processed, of the printed matter 3001, and an error detection code CRC (Cyclic Redundancy Check) indicating validity of the data.

FIG. 57 is a system configuration diagram illustrating entire configuration of the printing management system when the printed matter with tag is read out.

In FIG. 57, a printing management system 3010B (here, showing a state where the printed matter with tag is read out) has the reader 200 having antenna 210 (reading device side antenna, apparatus antenna) configured to read out the information via radio communication from the RFID label T produced by the apparatus 300 for producing RFID label and the PC 3100 connected to the reader 200 via the connecting member 3 such as a USB cable, for example, and having the display portion 101, the operation portion 102 and the like. The PC 3100 and the reader 200 may be connected via a network through the above-mentioned communication line 5.

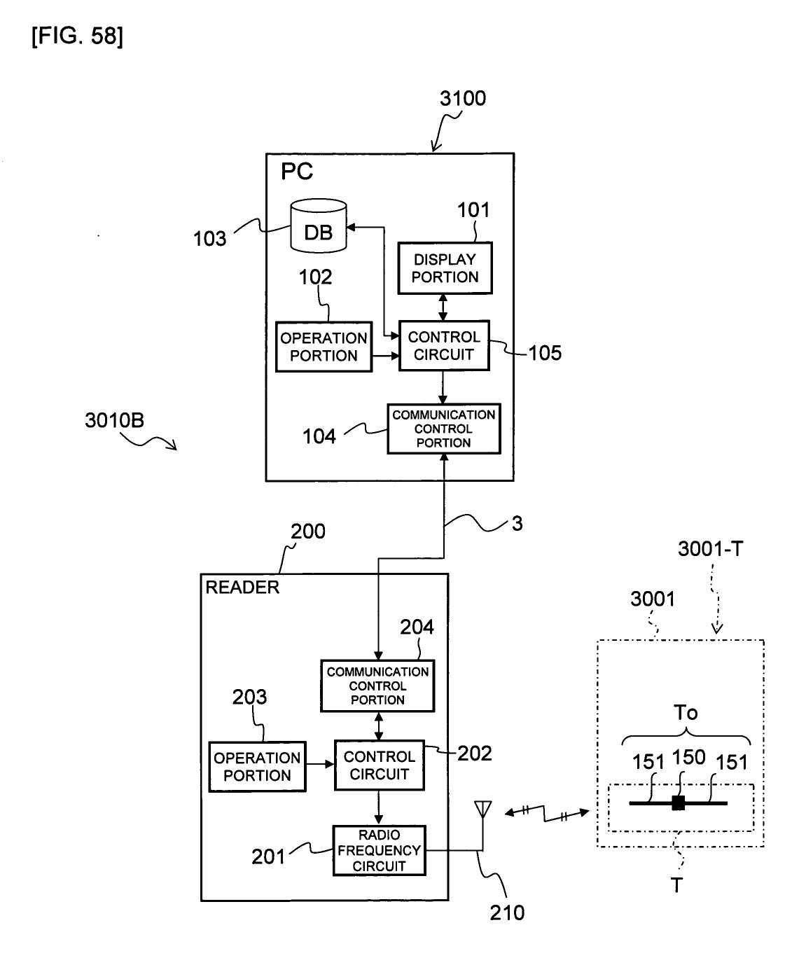

FIG. 58 is a functional block diagram illustrating detailed functions of the PC 3100 and the reader 200 constituting the printing management system 3010B and corresponds to the above-mentioned FIG. 13 and the like. In FIG. 58, the reader 200 has, similar to the above, the antenna 210, the radio frequency circuit 201, the control circuit 202, the operation portion 203, and the communication control portion 204.

In the above configuration, when the RFID tag information of the RFID label T attached on the printed matter with tag 3001-T is to be read out by the reader 200, the printed matter with tag 3001-T (RFID label T) is brought close to the side of the reader 200 (to have it present in a communicable range). At this time, as mentioned above, the IC circuit part 150 of the RFID circuit element To in the RFID label T stores and holds the file access information relating to a storage location of the file data as a printing target printed on the printed matter with tag 3001-T (printed matter 3001), and when the information is gotten by the side of the reader 200, the file data is read in from the database 103 of the PC 3100 on the basis of the file access information.

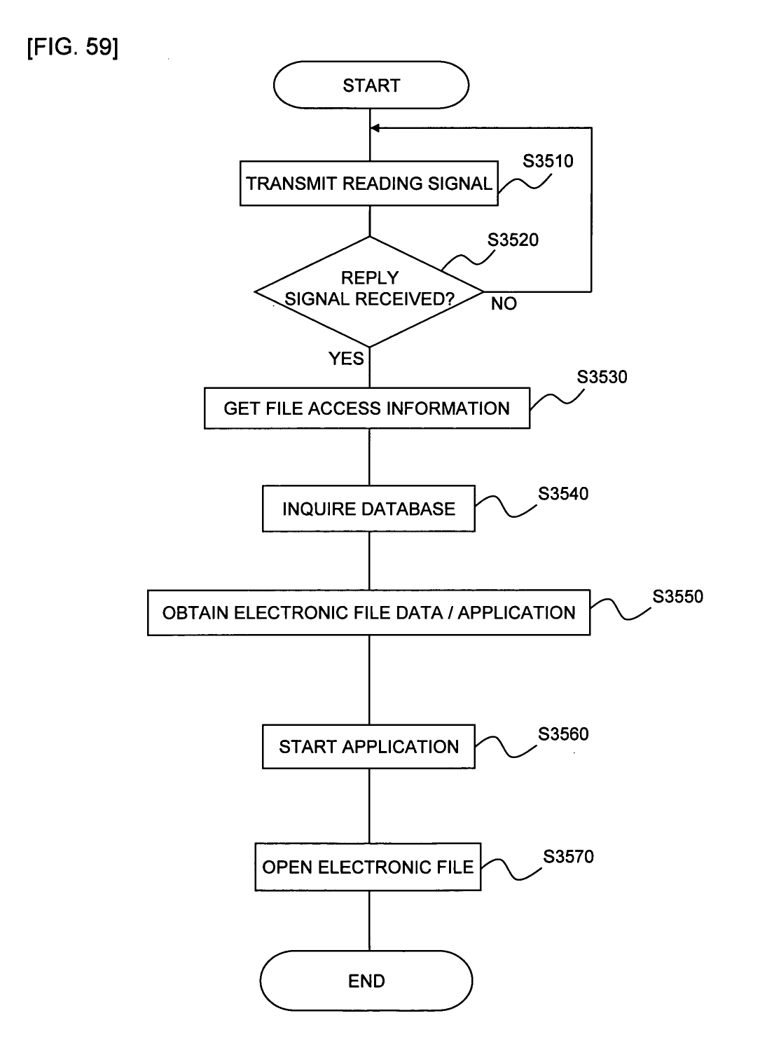

FIG. 59 is a flowchart illustrating a control procedure executed by the control circuit 202 of the reader 200 when the RFID tag information of the RFID label T is read out and corresponds to FIG. 14.

In FIG. 59, first, at Step S3510, similarly to Step S210 in FIG. 14, a signal for reading out the information stored in the IC circuit part 150 of the RFID circuit element To in the RFID label T is transmitted via the radio frequency circuit 201 and the antenna 210.

After that, the routine goes to Step S3520, where similarly to Step S220 in FIG. 14, it is determined if a reply signal transmitted (returned) from the RFID circuit element To in response to the “Scroll All ID” signal has been received via the antenna 210 and taken into the control circuit 202 via the radio frequency circuit 201.

If the reply signal has not been received, the determination is not satisfied, and the routine returns to Step S3510 and the similar procedure is repeated. If the reply signal is received, the determination at Step S3520 is satisfied, and the routine goes to Step S3530.

At Step S3530, the file access information, which is the information of the storage destination of the file data, is read and gotten from the reply signal received from the RFID circuit element To. Incidentally, the read-out information is temporarily stored in an appropriate storage device (such as a memory provided at the control circuit 202, for example).

Subsequently, at Step S3540, similarly to Step S240 in FIG. 14, a control signal is output to the control circuit 105 of the PC 3100 via the communication control portion 204 and the connecting member 3 and an inquiry about the file data is made at the database 103 on the basis of the file access information gotten at Step S3530.

At the subsequent Step S3550, similarly to Step S250 of FIG. 14, the file data corresponding to the inquiry at Step S3540 is read out of the database 103 and the predetermined application (such as Japanese software, drawing software, for example) corresponding to the file data is obtained. Incidentally, the read-out electronic file data and the application data are temporarily stored in an appropriate storage device (such as RAM provided at the control circuit 105 of the PC 3100, for example). As for the application, an appropriate application (such as word-processor software) is selected according to the type of the file data.

Then, at Step S3560, similarly to Step S260 in FIG. 14, a control signal is output to the control circuit 105 of the PC 3100 via the communication control portion 204 and the connecting member 3, and the application obtained at Step S3550 is started.

After that, at Step S3570, similarly to Step S270 in FIG. 14, a control signal is output to the control circuit 105 of the PC 3100 via the communication control portion 204 and the connecting member 3, and the file data is opened on the started application. Then, this flow is finished.

Note that in the above, the application is automatically opened for use after the file data is obtained from the database 103 of the PC 3100, but not limited to that, only obtainment from the database 103 is carried out and the subsequent file processing may be executed by the operator. Also, in the above, the reading of the RFID tag information and the obtainment of the file data from the database 103 and the like are carried out by the control circuit 202 of the reader 200, but it may be so configured that up to the reading of the RFID tag information is carried out by the control circuit 202 of the reader 200 and the subsequent obtainment of the file data and the like is carried out on the side of the control circuit 105 of the PC 3100.

In the above, Step S3230 executed by the control circuit 3402 of the printer 3400 constitutes a production instruction output portion that outputs the tag production instruction signal to the apparatus for producing RFID label described in each claim and also constitutes a transmission/reception instructing portion. Also, Step S3225 executed by the control circuit 402 constitutes an information acquisition portion for printing that gets storage destination information of the file data from the operation terminal.

Step S3420 executed by the control circuit 302 of the apparatus 300 for producing RFID label constitutes a writing control portion that writes the storage destination information of the file data or information corresponding to that and also constitutes a transmission/reception control portion.

In the printer 3400 of the sixth embodiment configured as above, when the printing data is input from the PC 3100, the printing corresponding to the file data to be printed is applied by the print head 3401 on the object to be printed. Then, in response to the printing by the print head 3401, the control circuit 3402 outputs the tag data to the apparatus 300 for producing RFID label via the communication control portion 3403 and the connecting member 2. In response to that, at the apparatus 300 for producing RFID label, the RFID label T that can get the storage destination information of the file data is produced.

The produced RFID label T is attached to the printed matter 3001 on which the corresponding file data is printed by the print head 401. As a result, if the user who obtained the printed matter with tag 3001-T thus produced intends to obtain the file data of the printed matter with tag 3001-T, the user can get the storage destination information (electronic address) of the file data by reading the information from the RFID circuit element To of the RFID label T attached to the printed matter with tag 3001-T and make an access to the file data easily using that. As mentioned above, since the data of the printed matter itself can be easily obtained from the printed matter, convenience of the user can be improved.

Also, particularly in this sixth embodiment, the tag attachment frame L indicating the arrangement position of the RFID circuit element To is printed on the object to be printed. As a result, the user can attach the RFID label T on the printed matter 3001 easily and assuredly.

Also, particularly in this sixth embodiment, the print that can identify the corresponding file data (print of the file name in this example) is applied by the print head 305 of the apparatus 300 for producing RFID label on the region corresponding to the RFID circuit element To in the tag tape 303. As a result, the fact that the RFID label T is for the printed matter 3001 of the corresponding file data can be visually made clear, and the association between the printed matter 3001 and the RFID label T can be made clear. As a result, attachment of a wrong label and the like can be assuredly prevented.

The sixth embodiment is not limited to the above mode but is capable of further various variations in a range not departing from its gist and technical idea. The variations will be described below.

(C-1) When the File Data is Stored in a Server Connected to a Network:

In the sixth embodiment, the file data to be printed by the printer 3400 is stored in the database 103 provided at the PC 3100, but not limited to that, it may be stored outside the PC 3100 or in a database of a server and the like connected to a network, for example.

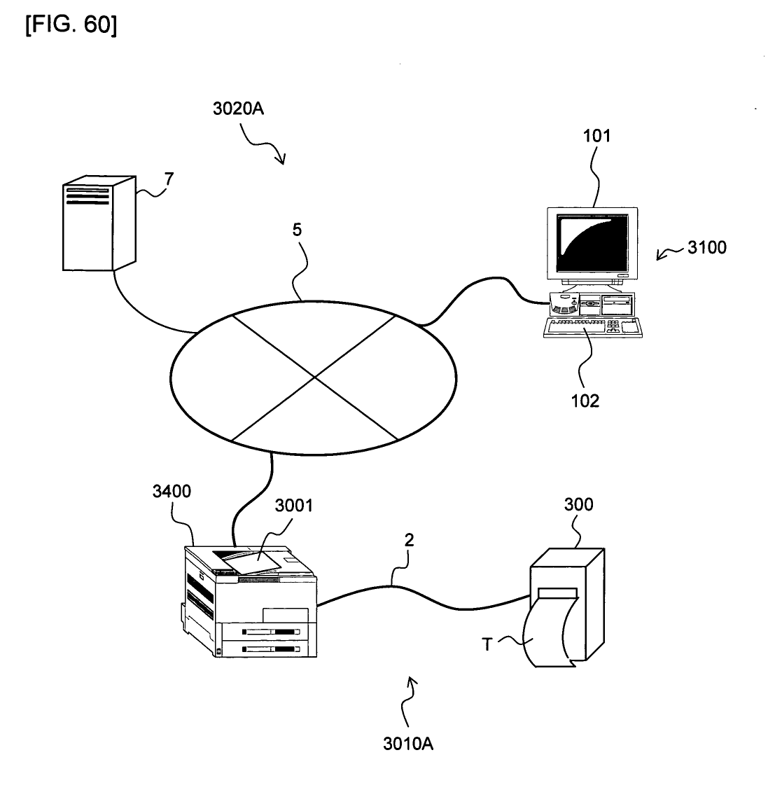

FIG. 60 is a system configuration diagram illustrating entire configuration of the manufacturing system for printed matter with tag of this variation and corresponds to the above-mentioned FIG. 47. The same reference numerals are given to portions equivalent to those in FIG. 47 and the description will be omitted. As shown in FIG. 60, a manufacturing system 3020A for printed matter with tag has the information server 7 connected to the PC 3100 and the printer 3400 capable of information transmission/reception via the communication line 5.

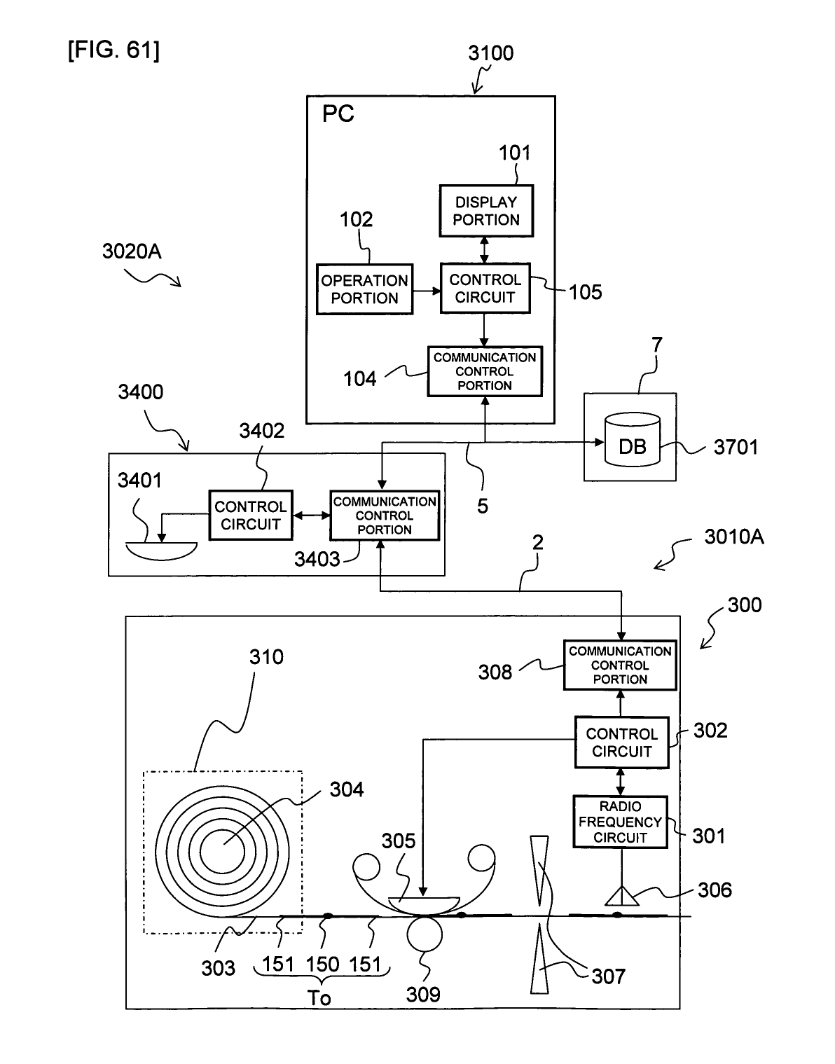

FIG. 61 is a functional block diagram illustrating detailed functions of the PC 3100, the printer 3400, the apparatus 300 for producing RFID label, and the information server 7 constituting the manufacturing system 3020A for printed matter with tag and corresponds to the above-mentioned FIG. 48. The same reference numerals are given to portions equivalent to those in FIG. 48 and the description will be omitted. As shown in FIG. 61, the information server 7 has a database 3701 (hard disk or memory and the like) in which the file data to be printed on the printed matter 3001 and the like are stored.

In this variation, by the apparatus 300 for producing RFID label, the file access information corresponding to the database 3701 of the server 7 is written in the RFID circuit element To and the RFID label T is produced. Then, the RFID label T is attached to the printed matter 3001, and the printed matter with tag 3001-T is produced. Then, by bringing the printed matter with tag 3001-T (RFID label T) close to the side of the reader 200 (to have it present in the communicable range), the file access information stored and held in the RFID circuit element To of the RFID label T is gotten, and on the basis of the file access information, the file data is read out of the database 3701 of the information server 7.

In the above-described variation, too, the effect similar to that in the sixth embodiment can be obtained.

(C-2) When there Will be a Plurality of Printed Matters:

In the sixth embodiment, a case where the file data is printed to produce a single-page printed matter as shown in the above-mentioned FIG. 55 was described as an example, but if the file data is large and will be printed matters in plural pages when printed, for example, the plural printed matters may be associated with each other and collected to produce the single RFID label T.

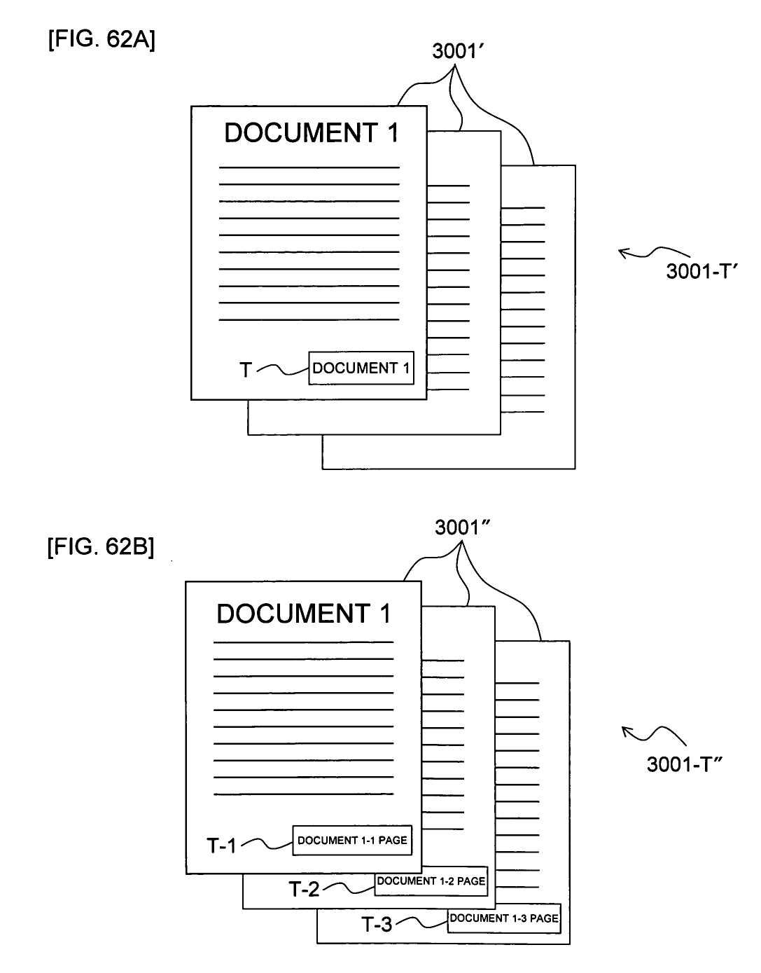

FIG. 62A is a top view illustrating an example of an entire schematic configuration of a printed matter with tag 3001-T′ produced by attaching the RFID label T produced by the apparatus 300 for producing RFID label on a printed matter 3001′ produced in this variation.

Though a detailed description will be omitted, in this variation, the printing data is created so that the tag attachment frame L is arranged on a top page of the printed mater 3001′ made of a plurality of pages by the control circuit 105 of the PC 3100 and printed by the printer 3400. As a result, as shown in FIG. 62A, the printed matter with tag 3001-T′ on which the RFID label T corresponding only to the top page of the printed matter 3001′ made of a plurality of pages is affixed is produced.

As a result, if it is more convenient to handle a plurality of printed matters in a lump sum such as a case where a plurality of pages is produced when the file data is printed and the like, by collecting the plural printed matters associated with each other so as to produce a single RFID label T, convenience can be improved.

On the contrary, the corresponding RFID label T may be produced and attached to each of the plural pages of a printed matter constituted by the plural pages. FIG. 62B is a top view illustrating an example of an entire schematic configuration of a printed matter with tag 3001-T″ produced by attaching the RFID label T produced by the apparatus 300 for producing RFID label on each page of a printed matter 3001″ in this case.

Though a detailed description will be omitted, in this variation, the printing data is created so that the tag attachment frame L is arranged on each page of the printed matter 3001″ made of a plurality of pages by the control circuit 105 of the PC 3100 and printed by the printer 3400. Also, the tag data corresponding to each page is created, respectively, and corresponding to that, the RFID labels T-1, T-2, T-3 . . . for each of the pages are produced by the apparatus 300 for producing RFID label. In this example, a document name and page numbers corresponding to each of the RFID labels T-1, T-2, T-3 . . . are printed. As a result, as shown in FIG. 62B, the printed matter with tag 3001-T″ is produced in which each of the corresponding RFID labels T-1, T-2, T-3, . . . is attached to each page of the printed matter 3001″ made of a plurality of pages.

In this case, even a case in which electronic data of only a desired page in the document 1 is to be obtained can be handled, for example, and a user's needs can be responded finely.

(C-3) Variation of the Tag Writing Information

In the sixth embodiment, when the RFID label T is produced by the apparatus 300 for producing RFID label, the tag ID, which is the identification information of the RFID circuit element To and the file access information, which is information of a storage destination of the file data to be printed on the printed matter 3001 are written in the IC circuit part 150 of the RFID circuit element To, but another information may be further written.

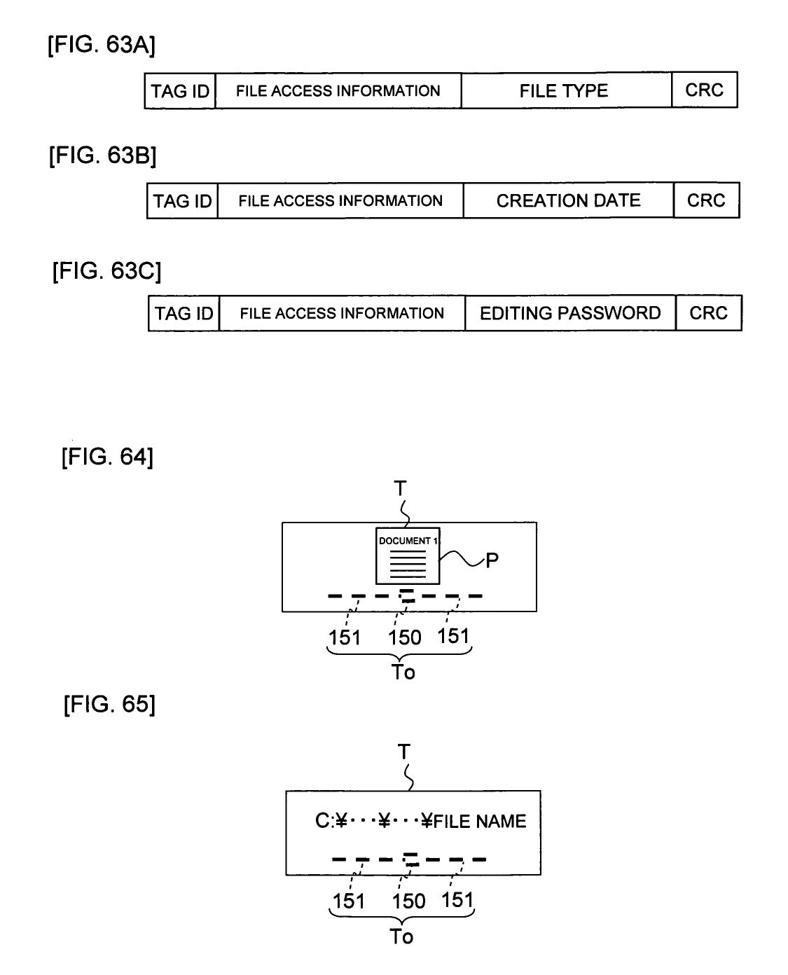

For example, identification information of the file data to be printed (file type, attribute, number and the like) may be written. FIG. 63A is a diagram illustrating an example of data structure of the memory part 155 of the IC circuit part 150 in the RFID circuit element To in this case. In this example, the data stored in the RFID circuit element To is constituted by the tag ID and the file access information, file type information as the identification information of the file data, and the error detection code CRC (Cyclic Redundancy Check) indicating validity of the data. As a result, when the RFID tag information is read out by the reader 200, the identification information (file type, attribute, number and the like) of the file data can be gotten, and convenience can be further improved such that an optimal application according to the file type can be automatically started at obtainment of the file data and the like, for example.

Also, for example, file additional information corresponding to the file data to be printed (production date of the RFID label T, version information of the software creating the file and the like) may be written. FIG. 63B is a diagram illustrating an example of data structure of the memory part 155 of the IC circuit part 150 in the RFID circuit element To in this case. In this example, the data stored in the RFID circuit element To is constituted by the tag ID and the file access information, the tag production date information as the file additional information, and the error detection code CRC. As a result, when the REID tag information is read out by the reader 200, the additional information of the electronic file such as the file creation date, software version information and the like can be gotten, and convenience can be further improved. Particularly if the tag production date is written, it becomes possible to determine if the description contents of the printed matter is the latest or not (whether the contents have not been updated since the tag production date) as will be described later, which is particularly convenient.

Moreover, authority information relating to an access to the file data or various processing (editing and the like) after the access may be written. This authority information is information that specifies a person who can download the file data in a limited manner according to confidentiality and the like of the file data, sets an authority range by processing operation according to a person (A can download the data but B can even edit the downloaded data and the like), or sets password by processing operation without personal identification and the like, for example. FIG. 63C is a diagram illustrating an example of data structure of the memory part 155 of the IC circuit part 150 in the RFID circuit element To in this case. In this example, the data stored in the RFID circuit element To is constituted by the tag ID and the file access information, the editing password information as the authority information (by inputting the password, the downloaded file data can be made editable) and the error detection code CRC.

As a result, according to the printed matter management mode and the like of the user who produces the printed matter with tag, as mentioned above, it becomes possible to specify a person who can download file data in a limited manner, to set an authority range by processing operation according to person or to set a password by processing operation without personal identification and the like, for example, and further various printed matter management can be made possible.

(C-4) Variation of the Print Mode of the RFID Label

In the sixth embodiment, when the RFID label T is produced by the apparatus 300 for producing RFID label, the file name of the file data to be printed is printed by the print head 305, but not limited to that, other identification information such as the file number, file type and the like may be used as long as the file can be identified by the information.

Other than the above identification information, as shown in FIG. 64, for example, a thumb-nail image (size-reduced image) P and the like may be printed on the top page (or a representative page and the like) of the printed matter on which the file data is printed.

Moreover, other than the above identification information and image information, as shown in FIG. 65, for example, the file access information, which is information of the storage destination of the file data written in the RFID circuit element To (storage destination information, processing assisting information for operator) may be printed. As a result, the storage destination information of the file data that is stored in the RFID circuit element To of the RFID label T attached to the printed matter and can be gotten by information reading can be also visually confirmed by the user, by which convenience can be further improved.

(C-5) When a Function to Check if the Printed Matter is the Latest or not is Provided:

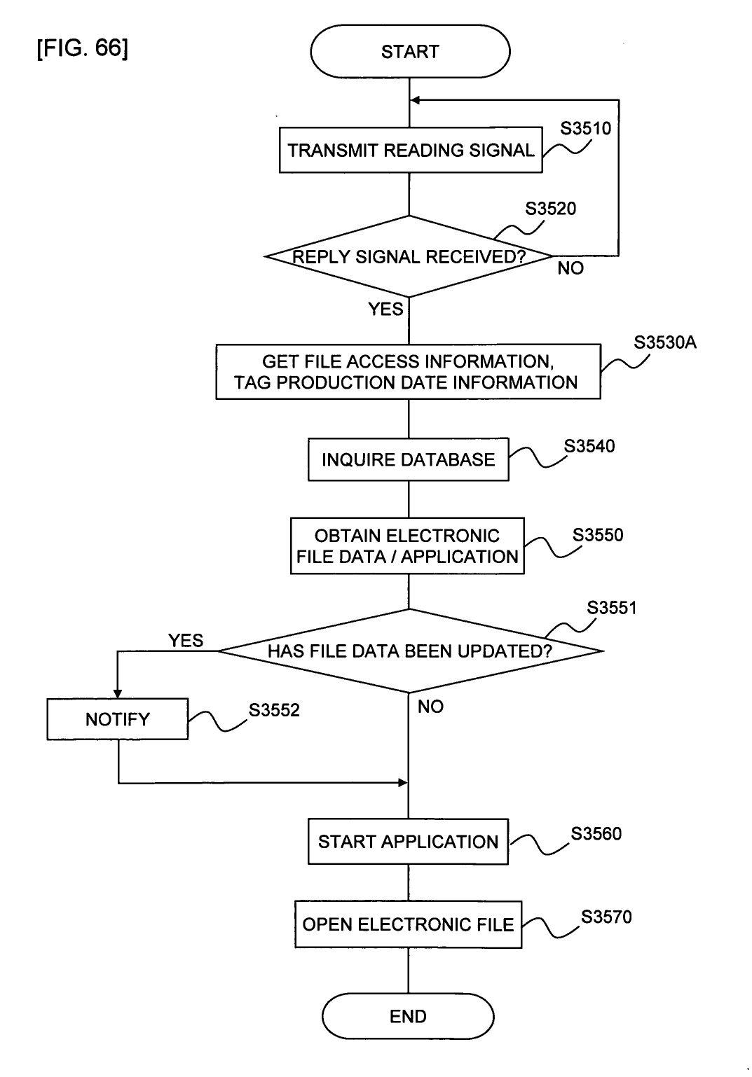

FIG. 66 is a flowchart illustrating a control procedure executed by the control circuit 202 of the reader 200 in this variation and corresponds to the above-mentioned FIG. 59. The same reference numerals are given to procedures similar to those in FIG. 59 and the description will be omitted.

In this variation, as shown in the above-mentioned FIG. 63B, the case in which the data stored in the RFID circuit element To is constituted by the tag ID and the file access information and the tag production date information as the file additional information is used as an example.

In FIG. 66, Step S3510 and Step S3520 are similar to those in FIG. 59, in which the “Scroll All ID” signal (or the “Ping” signal) for reading out the information stored in the RFID circuit element To is transmitted to the RFID circuit element To present in the communicable range, and if a reply signal transmitted (returned) from the RFID circuit element To in response to that is received, the routine goes to the subsequent Step S3530A.

At Step S3530A, from the reply signal received from the RFID circuit element To, the file access information, which is the information of the storage destination of the file data, and the production date information of the RFID label T are read out and gotten (information acquisition portion for reading, transmission/reception control portion). The read-out information is temporarily stored in an appropriate storage device (such as a memory provided at the control circuit 202, for example).

At the subsequent Step S3540 and Step S3550, on the basis of the above-gotten file access information, the file data is read out of the database 103, and the predetermined application corresponding to the file data is obtained and then, the routine goes to the subsequent Step S3551.

At Step S3551, the file data obtained at Step S3550 (in detail, update date information of the data) is compared with the production date information of the RFID label T gotten from the RFID circuit element To at the previous Step S3530A, and it is determined whether or not the file data stored in the database 103 has been updated since the tag production date (update determining portion). If not updated, at the subsequent Step S3560 and step S3570, a control signal is output to the control circuit 105 of the PC 3100 via the communication control portion 204 and the connecting member 3 so as to start the corresponding application, and the file data obtained at Step S3550 is opened.

On the other hand, at Step S3551, if the file data has been updated since the tag production date, the routine goes to the subsequent Step S3552, where a control signal is output to the control circuit 105 of the PC 3100 via the communication control portion 204 and the connecting member 3, and the fact that the file data has been updated is displayed on the display portion 101 and notified to the operator. After that, the corresponding application is started at Step S3560 and Step S3570, and the updated file data is opened. Then, this flow is finished.

According to the above variation, by determining if the contents of the file data has been updated since the tag label production when the file data is obtained, it can be confirmed whether or not the printed matter with tag 3001-T on which the RFID label T is attached is the latest. As a result, if the printed matter with tag 3001-T is not the latest, it becomes possible to take a measure such as printing of the (latest version of the) file data again by a printing device and the like, by which convenience can be further improved.

(C-6) When the File Data Itself is Written in the Tag:

In the sixth embodiment, the storage destination information of the file data is written in the RFID circuit element To, the storage destination information is gotten when the RFID tag information is read out by the reader and the file data is obtained by accessing the storage destination, but not limited to that. That is, if there is an extra storage capacity in the RFID circuit element To, the file data itself (may be file data itself to be printed or image data of the printed matter 3001 on which the file data is printed and the like, for example) may be written in.

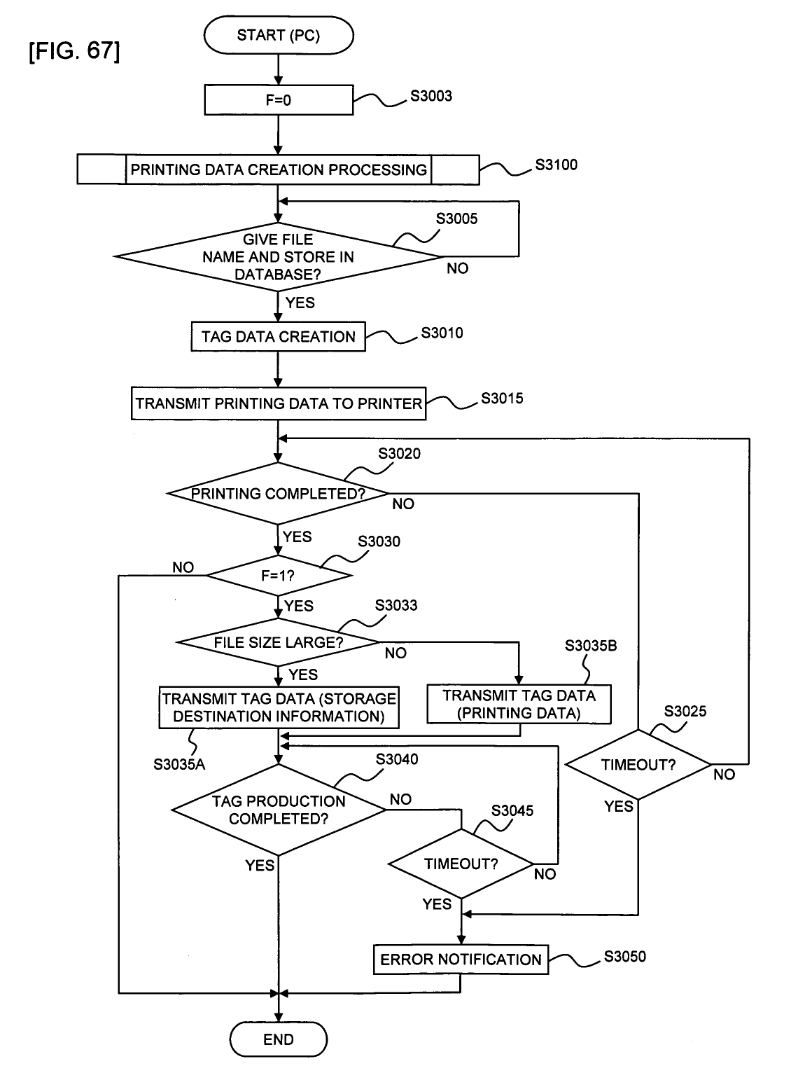

FIG. 67 is a flowchart illustrating a control procedure executed by the control circuit 105 of this variation and corresponds to the above-mentioned FIG. 49. In FIG. 67, the same reference numerals are given to portions similar to those in FIG. 49 and the description will be omitted.

In FIG. 67, Step S3003 to Step S3030 are similar to those in the above-mentioned FIG. 49. At Step S3010 of this variation, tag data including the file access information indicating the storage destination where the file data is stored is created and the tag data including the file data itself to be printed is also created.

At the subsequent Step S3033, it is determined whether or not the size of file data to be printed is larger than a predetermined size (in this case, the size capable of being written in the memory part 155 of the IC circuit part 150 in the RFID circuit element To). If the data size is larger than the predetermined size, it is impossible to write the file data itself in the RFID circuit element To, and the routine goes to Step S3035A, where the tag data including the file access information created at the previous Step S3010 is transmitted to the printer 3400 via the communication control portion 104 and the communication line 5. On the other hand, if the file data size is smaller than the predetermined size, the file data itself can be written in the RFID circuit element To, and the routine goes to Step S3035B, where the tag data including the file data itself created at the previous Step S3010 is transmitted to the printer 3400 via the communication control portion 104 and the communication line 5.

The subsequent Step S3040 to Step S3050 are similar to those in the above-mentioned FIG. 49 and the description will be omitted.

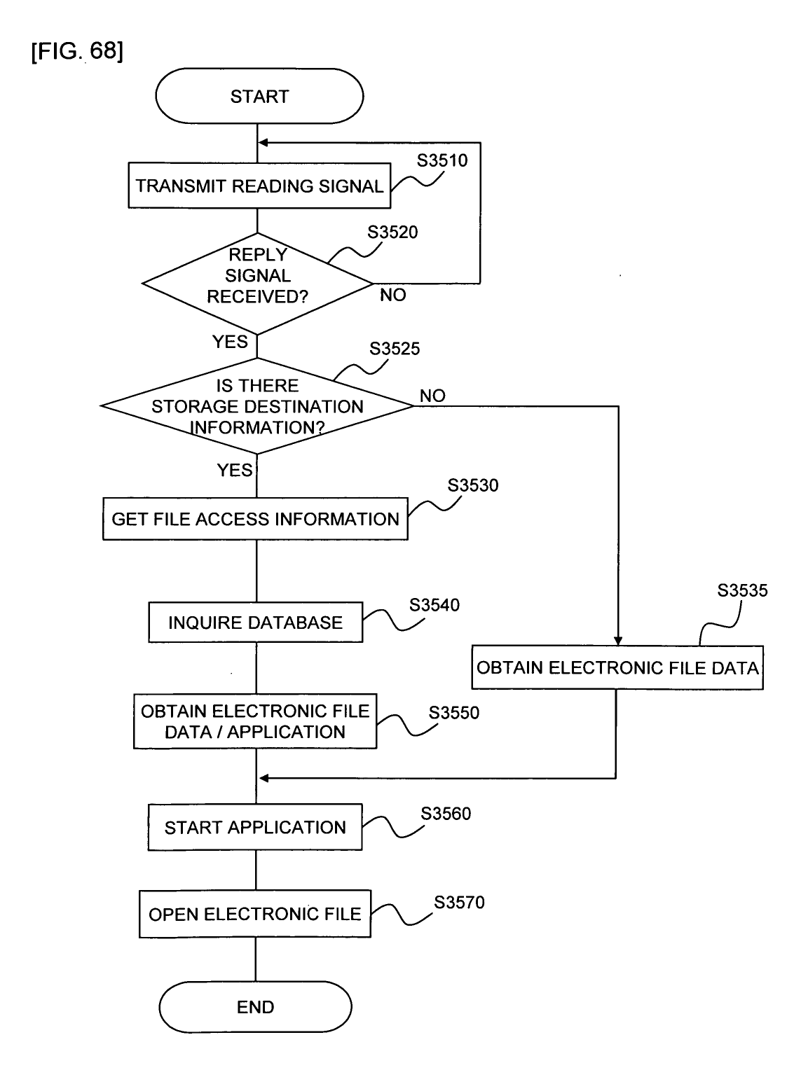

FIG. 68 is a flowchart illustrating a control procedure executed by the control circuit 202 of the reader 200 when the RFID tag information of the RFID label T is read out in this variation and corresponds to the above-mentioned FIG. 59.

In FIG. 68, Step S3510 to Step S3520 are similar to those in the above-mentioned FIG. 59. At the subsequent Step S3525, it is determined whether or not the file access information, which is the information of the storage destination of the file data, is included in the reply signal received from the RFID circuit element To. If included, the routine goes to the subsequent Step S3530, where the file access information is read out and gotten. The subsequent Step S3540 to Step S3570 are similar to those in the above-mentioned FIG. 59.

On the other hand, at Step S3525, if the file access information is not included (that is, the file data itself is included), the routine goes to Step S3535, where the file data is read out of the reply signal received from the RFID circuit element To and gotten. After that, at Step S3560 and Step S3570, the file data obtained from the RFID circuit element To is opened by the started application.

In the above-described variation, too, the effect similar to that in the sixth embodiment can be obtained.

(C-7) Others

In the above, the file access information itself indicating the storage destination where the file data is stored is written in the IC circuit part 150 of the RFID circuit element To, but not limited to that. That is, combined information (so-called linked information) of the file access information and the identification information of the RFID circuit element To (the tag ID) may be stored in the database and the like, and the tag ID combined as above may be written in the RFID circuit element To. In this case, when the tag ID is read out of the RFID circuit element To by the reader, the file access information can be gotten by checking the tag ID with the above-stored combined information. Alternatively, the address information representing the storage destination where the file access information is stored (so-called indirect address information) may be written.

Also, in the above, when the printed matter with tag is produced, the printer 3400 and the apparatus 300 for producing RFID label are connected in series and transmission/reception of the signal with the PC 3100 and the apparatus 300 for producing RFID label is carried out via the printer 3400, but not limited to that, the printer 3400 and the apparatus 300 for producing RFID label may be connected in parallel with the PC 3100, and a signal may be transmitted/received from the PC 3100 to the printer 3400 and the apparatus 300 for producing RFID label in parallel.

Also, in the above, the case where the tag label tape 303 with print for which print and access to the RFID circuit element To have been finished is cut by the cutter 307 so as to produce the tag cards 1, 2001 was described as an example, but not limited to that. That is, if a label mount (so-called die cut label) separated in advance to a predetermined size corresponding to a label is continuously arranged on a tape fed out of a roll, it may be so configured that only the label mount (provided with the accessed RFID circuit element To and on which the corresponding print has been applied) is peeled off the tape so as to produce the tag cards 1, 2001 or a RFID label after the tape is discharged from a carry-out exit even without cutting the tape by the cutter 307.

Also, in the above, the RFID tag information is written in the IC circuit part 150 of the RFID circuit element To and printing that identifies the RFID circuit element To is made by the print head 305 so as to produce the tag cards 1, 2001, but not limited to that. The printing does not necessarily have to be made but may be applied to a mode in which only the RFID tag information is written.

Moreover, in the above, the case where a roll is constituted by winding the tag tape around a reel member, and the roll is arranged in the holder portion 310 of roll of tape with RFID tags so that the tag tape is fed out was described as an example, but not limited to that. For example, a lengthy flat-sheet state or strip-state tape or sheet (including those formed by cutting a tape wound around a roll is fed out and then, cut into an appropriate length) on which at least one RFID circuit element To is arranged is stacked in a predetermined storage portion (flatly laminated in a tray-like container, for example) to be made into a cartridge, and this cartridge is attached to the holder portion of roll of tape with RFID tags on the side of the apparatus for producing RFID label so that the tape is transferred and transported from the storage portion and printed and written so as to produce the tag cards 1, 2001 and the RFID label.

Moreover, there may be a configuration in which the lengthy flat-sheet state or strip state tape or sheet is transferred from outside the apparatus 300 for producing RFID label one by one by a predetermined feeder mechanism and supplied into the apparatus 300 for producing RFID tag. In this case, too, the same effect is obtained.

The “Scroll All ID” signal, the “Ping” signal and the like used in the above shall comply with the specification formulated by EPC global. The EPC global is a non-profit corporation jointly established by International EAN Association, which is an international organization of distribution codes, and UCC (Uniformed Code Council), which is an U.S. distribution code organization. Signals complying with other standards will do as long as they serve the same functions.

Other than those mentioned above, methods of the embodiments and each variation may be combined as appropriate for use.

Though not specifically exemplified, the present invention should be put into practice with various changes made in a range not departing from its gist.

What is claimed is:

1. An apparatus for communicating with RFID tag comprising:
an apparatus antenna configured to carry out radio communication with a RFID circuit element provided with an IC circuit part storing information and a tag antenna that transmits/receives information; and
a transmission/reception control portion configured to transmit/receive processing assisting information for operator associated with data to be processed to/from said RFID circuit element via said apparatus antenna.

2. The apparatus for communicating with RFID tag according to claim 1, further comprising:
a file additional information creating portion configured to create, as said processing assisting information for operator, file additional information relating to an electronic file, which is said data to be processed; and
a tag access information creating portion configured to create tag access information to said IC circuit part, wherein:
said transmission/reception control portion is a information access portion for production configured to transmit at least said file additional information and said tag access information to said RFID circuit element via an antenna for production as said apparatus antenna and to write information in said IC circuit part.

3. The apparatus for communicating with RFID tag according to claim 2, wherein:
said file additional information creating portion creates attribute information relating to an attribute of said electronic file as said file additional information.

4. The apparatus for communicating with RFID tag according to claim 2, wherein:
said file additional information creating portion creates processing mode information relating to a mode of said processing operation to said electronic file as said file additional information.

5. The apparatus for communicating with RFID tag according to claim 2, wherein:
said file additional information creating portion creates product mode information relating to a mode of a product from said electronic file after said processing operation, as said file additional information.

6. The apparatus for communicating with RFID tag according to claim 3, further comprising a file access information creating portion configured to create file access information to access a storage destination of said electronic file, wherein:
said information access portion for production transmits said file access information, said file additional information, and said tag access information to said RFID circuit element via said antenna for production and writes the information in said IC circuit part.

7. The apparatus for communicating with RFID tag according to claim 6, further comprising a storage operation signal input portion configured to input a storage operation signal for operating and specifying a storage destination of said electronic file, wherein:
said file access information creating portion creates said file access information corresponding to the storage destination of said electronic file specified by said storage operation signal input by said storage operation signal input portion.

8. The apparatus for communicating with RFID tag according to claim 7, wherein:
said storage operation signal input portion inputs said storage operation signal specifying an operation terminal connectable to the apparatus for communicating with RFID tag as said storage destination of said electronic file; and
said file access information creating portion creates said file access information relating to said operation terminal according to said storage operation signal.

9. The apparatus for communicating with RFID tag according to claim 7, wherein:
said storage operation signal input portion inputs said storage operation signal specifying an external storage medium detachably attached to the apparatus for communicating with RFID tag as said storage destination of said electronic file; and
said file access information creating portion creates said file access information relating to said external storage medium according to said storage operation signal.

10. The apparatus for communicating with RFID tag according to claim 7, wherein:
said storage operation signal input portion inputs said storage operation signal specifying a server to which the apparatus for communicating with RFID tag can be connected as said storage destination of said electronic file; and
said file access information creating portion creates said file access information relating to said server according to said storage operation signal.

11. The apparatus for communicating with RFID tag according to claim 10, wherein:
said file access information creating portion creates authentication information to access said server with said file access information; and
said information access portion for production transmits said file access information, said file additional information, said tag access information, and said authentication information to said RFID circuit element via said antenna for production and writes the information in said IC circuit part.

12. The apparatus for communicating with RFID tag according to claim 3, further comprising a first printing device configured to print predetermined print information corresponding to contents of said electronic file on a tag medium provided with said RFID circuit element or a print-receiving medium to be bonded to the tag medium.

13. The apparatus for communicating with RFID tag according to claim 12, wherein:
said first printing device prints identification information of said electronic file or at least a part of the contents of said electronic file as said predetermined print information.

14. The apparatus for communicating with RFID tag according to claim 13, wherein:
said first printing device prints a representative portion of the contents of said electronic file as said predetermined print information.

15. The apparatus for communicating with RFID tag according to claim 12, further comprising a print operation signal input portion configured to input a print operation signal that specifies contents of said print information, wherein:
said first printing device print said predetermined print information on said tag medium or said print-receiving medium according to said print operation signal input with said print operation signal input portion.

16. The apparatus for communicating with RFID tag according to claim 2, further comprising a setting display signal output portion configured to output a display signal that displays a setting screen for making various settings relating to said file additional information.

17. The apparatus for communicating with RFID tag according to claim 3, further comprising an instruction signal input portion configured to input a start instruction signal to instruct start of production of a RFID tag by said antenna for production, said file additional information creating portion, said tag access information creating portion, and said information access portion for production.

18. The apparatus for communicating with RFID tag according to claim 2, further comprising:
a detecting device configured to optically detect a target to be made into an electronic file; and
an electronic file creating portion configured to create said corresponding electronic file according to a detection result of said detecting device.

19. The apparatus for communicating with RFID tag according to claim 18, wherein:
in the case that said detecting device carries out said optical detection to a plurality of said targets, said electronic file creating portion creates one said electronic file or one electronic file group in association with each other from the plurality of targets in a lump sum or for each predetermined number of said plurality of targets.

20. The apparatus for communicating with RFID tag according to claim 1, wherein:
said apparatus antenna is an antenna for reading configured to transmit/receive information via radio communication with a RFID circuit element provided with an IC circuit part storing and holding file additional information relating to an electronic file, which is said data to be processed, as said processing assisting information for operator;
said transmission/reception control portion is a information access portion for reading configured to create access information to said IC circuit part, to transmit the information to said RFID circuit element via said antenna for reading, and to practice reading of information from said IC circuit part, and
the apparatus for communicating with RFID tag further comprising:
an additional information acquisition portion configured to get said file additional information from a reply signal returned from said RFID circuit element, respectively, according to said access information by said information access portion for reading; and
a processing signal output portion configured to output a signal based on said file additional information gotten by said additional information acquisition portion to a processing device that performs said processing operation corresponding to the file additional information to said electronic file.

21. The apparatus for communicating with RFID tag according to claim 1, further comprising a feeding device configured to feed a tag medium on which said RFID circuit element is arranged, wherein:
said apparatus antenna is an antenna for production configured to transmit/receive information via radio communication with said RFID circuit element fed by said feeding device; and
said transmission/reception control portion is a writing control portion configured to write storage destination information of said file data or information corresponding thereto as said processing assisting information for operator in said IC circuit part of said RFID circuit element via said antenna for production according to a tag production instruction signal input from a processing device for communication with a RFID tag that applies printing corresponding to file data, which is said data to be processed, to an object to be printed.

22. The apparatus for communicating with RFID tag according to claim 21, wherein:
said writing control portion writes an electronic address as said storage destination information of said file data in said IC circuit part of said RFID circuit element.

23. The apparatus for communicating with RFID tag according to claim 21, wherein:
said writing control portion writes identification information of said file data in said IC circuit part of said RFID circuit element.

24. The apparatus for communicating with RFID tag according to claim 21, wherein:
said writing control portion writes file additional information relating to an electronic file corresponding to said file data in said IC circuit part of said RFID circuit element.

25. The apparatus for communicating with RFID tag according to claim 21, wherein:
said writing control portion writes authority information relating to an access to said file data or various processing after the access in said IC circuit part of said RFID circuit element.

26. The apparatus for communicating with RFID tag according to claim 21, further comprising a second printing device configured to apply a print corresponding to said file data on said tag medium or a print-receiving medium to be bonded the tag medium.

27. The apparatus for communicating with RFID tag according to claim 26, wherein:
said second printing device prints said identification information of said file data on said tag medium or said print-receiving medium.

28. The apparatus for communicating with RFID tag according to claim 27, wherein:
said second printing device prints said storage destination information of said file data on said tag medium or said print-receiving medium.

29. The apparatus for communicating with RFID tag according to claim 1, wherein:
said apparatus antenna is an antenna for reading configured to transmit/receive information via radio communication with said RFID circuit element provided at a RFID label attached to a printed matter printed on the basis of file data, which is said data to be processed;
said transmission/reception control portion is a information acquisition portion for reading configured to get storage destination information of said file data or information corresponding thereto as said processing assisting information for operator stored in said IC circuit part via said antenna for reading, and
said apparatus for communicating with RFID tag further comprises an update determining portion configured to determine whether or not contents of the file data has been updated after production of said RFID label by accessing the storage destination of said file data using information gotten by said information acquisition portion for reading.

30. A processing device for communication with a RFID tag having an apparatus antenna configured to carry out radio communication with a RFID circuit element provided with an IC circuit part storing information and a tag antenna that transmits/receives information, and performing control processing of an apparatus for communicating with RFID tag that transmits/receives processing assisting information for operator associated with data to be processed to/from said RFID circuit element via said apparatus antenna, said processing device for communication with a RFID tag comprising:
a transmission/reception instructing portion configured to output an instruction signal for transmission/reception of said processing assisting information for operator to said apparatus for communicating with RFID tag.

31. The processing device for communication with a RFID tag according to claim 30, wherein:
said processing device for communicating with a RFID tag is connectable to an apparatus for producing a RFID tag provided with an antenna for production, which is said apparatus antenna, as said apparatus for communicating with RFID tag, and further comprising:
an operating device for work configured to allow an operator to carry out operation input for work; and
a first display device configured to make display to said operator, wherein:
said transmission/reception instructing portion is a writing control signal output portion configured to output a writing control signal to said apparatus for producing a RFID tag as said instruction signal, said writing control signal being for transmitting current personal work information by said operator, which is said processing assisting information for operator, or information corresponding to the current personal work information to said RFID circuit element via said antenna for production and writing in said IC circuit part.

32. The processing device for communication with a RFID tag according to claim 31, further comprising a discriminating portion configured to discriminate information to be written in said IC circuit part of said RFID circuit element from information not to be written in said IC circuit part, among the current personal work information by said operator, wherein:
said writing control signal output portion outputs a signal that outputs said writing control signal for writing the personal work information discriminated by said discriminating portion as the information to be written or information corresponding to the personal work information in said IC circuit part.

33. The processing device for communication with a RFID tag according to claim 32, wherein:
said writing control signal output portion outputs a signal for outputting said writing control signal that writes work information of an application file displayed on said first display device or edited by an operation input of said operating device for work within a predetermined time range from the present or information corresponding to the work information in said IC circuit part as said personal work information.

34. The processing device for communication with a RFID tag according to claim 33, wherein:
said writing control signal output portion outputs a signal for outputting said writing control signal that writes work information of a plurality of application files displayed on said first display device within a predetermined time range from the present or information corresponding to the work information in said IC circuit part.

35. The processing device for communication with a RFID tag according to claim 32, wherein:
said writing control signal output portion outputs a signal for outputting said writing control signal that writes at least one piece of short-cut information displayed on said first display device within a predetermined time range from the present or information corresponding to the short-cut information in said IC circuit part.

36. The processing device for communication with a RFID tag according to claim 35, wherein:
said writing control signal output portion outputs a signal for outputting said writing control signal that writes all the short-cut information displayed on said first display device within a predetermined time range from the present or information corresponding to the short-cut information in said IC circuit part.

37. The processing device for communication with a RFID tag according to claim 31, wherein:
said writing control signal output portion automatically outputs said writing control signal at a predetermined timing.

38. The processing device for communication with a RFID tag according to claim 37, wherein:
said writing control signal output portion outputs said writing control signal on the basis of display switching of said first display device corresponding to non-operation duration time of said operating device for work as said predetermined timing.

39. The processing device for communication with a RFID tag according to claim 31, further comprising an operating device for writing instruction configured to instruct and input writing by an operator of said personal work information, wherein:
said writing control signal output portion outputs said writing control signal according to said instruction input in said operating device for writing instruction.

40. The processing device for communication with a RFID tag according to claim 37, wherein:
said first display device makes selection display that prompts said operator for selection on whether or not said writing control signal is to be output before said writing control signal output portion outputs said writing control signal.

41. The processing device for communication with a RFID tag according to claim 30, being configured to be connectable to an apparatus for reading RFID tag information having an antenna for reading, which is said apparatus antenna, as said apparatus for communicating with said RFID tag; wherein:
said transmission/reception instructing portion is a reading control signal output portion that outputs a reading control signal to said apparatus for reading RFID tag information as said instruction signal, said reading control signal being for reading personal work information by said operator, which is said processing assisting information for operator or information corresponding to the personal work information from said RFID circuit element via said antenna for reading, and
the processing device for communication with a RFID tag further comprising a second display device configured to make display corresponding to said personal work information on the basis of a reading result by said apparatus for reading RFID tag information according to said reading control signal.

42. The processing device for communication with a RFID tag according to claim 41, wherein:
said IC circuit part of said RFID circuit element stores an identifier relating to a type of said corresponding personal work information; and
said second display device makes display according to said identifier included in said reading result by said apparatus for reading RFID tag information.

43. The processing device for communication with a RFID tag according to claim 30, further comprising a printing device configured to apply printing on an object to be printed on the basis of a printing instruction signal for printing of file data, which is data to be processed, wherein:
said transmission/reception instructing portion is a production instruction output portion that outputs a tag production instruction signal as said instruction signal to the apparatus for producing RFID labels, which is said apparatus for communicating with RFID tag so that a RFID label in which said processing assisting information for operator is written to able to get said file data corresponding to the printing by said printing device is produced.

44. The processing device for communication with a RFID tag according to claim 43, wherein:
said production instruction output portion outputs a tag production instruction signal to the apparatus for producing RFID labels so that a RFID label able to get storage destination information of said file data as said processing assisting information for operator is produced.

45. The processing device for communication with a RFID tag according to claim 44, further comprising a information acquisition portion for printing configured to get said storage destination information of said file data, wherein:
said production instruction output portion outputs said tag production instruction signal including said storage destination information gotten with said information acquisition portion for printing to said apparatus for producing RFID labels.

46. The processing device for communication with a RFID tag according to claim 44, wherein:
said production instruction output portion outputs said tag production instruction signal to said apparatus for producing RFID labels so as to produce one said RFID label containing said storage destination information of said file data to become a plurality of printed matters when printed on said object to be printed.

47. The processing device for communication with a RFID tag according to claim 44, wherein:
said printing device prints an identifier indicating an arrangement position of an antenna base on which a RFID circuit element provided with an IC circuit part storing information and an antenna for transmission/reception of the information is arranged on said object to be printed.

48. The processing device for communication with a RFID tag according to claim 44, wherein:
said production instruction output portion has a tag production mode in which said tag production instruction signal for producing a RFID label that can get storage destination information of said file data is output and a tag non-production mode in which the RFID label is not produced, as operation modes.

49. A RFID tag comprising:
a RFID circuit element including with an IC circuit part that can store information and a tag antenna connected to said IC circuit part, wherein:
said IC circuit part stores and holds processing assisting information for operator associated with data to be processed.

50. The RFID tag according to claim 49, wherein:
said IC circuit part stores and holds file additional information relating to an electronic file, which is data to be processed, as said processing assisting information for operator.

51. The RFID tag according to claim 50, wherein:
said IC circuit part stores and holds file access information to access the storage destination of said electronic file.

52. The RFID tag according to claim 49, wherein:
said IC circuit part stores and holds current personal work information of an operator in a processing device for communication with a RFID tag or information corresponding to the personal work information as said processing assisting information for operator.

53. A RFID tag communication system comprising:
an apparatus for communicating with RFID tag having an apparatus antenna for radio communication with a RFID circuit element provided with an IC circuit part storing information and a tag antenna for transmission/reception of the information and configured to transmit/receive processing assisting information for operator associated with data to be processed with respect to said RFID circuit element via said apparatus antenna; and
a processing device for communication with a RFID tag provided with a transmission/reception instructing portion configured to output an instruction signal for transmission/reception of said processing assisting information for operator to said apparatus for communicating with RFID tag.

54. The RFID tag communication system according to claim 53, wherein:
said processing device for communication with a RFID tag further includes a printing device configured to apply printing on an object to be printed on the basis of a printing instruction signal for printing of file data, which is data to be processed;
said transmission/reception instructing portion is a production instruction output portion configured to output a tag production instruction signal as said instruction signal so that a RFID label in which said processing assisting information for operator to get said file data is written corresponding to the printing by said printing device is produced; and
said apparatus for communicating with RFID tag further includes a feeding device configured to feed a tag medium on which said RFID circuit element is arranged; and
said apparatus antenna is an antenna for production configured to transmit/receive information via radio communication with said RFID circuit element fed by said feeding device, and
the RFID tag communication system further comprises a writing control portion configured to write said file data or information corresponding thereto as said processing assisting information for operator in said IC circuit part of said RFID circuit element via said antenna for production according to said tag production instruction signal input from said production instruction output portion of said processing device for communication with a RFID tag.
